(19) United States
(12) Patent Application Publication
(10) Pub. No.: US 2007/0160899 A1
(43) Pub. Date: Jul. 12, 2007

(54) Alloy catalyst compositions and processes for making and using same

(75) Inventors: Paolina Atanassova, Albuquerque, NM (US); Rimple Bhatia, Placitas, NM (US); Yipeng Sun, Albuquerque, NM (US); Mark J. Hampden-Smith, Albuquerque, NM (US); James Brewster, Rio Rancho, NM (US); Paul Napolitano, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/328,147

(22) Filed: Jan. 10, 2006

(51) Int. Cl. H01M 4/90; B05D 7/00; B01J 23/42

(52) U.S. Cl. 429/44; 427/216; 502/326

(57) ABSTRACT

Composite particles comprising inorganic nanoparticles disposed on a substrate particle and processes for making and using same. A flowing aerosol is generated that includes droplets of a precursor medium dispersed in a gas phase. The precursor medium contains a liquid vehicle and at least one precursor. At least a portion of the liquid vehicle is removed from the droplets of precursor medium under conditions effective to convert the precursor to the nanoparticles on the substrate and form the composite particles.

### STATEMENT REGARDING FEDERALLY SPONSORED RESEARCH OR DEVELOPMENT

This invention was made with United States Government support under Cooperative Agreement No. DE-FC0402AL6762 awarded by the U.S. Department of Energy.

### FIELD OF THE INVENTION

The present invention relates to catalyst compositions. More particularly, the invention relates to alloy catalyst compositions, and to processes for making and using such compositions.

### BACKGROUND OF THE INVENTION

Fuel cells are electrochemical devices in which the energy from a chemical reaction is converted to direct current electricity. During operation of a fuel cell, a continuous flow of fuel, e.g., hydrogen (or a liquid fuel such as methanol), is fed to the anode while, simultaneously, a continuous flow of an oxidant, e.g., air, is fed to the cathode. The fuel is oxidized at the anode causing a release of electrons through the agency of a catalyst. These electrons are then conducted through an external load to the cathode, where the oxidant is reduced and the electrons are consumed, again through the agency of a catalyst. The constant flow of electrons from the anode to the cathode constitutes an electrical current which can be made to do useful work.

Initially, fuel cell catalysts were comprised of platinum or other noble metals, as these materials were most active and best able to withstand the corrosive environment of the fuel cell. Later, these noble metals were dispersed over the surface of electrically conductive supports (e.g. carbon black) to increase the surface area of the catalyst which in turn increased the number of reactive sites leading to improved efficiency of the cell. It was then discovered that certain alloys of noble metals exhibit increased catalytic activity, further increasing fuel cell efficiencies. Some catalytic alloys are disclosed, for example, in U.S. Pat. No. 4,186,110 (Pt—Ti, Pt—Al, Pt—Al—Si, Pl-Sr—Ti, Pt—Ce), in U.S. Pat. No. 4,316,944 (Pt—Cr) and U.S. Pat. No. 4,202,934 (Pt—V).

More recently, there has been increasing interest in ternary alloy catalyst systems for fuel cell applications. U.S. Pat. No. 4,447,506, for example, discloses a ternary noble metal-containing alloy catalyst which has a catalytic activity for the electro-chemical reduction of oxygen greater than two and one-half times that of the support unalloyed noble metal alone. Similarly, U.S. Pat. Nos. 4,677,092 and 4,711,829 disclose ternary alloy catalysts for the electrochemical reduction of oxygen, the catalysts having an ordered structure to improve stability and the specific activity of the catalysts. U.S. Pat. No. 4,794,054 discloses Pt—Fe—Co ternary alloy with face centered cubic lattice structure and U.S. Pat. No. 4,970,128 discloses Pt—Fe—Cu ternary ordered alloy. U.S. Pat. No. 5,068,161 discloses several Pt—Ni and Pt—Mn catalyst systems in addition to Pt—Co—Cr ternary alloy catalyst systems. U.S. Pat. No. 5,189,005 discloses a platinum alloy catalyst comprising an electroconductive support and Pt—Ni—Co alloy particles having an ordered structure supported thereon.

Conventionally, alloy catalysts have been formed through wet precipitation techniques. In general, these techniques involve mixing solutions of a preformed supported Pt/Carbon catalyst with a precursor of two or more metal precursors, optionally in admixture with a pH adjusting chemical or a reducing agent, and removing the liquids from the resulting mixture to form a precipitant comprising a plurality of metals. The goal of this first step is typically to ensure intimate contact between supported noble metal particles and the precursors of the alloying elements, typically metal oxide particles supplied as colloidal solution (See U.S. Pat. No. 4,186,110) or by impregnation with precursors to the alloying metals or metal oxides of choice (See U.S. Pat. Nos. 4,316,944; 4,447,506; 4,711,829; 4,970,128; and 5,178,971). In another approach, as described in U.S. Pat. No. 5,068,161, the precursors to the alloy metals are dissolved and added consecutively to a carbon support suspension, depositing the platinum group metal firstly. In all cases above the precipitant is then heated in inert or reducing atmosphere to high temperatures (600-1000° C.) to alloy the metals together and form an alloy catalyst. As a result of the specific heating conditions, either disordered or ordered alloy catalysts are prepared (See U.S. Pat. Nos. 4,677,092; 4,711,829; 5,068,161; 5,178,971; and 5,189,005). The high temperatures used in all of these cases to achieve alloying of the precursors were needed because separately formed metal oxides or metal nanoclusters of the alloying elements had to diffuse into the Pt nanoparticles for the alloying to take place. However, using too high of temperatures may lead to undesirable loss of surface area for the alloyed particles. U.S. Pat. No. 5,178,971 discloses a quaternary Pt—Co—Ni—Cu alloy and U.S. Pat. No. 5,876,867 teaches a process for producing Pt alloy catalyst with base metals having a structure of vacant lattice site type defects by removing part of the alloy base metal from the lattice structure.

Undesirably, in order to achieve a degree of alloying and long term durability desired for the strongly acidic conditions present in phosphoric acid and polymer electrolyte fuel cells, all these processes for forming alloy catalysts require multiple consecutive impregnation/reduction steps and high temperature treatment steps, which lead to undesirable agglomeration of the alloy particles. In addition, because of the utilization of multiple preparation steps, the alloy particles formed are not substantially uniform from particle to particle, resulting in reduced overall activity. Thus, there is a need for a new process of making binary, ternary and quaternary alloys with high active site dispersion, high activity, and a high degree of uniformity from particle to particle. In addition, new processes are sought for enabling the discovery of new alloy catalyst compositions, containing one or more metals from the Pt group metals that are alloyed with 2 or more compositions of base metals, having a very high degree of uniformity.

Additionally, although various platinum alloy catalyst systems have shown promise for fuel cell applications, the need remains for improved catalyst compositions having high catalytic activity.

### SUMMARY OF THE INVENTION

The present invention is directed to electrocatalyst compositions and processes for making same. In one embodiment, the invention is directed to a process for forming composite particles, wherein the process comprises the steps of: (a) providing a precursor medium comprising a first metal precursor, a second metal precursor, a liquid vehicle (optionally comprising water), and a substrate precursor to substrate particles; (b) spray drying the precursor medium to vaporize at least a portion of the liquid vehicle and form intermediate particles; and (c) heating the intermediate particles to a temperature of no greater than about 600° C. (e.g., no greater than about 500° C., no greater than about 400° C. or no greater than about 250° C.) under conditions effective to form the composite particles, wherein the composite particles comprise alloy nanoparticles dispersed on the substrate particles. The intermediate particles optionally comprise the substrate particles and a plurality of metal-containing compositions disposed thereon, wherein the metal-containing compositions are formed from the first and second metal precursors. At least one of the metal-containing compositions optionally comprises an elemental metal. Additionally or alternatively, at least one of the metal-containing compositions optionally comprises a metal oxide. Steps (b) and (c) may occur substantially simultaneously, e.g., through spray pyrolysis. Alternatively, step (b) occurs at least partially before step (c).

In another embodiment, the invention is to a process for forming composite particles, wherein the process comprises the steps of: (a) providing a precursor medium comprising a first metal precursor, a second metal precursor, a liquid vehicle and a substrate precursor to a substrate particle; (b) aerosolizing the precursor medium to form a flowable aerosol comprising droplets of the liquid mixture; and (c) heating the flowable aerosol to a temperature of from about 400° C. to about 800° C. (optionally no greater than about 700° C., no greater than about 600° C. or no greater than about 500° C.) under conditions effective to at least partially vaporize the liquid vehicle and form the composite particles, wherein the composite particles comprise alloy nanoparticles disposed on the substrate particles. In this embodiment, step (b) optionally forms intermediate particles comprising the substrate particles and a plurality of metal-containing compositions disposed thereon, wherein the metal-containing compositions are formed from the first and second metal precursors. Optionally, at least one of the metal-containing compositions comprises an elemental metal. Additionally or alternatively, at least one of the metal-containing compositions comprises a metal oxide. In this embodiment, steps (b) and (c) preferably occur substantially simultaneously through spray pyrolysis. Alternativley, step (b) occurs at least partially before step (c).

In either embodiment, the alloy nanoparticles preferably are formed from metals derived from the first metal precursor and the second metal precursor. Optionally, the first metal precursor optionally comprises platinum and the second metal precursor optionally comprises a second metal selected from the group consisting of: nickel, cobalt, iron, copper, manganese, chromium, ruthenium, rhenium, molybdenum, tungsten, vanadium, zinc, titanium, zirconium, tantalum, iridium, palladium and gold. Thus, the alloy nanoparticles optionally comprise a solid solution of the platinum and the second metal. In one embodiment, the precursor medium further comprises a third metal precursor comprising a third metal, different from the second metal, the third metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold. The alloy nanoparticles optionally comprise a solid solution of the platinum and the second and third metals. In one aspect, the second metal comprises cobalt and the third metal comprises nickel. The precursor medium optionally further comprises a fourth metal precursor comprising a fourth metal, different from the second and third metals, the fourth metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold. In this embodiment, the alloy nanoparticles optionally comprise a solid solution of the platinum and the second, third and fourth metals.

In each embodiment, the alloy nanoparticles optionally have an average particle size of from about 1 nm to about 10 nm, e.g., from about 3 nm to about 5 nm, or from about 1 nm to about 3 nm.

The average distance between adjacent alloy nanoparticles on a given substrate particle optionally is from about 1 nm to about 10 nm.

Optionally, the substrate particles comprise carbon microparticles, which may have a d50 value, by volume, of from about 1 μm to about 20 μm.

The precursor medium optionally comprises the substrate precursor in an amount from about 1 to about 10 weight percent, based on the total weight of the precursor medium.

The alloy nanoparticles may comprise a disordered alloy, an ordered alloy, or a combination thereof.

In one specific embodiment, the first metal precursor comprises platinum, the second metal precursor comprises manganese, the precursor medium further comprises an iron precursor, and the alloy nanoparticles comprise a solid solution of platinum, manganese and iron. In another embodiment, the first metal precursor comprises platinum, the second metal precursor comprises palladium, the precursor medium further comprises a manganese precursor, and the alloy nanoparticles comprise a solid solution of platinum, palladium and manganese. In another embodiment, the first metal precursor comprises platinum, the second metal precursor comprises palladium, the precursor medium further comprises a nickel precursor and a cobalt precursor, and the alloy nanoparticles comprise a solid solution of platinum, palladium, nickel and cobalt. In another embodiment, the first metal precursor comprises platinum, the second metal precursor comprises cobalt, the precursor medium further comprises a copper precursor, and the alloy nanoparticles comprise a solid solution of platinum, cobalt and copper. In this aspect, the alloy nanoparticles optionally comprise the solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points A, B, C and D, by points E, F, G and H, by points I, J, K and L, or by points M, J, N and O of the ternary diagram which is FIG. 8. In another embodiment, the first metal precursor comprises platinum, the second metal precursor comprises cobalt, the precursor medium further comprises an iron precursor, and the alloy nanoparticles comprise a solid solution of platinum, cobalt and iron. In this aspect, the alloy nanoparticles optionally comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points A, B, C and D, points E, F, G and H, or points I, J, K and L of the ternary diagram which is FIG. 9. In another embodiment, the first metal precursor comprises platinum, the second metal precursor comprises iron, the precursor medium further comprises a copper precursor, and the alloy nanoparticles comprise a solid solution of platinum, iron and copper. In this aspect, the alloy nanoparticles optionally comprise a solid solution of platinum, iron and copper in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points A, B, C, D, E and F, points G, H, I and J, or points A, K, L and M of the ternary diagram which is FIG. 10. In another embodiment, the first metal precursor comprises platinum, the second metal precursor comprises nickel, the precursor medium further comprises a copper precursor, and the alloy nanoparticles comprise a solid solution of platinum, nickel and copper. In this aspect, the alloy nanoparticles optionally comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points A, B, C, and D, points E, F, G and H, points I, J, K and L or points M, I, N and O of the ternary diagram which is FIG. 11. In another embodiment, the first metal precursor comprises platinum, the second metal precursor comprises nickel, the precursor medium further comprises an iron precursor, and the alloy nanoparticles comprise a solid solution of platinum, nickel and iron. In this aspect, the alloy nanoparticles optionally comprise a solid solution of platinum, nickel and iron in amounts represented by the formula PtₓNi_{y}Fe_{z}, wherein x, y and z represent the mole fractions of platinum, nickel and iron, respectively, present in the alloy nanoparticles, the mole fractions being such that they are within the compositional area defined by points A, B, C, and D of the ternary diagram which is FIG. 12. In another embodiment, the first metal precursor comprises platinum, the second metal precursor comprises palladium, the precursor medium further comprises an copper precursor, and the alloy nanoparticles comprise a solid solution of platinum, palladium and copper. In this aspect, the alloy nanoparticles optionally comprise a solid solution of platinum, palladium and copper in amounts represented by the formula PtₓPd_{y}Cu_{z}, wherein x, y and z represent the mole fractions of platinum, palladium and copper, respectively, present in the alloy nanoparticles, the mole fractions being such that they are within the compositional area defined by points A, B, C, D, E, and F, or points G, B, H and I of the ternary diagram which is FIG. 13. In another embodiment, the first metal precursor comprises platinum, the second metal precursor comprises palladium, the precursor medium further comprises a cobalt precursor, and the alloy nanoparticles comprise a solid solution of platinum, palladium and cobalt. In this aspect, the alloy nanoparticles optionally comprise a solid solution of platinum, palladium and cobalt in amounts represented by the formula PtₓPd_{y}Co_{z}, wherein x, y and z represent the mole fractions of platinum, palladium and cobalt, respectively, present in the alloy nanoparticles, the mole fractions being such that they are within the compositional area defined by points A, B, C, and D of the ternary diagram which is FIG. 14. In another embodiment, the first metal precursor comprises platinum, the second metal precursor comprises palladium, the precursor medium further comprises an iron precursor, and the alloy nanoparticles comprise a solid solution of platinum, palladium and iron. In another embodiment, the first metal precursor comprises platinum, the second metal precursor comprises nickel, the precursor medium further comprises a cobalt precursor, and the alloy nanoparticles comprise a solid solution of platinum, nickel and cobalt. In this aspect, the alloy nanoparticles optionally comprise a solid solution of platinum, nickel and cobalt in amounts represented by the formula PtₓNi_{y}Co_{z}, wherein x, y and z represent the mole fractions of platinum, nickel and cobalt, respectively, present in the alloy nanoparticles, the mole fractions being such that they are within the compositional area defined by points A, B, C, and D, or points E, F, G and H of the ternary diagram which is FIG. 15.

In another embodiment, the invention is to an electrocatalyst composition, comprising a plurality of alloy nanoparticles disposed on a surface of a substrate particle, wherein the plurality of alloy nanoparticles has a number average particle size of from about 1 to about 5 nm (e.g., from about 1 to about 4 nm, from about 1 to about 3 nm, from about 1 nm to about 2.5 nm, or from about 3 nm to about 5 nm). The composition preferably delivers similar or better performance when used as a first cathode electrocatalyst at loadings if 0.1 to 0.5 mg active phase/cm², the active phase comprising the alloy nanoparticles, as compared to a MEA comprising a second cathode electrocatalyst comprising elemental platinum nanoparticles, wherein the first cathode electrocatalyst comprises at least 10% less platinum than the second cathode electrocatalyst. The electrocatalyst composition may comprise any of the specific alloy compositions described above with reference to the ternary diagrams in FIGS. 8-15. The substrate particle preferably comprises a carbon microparticle optionally having a particle size of from about 0.1 to about 20 μm. The average distance between adjacent alloy nanoparticles on the substrate particle may be from about 1 to about 10 nm.

In another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species (e.g., alloy nanoparticles)/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 400 mA/cm² at 80° C. as measured with anode constant flow rate of 100% humidified 510 ml/min hydrogen and the cathode flow rate of fully humidified 2060 ml/min air, at 30 psig (207 kPa) pressure at both anode and cathode inlets. Preferably, the electrocatalyst layer has a platinum loading of not greater than 0.4, not greater than about 0.3, not greater than about 0.2 or not greater than about 1 mgPt/cm².

In another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 600 mA/cm² at 80° C. as measured with anode constant flow rate of 100% humidified 510 ml/min hydrogen and the cathode flow rate of fully humidified 2060 ml/min air, at 30 psig pressure at both anode and cathode inlets. Preferably, the electrocatalyst layer has a platinum loading of not greater than 0.4, not greater than about 0.3, not greater than about 0.2 or not greater than about 1 mgPt/cm².

In yet another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 850 mA/cm² at 80° C. as measured with anode constant flow rate of 100% humidified 510 ml/min hydrogen and the cathode flow rate of fully humidified 2060 ml/min air, at 30 psig pressure at both anode and cathode inlets.

### BRIEF DESCRIPTION OF THE DRAWINGS

The present invention will be better understood in view of the following non-limiting figures, wherein:

FIG. 1 is a Tunneling Electron Micrograph (TEM) of an electrocatalyst composition according to one embodiment of the present invention;

FIGS. 2A-E are TEM's of an electrocatalyst composition according to another embodiment of the present invention;

FIGS. 3A-B present an X-Ray Diffraction (XRD) Spectra of Pt alloy supported catalyst before (A) and after (B) post processing;

FIGS. 4A-B present High Resolution Transmission Electron Microscopy (HRTEM) images of Pt alloy supported catalyst before (A) and after (B) post processing;

FIGS. 5A-B present XRD spectra for a 40 wt. % Pt alloy catalyst composition (Pt₂Ni₁Co₁) before (A) and after (B) post processing;

FIGS. 6A-B present TEM's for the 40 wt. % Pt alloy catalyst composition of FIGS. 5A-B before (A) and after (B) post processing;

FIG. 7 presents non-limiting groups of various metals that may be alloyed according to several aspects of the present invention;

FIG. 8 presents a Pt—Co—Cu compositional ternary diagram for catalyst compositions according to one aspect of the present invention;

FIG. 9 presents a Pt—Co—Fe compositional ternary diagram for catalyst compositions according to one aspect of the present invention;

FIG. 10 presents a Pt—Fe—Cu compositional ternary diagram for catalyst compositions according to one aspect of the present invention;

FIG. 11 presents a Pt—Ni—Cu compositional ternary diagram for catalyst compositions according to one aspect of the present invention;

FIG. 12 presents a Pt—Ni—Fe compositional ternary diagram for catalyst compositions according to one aspect of the present invention;

FIG. 13 presents a Pt—Pd—Cu compositional ternary diagram for catalyst compositions according to one aspect of the present invention;

FIG. 14 presents a Pt—Pd—Co compositional ternary diagram for catalyst compositions according to one aspect of the present invention;

FIG. 15 presents a Pt—Ni—Co compositional ternary diagram for catalyst compositions according to one aspect of the present invention;

FIGS. 16A-C present TEM and Field Emission X-Ray Analysis data showing the high degree of uniformity of compositions formed by a process of the present invention;

FIGS. 17A-B present XRD and TEM data showing the high dispersion of alloy nanoparticles formed by a process of the present invention;

FIG. 18 presents an XRD spectra for Pt₂₅Co₁₀Cu₆₅ showing that highly dispersed alloy clusters can be achieved by the process of the present invention;

FIG. 19 presents an XRD spectra for Pt₃₉Ni₅₄Fe₇ showing that highly dispersed alloy clusters can be achieved by the process of the present invention;

FIG. 20 presents the polarization curves for single cell MEA containing electrodes comprised of alloy compositions formed by the process of the present invention;

FIG. 21 presents polarization curves as in FIG. 20 where the performance is presented as a function of the mass activity or normalized by the total amount of Pt in the MEA;

FIG. 22 presents a table where the performance of the 20 wt. % Pt alloy electrocatalysts is compared to that of pure 20 wt. % Pt supported on carbon;

FIG. 23 presents a comparison between an alloy cathode composition before and after acid treatment;

FIG. 24 presents high resolution TEM images of an alloy electrocatalyst before and after the acid treatment;

FIG. 25 compares the XRD patterns of alloy catalysts before and after acid treatment;

FIG. 26 presents the test results of long term testing of an MEA containing alloy electrocatalyst of the present invention; and

FIG. 27 presents polarization curves comparing the performance of single MEA for two electrocatalysts.

### DETAILED DESCRIPTION OF THE INVENTION

### I. Introduction

The present invention is directed to composite particles, e.g., alloy electrocatalyst compositions, and to processes for making composite particles. In one aspect, the invention is directed to the use of spray conversion methods for making binary, ternary, quaternary (or greater) complex alloy compositions. In this approach, all precursors to the final alloy composition are dissolved in a solvent containing dispersed support (i.e., substrate) particles. Droplets of this suspension are formed, entrained in a carrier gas, and passed through a high temperature furnace for a time no longer than 100 seconds under conditions effective to cause the solvent to vaporize. As the solvent vaporizes, the precursors are converted to an intimate mixture of metal-containing compositions disposed on the support particles. After the catalyst particles are collected they are subjected to a heat treatment in inert or reducing atmosphere at temperatures below 600° C. which is sufficient to achieve a desired degree of alloying because of the intimate mixing of the metal-containing compositions formed by the spray conversion process. Further, a high dispersion of alloy phase is achieved in combination with sufficient degree of alloying. Post treatment temperatures as low as 250° C. to 500° C. were surprisingly found sufficient to achieve alloying of the components. According to the processes of the present invention, the catalyst particles and, in particular, the alloy particles thereof have a high degree of uniformity from particle to particle since each particle is exposed to essentially the same time-temperature profile in the spray conversion equipment.

In other aspects, the invention is to an electrocatalyst composition comprising a plurality of alloy nanoparticles disposed on a surface of a substrate particle, wherein the plurality of alloy nanoparticles has an average particle size of from about 1 nm to about 5 nm. In this embodiment, surprisingly and unexpectedly, it has been discovered that the composition may deliver similar or better performance when used as a first cathode electrocatalyst at loadings if 0.1 to 0.5 mg active phase/cm², the active phase comprising the alloy nanoparticles, as compared to a MEA comprising a second cathode electrocatalyst comprising elemental platinum nanoparticles, wherein the first cathode electrocatalyst comprises at least 10% less platinum than the second cathode electrocatalyst.

In other aspects, the invention is directed to several specific alloy electrocatalyst compositions that have exhibited surprisingly and unexpectedly high activity for fuel cell applications. The alloy electrocatalyst compositions of the present invention have an extremely high degree of uniformity and, accordingly, a higher degree of activity over less uniform catalyst compositions. The high degree of uniformity of the electrocatalyst compositions of the present invention may be achieved by forming the electrocatalyst compositions by any of the processes of the present invention.

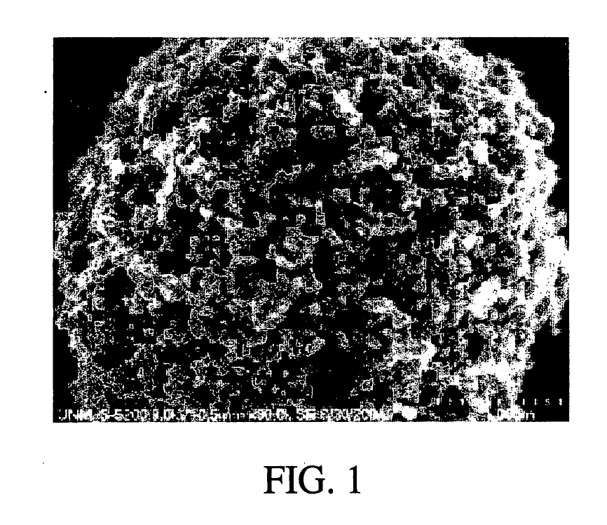

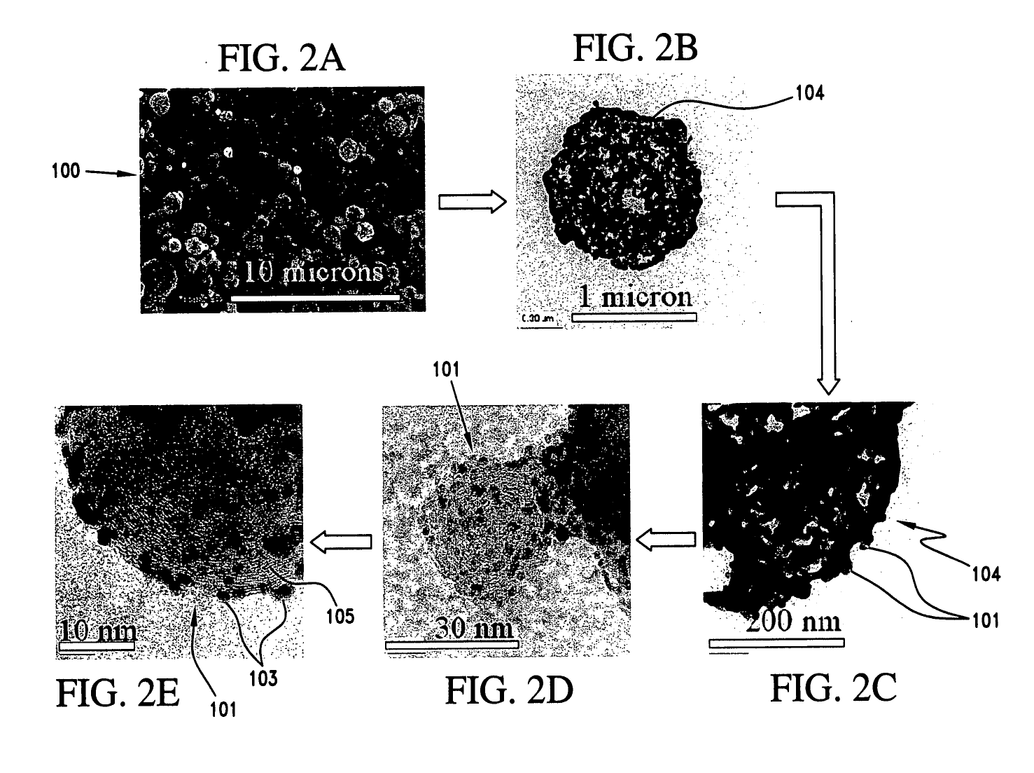

FIG. 1 presents a tunneling electron micrograph (TEM) of a composite particle (e.g., electrocatalyst composition) made according to one embodiment of the current invention, and FIGS. 2A-E present TEM's of increasing magnification of a population of composite particles 100 according to another embodiment of the current invention. FIG. 2A is a TEM of a plurality of composite particles 100 in a powder batch. FIG. 2B is a TEM of an individual composite particle 104 having a size of about 1.2 μm. FIGS. 2C and 2D are TEM's of individual composite particle 104 showing that the composite particle 104 is comprised of many agglomerated smaller composite nanoparticles 101. FIG. 2E is a TEM of a portion of a composite nanoparticle 101 (which is a portion of larger composite particle 104), on which is disposed a plurality of alloy nanoparticles 103. Each composite nanoparticle 101 comprises a substrate particle 105, which is substantially spherical, and a plurality of alloy nanoparticles or nanocrystals 103 (visible in FIGS. 2D & 2E) disposed thereon. The composite nanoparticle 101 shown in FIG. 2E has a diameter of about 30 nm.

### II. Processes for Forming Composite Particles

In one embodiment, the invention is to a process for forming composite particles, such as electrocatalyst compositions, the process comprising the steps of: (a) providing a precursor medium comprising a first metal precursor, a second metal precursor, substrate particles and a liquid vehicle; (b) spray drying the precursor medium to vaporize at least a portion of the liquid vehicle and form intermediate particles; and (c) heating the intermediate particles to a temperature of no greater than about 600° C. under conditions effective to form the composite particles, wherein the composite particles comprise alloy nanoparticles disposed on a surface of the substrate particles. In this embodiment, “spray drying” means aerosolizing under conditions effective, e.g., through moderate heating, to vaporize at least a portion of the composition being spray dried.

In another aspect, the composite particles are formed through spray pyrolysis. In this aspect, the invention is to a process for forming composite particles, such as electrocatalyst compositions, the process comprising the steps of: (a) providing a precursor medium comprising a first metal precursor, a second metal precursor, substrate particles and a liquid vehicle; (b) aerosolizing the precursor medium to form a flowable aerosol comprising droplets of the liquid mixture; and (c) heating the flowable aerosol to a temperature of from about 400° C. to about 800° C. under conditions effective to at least partially vaporize the liquid vehicle, to decompose the precursors, to achieve intimate mixing of the alloy components and form the composite particles, wherein the composite particles comprise alloy nanoparticles disposed on the substrate particles.

The Precursor Medium

As indicated above, the processes for making the composite particles of the present invention include a step of providing a “precursor medium,” defined herein as a flowable medium comprising: (1) a sufficient amount of a liquid vehicle to impart flowability to the medium; (2) two or more metal precursors; (3) one or more substrate precursors; and (4) optionally, one or more additives or other components.

As used herein, the unmodified term “precursor” means a compound that has a first form in the precursor medium, at least momentarily, which may be converted to a second form (which is different from the first form) in the composite particles of the present invention, optionally through one or more intermediate forms between the first form and the second form. Two types of precursors, both of which are present in the precursor medium, include: (1) metal precursors; and (2) substrate precursor(s). Specifically, each metal precursor is converted to its corresponding metal (optionally through a metal oxide intermediate). The plurality of metals formed from the metal precursors are then alloyed to form the alloy nanoparticles. Similarly, the substrate precursor is converted to substrate particles, typically substrate microparticles, on which the alloy nanoparticles are disposed.

Thus, in a preferred embodiment, the precursor medium includes at least two types of precursors: (1) at least two metal precursors for forming alloy nanoparticles; and (2) at least one substrate precursor for forming substrate particles on which the alloy nanoparticles are formed in the final composite particles. The relative proportions of the metal precursors and substrate precursor(s) in the precursor medium will vary depending upon the proportions of alloy nanoparticles and substrate particles to be included in the composite particles, and also on the nature of the particular precursors to those materials that are included in the precursor medium. The amount of a precursor included in the precursor medium will be selected to provide the desired amount of the final material, e.g., alloy and substrate, in the composite particles. For example, if the composite particles are to contain certain weight percentages respectively of alloy nanoparticles and substrate, then the relative quantities of metal precursor and substrate precursor should be properly proportioned in the precursor medium to provide the proper weight fractions, taking into account any reactions that are involved in converting the metal and substrate precursors into the respective alloy nanoparticles and substrate in the resulting composite particles.

The precursor medium will typically comprise, in solution and/or as particulate precursor, no more than about 50 weight percent precursor(s), and preferably no more than about 25 weight percent precursor(s). In most situations, however, the precursor medium will comprise at least 3 weight percent precursor(s). When the precursor medium comprises dissolved precursors, the precursor medium will typically comprise no more than 25 weight percent of such dissolved precursor(s).

The precursor medium should also have properties that are conducive to efficient formation of the desired droplets of the precursor medium during the step of generating the aerosol during spray processing. The desired properties of the precursor medium for droplet generation may vary depending upon the specific composition of the precursor medium and the specific apparatus used to generate droplets for the aerosol. Some properties that may be important to droplet generation include the viscosity and surface tension properties of the liquid vehicle, the proportion of liquid vehicle and solids, when present, in the precursor medium, and the viscosity, flowability and density of the precursor medium. Typically, when the droplets are generated, the precursor medium will have a viscosity of less than 1000 centipoise and usually less than 100 centipoise. The precursor medium should be sufficiently stable to avoid significant settling of particles (e.g., substrate particles) in the precursor medium during processing.

The Liquid Vehicle

As indicated above, the precursor medium comprises a liquid vehicle, which imparts flowability to the medium. The liquid vehicle may be any liquid that is convenient and compatible for processing precursor(s) and reagent(s) that are to be included in the precursor medium to make the composite particles. The liquid vehicle may comprise a single liquid component, or may be a mixture of two or more liquid components, which may or may not be mutually soluble in one another. The use of a mixture of liquid components is useful, for example, when the precursor medium includes multiple precursors (e.g., metal precursors and one or more substrate precursors), with one or more precursors having a higher solubility in one liquid component and the other precursor(s) having a higher solubility in another liquid component. As one non-limiting example, the plurality of metal precursors may be more soluble in a first liquid component of the liquid vehicle and the substrate precursor may be more soluble in a second liquid component of the liquid vehicle, but the two components of the liquid vehicle may be mutually soluble so that the liquid vehicle has only a single liquid phase comprising the first liquid component, the second liquid component and the dissolved precursors. Alternatively, the liquid vehicle may have two liquid components that are not mutually soluble, so that the liquid vehicle has two, or more, liquid phases (e.g., an emulsion) with one or more precursors dissolved in one liquid phase, for example a continuous phase, and the other precursor(s) dissolved in a second liquid phase, for example a dispersed phase of an emulsion.

In some cases, the liquid vehicle may be selected to act as a solvent for one or more than one precursor to be included in the precursor medium, so that in the precursor medium all or a portion of the one or more than one precursor will be dissolved in the precursor medium. In other cases, the liquid vehicle will be selected based on its volatility. For example, a liquid vehicle with a high vapor pressure may be selected so that the liquid vehicle is easily vaporized and removed from the droplets to the gas phase of the aerosol during the formation of the particles. In other cases, the liquid vehicle may be selected for its hydrodynamic properties, such as viscosity characteristics of the liquid vehicle. For example, if one or more than one precursor is to be included in the precursor medium in the form of dispersed particulates (such as for example colloidal-size particles dispersed in the liquid vehicle), a liquid vehicle having a relatively high viscosity may be selected to inhibit settling of the precursor particles. As another example, a liquid vehicle with a relatively low viscosity may be selected when it is desired to produce smaller droplets of precursor medium during the generating of the aerosol. In still other cases, the liquid vehicle may be selected to reduce or minimize contamination of the composite particles and/or production of undesirable byproducts during the generating of the aerosol or the formation of the composite particles, especially when using organic components in the liquid vehicle.

The liquid vehicle may be an aqueous liquid, an organic liquid or a combination of aqueous and organic liquids. Aqueous liquids are generally preferred for use as the liquid vehicle in most situations because of their low cost, relative safety and ease of use. For example, water has the advantage of being non-flammable, and when vaporized during the formation of the particles does not tend to contribute to formation of byproducts that are likely to complicate processing or contaminate particles. Moreover, aqueous liquids are good solvents for a large number of precursor materials, although attaining a desired level of solubility for some materials may involve modification of the aqueous liquid, such as pH adjustment.

In some situations, however, organic liquids are preferred for the liquid vehicle. This might be the case, for example, when it is desired to dissolve a precursor into the liquid vehicle in situations when the precursor is not adequately soluble in aqueous liquids, or when aqueous liquids are otherwise detrimental to the precursor. For example, an organic liquid vehicle might be necessary to solubilize a number of organic or organometallic precursor materials.

Substrate Precursors

Additionally, the precursor medium preferably comprises one or more substrate precursors. As used herein, a “substrate precursor” is a composition that can be converted to or forms the substrate particles in the composite particles. In a preferred embodiment, the substrate precursors comprise substrate particles, e.g., substrate nanoparticles and/or microparticles, suspended (e.g., as a colloidal suspension) in the liquid medium, which suspended substrate particles form the substrate particles of the composite particles as the liquid vehicle is removed from the precursor medium. In other aspects, the substrate precursor undergoes a reaction to provide the substrate for the composite particles. For example, the substrate precursor optionally is thermally decomposed at elevated temperature or is reduced to form the substrate in the composite particles. In another embodiment, the substrate precursor could process without reaction. For example, the substrate precursor optionally is initially dissolved in the liquid vehicle, and a substrate precipitate of the substrate precursor is formed as the liquid vehicle is removed from the droplets, e.g., as the composite particles are formed. This might be the case, for example, when the substrate precursor comprises an organic salt, organic compound or a polymer dissolved in the liquid medium, which organic salt, organic compound or polymer precipitates out to form all or part of the substrate when the liquid vehicle is vaporized during the formation of the composite particles.

Another example of a substrate precursor that may be processed without reaction comprises a solid substrate material suspended in the liquid vehicle. For example, the substrate precursor could be in the form of colloidal-size substrate particles in the precursor medium, which colloidal particles become part of the composite particles made during formation of the composite particles, the colloidal particles being carbon, conductive metal, carbides, nitrides or metal oxide particles. In another case the precursor medium contains colloidal polymer particles, which colloidal particles then form all or part of the substrate.

Additionally, if useful for subsequent processing or for use in a final application, the colloidal particles in the precursor medium could be surface modified or functionalized. By “functionalized,” it is meant that chemical functional groups have been attached to the surface of the colloidal particles to provide some specific chemical functionality. Such chemical functionality may be designed to aid in the processing of the substrate precursor, to aid in subsequent processing of the composite particles, or for some purpose related to the application for which the composite particles are intended. Also, particulate substrate precursors may be in a form other than colloidal particles, such as for example in the form of fibers, nanotubes or flakes. As another example, such particulate substrate precursors could comprise porous particles, which provide the substrate structure on which the nanoparticles form during formation of the composite particles. Some non-limiting examples of materials that may be useful in solid particulate substrate precursor form include porous ceramic materials (such as, for example, porous carbon, graphitized carbon, metal carbides, metal nitrides, metal oxides and various combinations thereof).

In a particularly preferred embodiment, the substrate precursor comprises carbon, optionally functionalized carbon. Preferably, in this aspect, the substrate precursor comprises suspended modified carbon black particles. For example, the substrate precursor could be in the form of colloidal-size carbon particles in the precursor medium, which colloidal-size carbon particles become the substrate of the composite particles made during formation of the composite particles. Some of the colloidal-size substrate particles may or may not fuse together or agglomerate during the formation of the composite particles. When the precursor medium comprises colloidal-sized substrate particles, e.g., carbon particles, the precursor medium optionally comprises colloidal-size substrate particles in an amount no greater than 60, no greater than 40 or no greater than 20 weight percent. Moreover, such colloidal-size substrate particles preferably have an average size of no larger than about 300 nm, e.g., no larger than about 150 nm, no larger than about 100 nm, or no larger than 50 nm. Additionally or alternatively, the substrate precursor optionally is in a form other than or in addition to colloidal-size carbon particles, such as for example in the form of carbon fibers, carbon nanotubes or carbon flakes. As another example, such particulate substrate precursors could comprise porous carbon particles, which provide the substrate structure on which the alloy nanoparticles form during formation of the composite particles.

In other aspects, the substrate precursor comprises one or more precursors to any conductive composition capable of being formed in the spray processing techniques of the present invention. A non-limiting list of other potential substrate precursors includes precursors to boron carbide, tantalum boride, titanium carbide and reduced titanium oxides. As with the above-discussed carbon precursors, in these aspects, the substrate precursor preferably comprises colloidal size particles of one or more of boron carbide, tantalum boride, titanium carbide and/or reduced titanium oxides.

Metal Precursors

As indicated above, the precursor medium further comprises two or more metal precursors. As used herein, the term “metal precursor” means a metal-containing compound that is dissolved or dispersed in the liquid vehicle, and which may be converted, at least in part, into a corresponding elemental metal (optionally through a metal oxide intermediate), which ultimately may be alloyed to form the alloy nanoparticles that are disposed on the substrate in the final composite particles.

In a preferred embodiment, the metal precursor undergoes a reaction to provide the nanoparticles in the composite particles. For example, the metal precursor optionally is thermally decomposed at elevated temperature or is reduced to form the nanoparticles in the composite particles. In another embodiment, the metal precursor could be processed without reaction to form the nanoparticles. For example, the metal precursor optionally is initially dissolved in the liquid vehicle, and a nanoparticle precipitate of the metal precursor is formed as the liquid vehicle is removed from the droplets, e.g., as the composite particles are formed. This might be the case, for example, when the metal precursor comprises an inorganic composition, e.g., inorganic salt, dissolved in the liquid medium, which inorganic composition precipitates out to form all or part of the nanoparticles when the liquid vehicle is vaporized during the formation of the composite particles. As another example, the metal precursor could volatilize, e.g., with the liquid medium, optionally during the formation of the composite particles and then condense to form all or a portion of the nanoparticles. One particular implementation of this example is the use of an inorganic salt or inorganic compound precursor for the nanoparticles that sublimes or vaporizes and then condenses to form the nanoparticles, preferably before or during the formation of the substrate.

As discussed in more detail below, the step of converting the metal precursors to their corresponding metals and/or metal oxides may occur before or substantially simultaneously with the step of alloying the metals to form the alloy nanoparticles in the composite particles of the present invention. Thus, in one aspect, the conversion of the metals to the alloy nanoparticles may occur in a step after the formation of an intimate mixture of the metals and/or metal oxides. Alternatively, the step of converting the metal precursors to their corresponding metals may occur substantially simultaneously with the step of alloying the metals to form the alloy nanoparticles. The two steps may occur simultaneously, for example, in the spray pyrolysis aspect of the invention, discussed in more detail below.

Table 1 shows some non-limiting examples of some compounds that may be used as metal precursors, and that would normally undergo reaction to form the corresponding metal or metal oxide prior to or during formation of the composite particles. The target materials for which each listed metal precursor provides a component is also listed in Table 1.

TABLE 1
EXEMPLARY METAL PRECURSORS

| TARGET | |
|---|---|
| MATERIAL | EXAMPLES OF METAL PRECURSORS |
| Platinum | Tetraamine platinum hydroxide (Pt(NH₃)₄(OH)₂), |
| | chloroplatinic acid (H₂PtCl₆•xH₂O); tetraamineplatinum |
| | (II) nitrate (Pt(NH₃)₄(NO₃)₂); hydroxoplatinic acid |
| | (H₂Pt(OH)₆); platinum nitrates; platinum amine nitrates; |
| | platinum tetrachloride (PtCl₄); sodium |
| | hexahydroxyplatinum (Na₂Pt(OH)₆); potassium |
| | hexahydroxyplatinum (K₂Pt(OH)₆) and Na₂PtCl₄ |
| Palladium | Tetraamine palladium nitrate (Pd(NH₃)₄(NO₃)₂); |
| | palladium (II) chloride (PdCl₂); palladium (II) nitrate |
| | (Pd(NO₃)₂); H₂PdCl₄; Na₂PdCl₄; Pd(NH₃)₄Cl₂; |
| | Pd(NH₃)₂(OH)₂ and palladium carboxylates |
| Ruthenium | ruthenium β-diketonates; ruthenium nitrosyl nitrate |
| | (Ru(NO)(NO₃)₃); potassium perruthenate (K₃RuO₄); |
| | sodium perruthenate (Na₃RuO₄); (NH₄)₃Ru₂O₇; |
| | NH₄Ru₂O₇; Ru₃(CO)₁₂ and ruthenium chloride (RuCl₃) |
| Gold | gold chloride (AuCl₃) and ammonium tetrachloroaurate |
| | ((NH₄)AuCl₄); hydrogen tetrachloroaurate trihydrate |
| Copper | copper carboxylates; copper acetate (Cu(OOCH₃)₂); |
| | copper chloride (CuCl₂); copper nitrate (Cu(NO₃)₂), and |
| | copper perchlorate (Cu(ClO₄)₂) |
| Rhodium | rhodium chloride hydrate (RhCl₃•xH₂O); ammonium |
| | hexachlororhodium hydrate ((NH₄)3RhCl6•xH₂O) and |
| | rhodium nitrate (Rh(NO₃)₃) |
| Titanium | titanium (III) chloride (TiCl₃); titanium (IV) chloride |
| | (TiCl₄) and tetrachlorodianimmo titanium (TiCl₄(NH₃)₂) |
| Vanadium | vanadium (III) chloride (VCl₃); vanadium (IV) chloride |
| | (VCl₄); vanadium fluoride (VF₄) and ammonium |
| | vanadium oxide (NH₄VO₃) |
| Manganese | manganese (II) acetate hydrate (Mn(OOCCH₃)₂•xH₂O); |
| | manganese (III) acetate hydrate (Mn(OOCCH₃)₂•xH₂O); |
| | manganese chloride hydrate (MnCl₂•xH₂O); manganese |
| | nitrate (Mn(NO₃)₂) and potassium permangate (KMNO₄) |
| Iron | iron acetate (Fe(OOCCH₃)₂); iron chloride hydrate |
| | (FeCl₂•xH₂O); iron chloride hydrate (Fecl₃•xH₂O); iron |
| | nitrate hydrate (Fe(NO₃)₃•xH₂O); iron (II) perchlorate |
| | hydrate (Fe(ClO₄)₂•xH₂O) and iron (III) perchlorate |
| | hydrate (Fe(ClO₄)₃•xH₂O) |
| Cobalt | cobalt acetate hydrate (Co(OOCCH₃)₂•xH₂O); cobalt |
| | chloride hydrate (CoCl₂•xH₂O) and cobalt nitrate hydrate |
| | (Co(NO₃)₂•xH₂O) |
| Tungsten | tungsten oxychloride (WOCl₄) and ammonium tungsten |
| | oxide ((NH4)₁₀W₁₂O₄₁) |
| Zinc | zinc acetate (Zn(OOCCH₃)₂•xH₂O); zinc chloride |
| | (ZnCl₂); zinc formate (Zn(OOCH)₂) and zinc nitrate |
| | hydrate (Zn(NO₃)₂•xH₂O). |
| Zirconium | zirconium chloride (ZrCl₄); zirconium hydride (ZrH₂) |
| | and zirconium dinitrate oxide (ZrO(NO₃)₂•xH₂O) |
| Niobium | niobium chloride (NbCl₅) and niobium hydride (NbH) |
| Molybdenum | molybdenum chloride; molybdenum hexacarbonyl |
| | (Mo(CO)₆); ammonium paramolybdate |
| | ((NH₄)Mo₇O₂₄•xH₂O); ammonium molybdate |
| | ((NH₄)₂Mo₂O₇) and molybdenum acetate dimer |
| | (Mo[(OCOCH₃)₂]₂) |
| Tin | SnCl₄•xH₂O |
| Osmium | OsCl₃ |
| Silver | complex silver salts ([Ag(RNH₂)₂]⁺, Ag(R₂NH)₂]⁺, |
| | [Ag(R₃N)₂]⁺ where R = aliphatic or aromatic; [Ag(L)ₓ]⁺ |
| | where L = ziridine, pyrrol, indol, piperidine, pyridine, |
| | aliphatic substituted and amino substituted pyridines, |
| | imidazole, pyrimidine, piperazine, triazoles. etc.; |
| | [Ag(L)ₓ]⁺ where L = ethanolamine, glycine, gormamides, |
| | acetamides or acetonitrile); Silver nitrate (AgNO₃) |
| Nickel | Ni-nitrate (Ni(NO₃)₂); Ni-sulfate (NiSO₄); Nickel |
| | ammine complexes ([Ni(NH₃)₆]ⁿ⁺ (n = 2, 3)); Ni- |
| | acetylacetonate ([Ni(acac)₂]₃ or Ni(acac)₂(H₂O)₂); Ni- |
| | hexafluoroacetylacetonate (Ni[CF₃COCH═C(O—)CF₃]₂); |
| | Ni-formate (Ni(O₂CH)₂); Ni-acetate (Ni(O₂CCH₃)₂) |
| Iridium | Iridium (IV) chloride; Hydrogen hexachloroiridate (IV) |
| | hydrate; Ammonium hexachloroiridate (III) monohydrate |
| Chromium | Chromium nitrate (Cr(NO₃)₃); chromium chloride |
| | (CrCl₃) |
| Rhenium | Rhenium (VII) oxide; Rhenium (III) chloride |
| Chromium | K₂Cr₂O₇; chrome carboxylates; and chromium oxalate |
| Oxide | |
| Manganese | KMnO₄; manganese nitrate; manganese acetate; |
| Oxide | manganese carboxylates; manganese alkoxides; and |
| | MnO₂ |
| Tungsten | Na₂WO₄ and W₂O₃ |
| Oxide | |
| Molybdenum | K₂MoO₄ and MoO₂ |
| Oxide | |
| Cobalt Oxide | cobalt-amine complexes; cobalt carboxylates and cobalt |
| | oxides |
| Nickel Oxide | nickel-amine complexes; nickel carboxylates and nickel |
| | oxides |
| Copper | copper-amine complexes; copper carboxylates and |
| Oxide | copper oxides |
| Iron Oxide | iron nitrate |

Because of their lower cost, some preferred precursors from Table 1 include nitrates, acetates and chlorides.

The step of converting the metal precursors to the corresponding metals and/or metal oxides (prior to alloying) may occur in any of a number of steps according to the present invention. For example, the metals or metal oxides (preferably as metal or metal oxide nanoparticles) may be formed during the step of generating the aerosol, and/or during one or more subsequent processing steps. It is also contemplated that the metals or metal oxides may be formed from the metal precursors, at least in part, prior to the step of generating the aerosol. For example, the metals or metal oxides optionally are formed as the precursor medium is prepared. In this embodiment, one or more of the metals or metal oxides are formed from one or more metal precursors in situ within the precursor medium, at least in part, prior to the step of generating the aerosol from the precursor medium, as discussed in more detail below.

In a similar aspect, one or more of the metal precursors comprise metal and/or metal oxide nanoparticles. In this aspect, the metal and/or metal oxide nanoparticles may be added to the liquid vehicle, and the precursor medium comprises metal and/or metal/oxide nanoparticles dispersed therein. The nanoparticles could be in the form of colloidal-size metal and/or metal oxide nanoparticles in the precursor medium, which colloidal particles become part of the alloy nanoparticles during formation of the composite particles. When the precursor medium comprises colloidal-size metal and/or metal oxide nanoparticles, the precursor medium preferably comprises the colloidal-size metal and/or metal oxide nanoparticles in an amount no greater than 60, no greater than 40 or no greater than 20 weight percent. Moreover, such colloidal-size particles preferably have an average size of no larger than about 20 nm and more preferably having a weight average size of no larger than about 5 nm. Many processes are known for forming metal nanoparticles. See, for example, U.S. Patent Publications Nos. US 2003/0148024 A1, filed Oct. 4, 2002; US 2003/0180451 A1, filed Oct. 4, 2002; US 2003/0175411 A1, filed Oct. 4, 2002; US 2003/0124259, filed Oct. 4, 2002, US 2003/0108664 A1, filed Oct. 4, 2002, and US 2003/0161959 A1, filed Nov. 1, 2002, the entireties of which are incorporated herein by reference. See also U.S. Provisional Patent Application Ser. Nos. 60/643,577; 60/643,629; and 60/643,378, all filed on Jan. 14, 2005, the entireties of which are incorporated herein by reference.

As previously noted, the metals and/or metal oxides formed from the metal precursors, prior to alloying, may be in the form of metal and/or metal oxide nanoparticles. In other aspects, the metals and/or metal oxides formed from the metal precursors do not form metal and/or metal oxide nanoparticles until during and/or after the alloying step. Instead, the metals and/or metal oxides formed from the metal precursors are intimately mixed on the surface of the substrate particles prior to alloying.

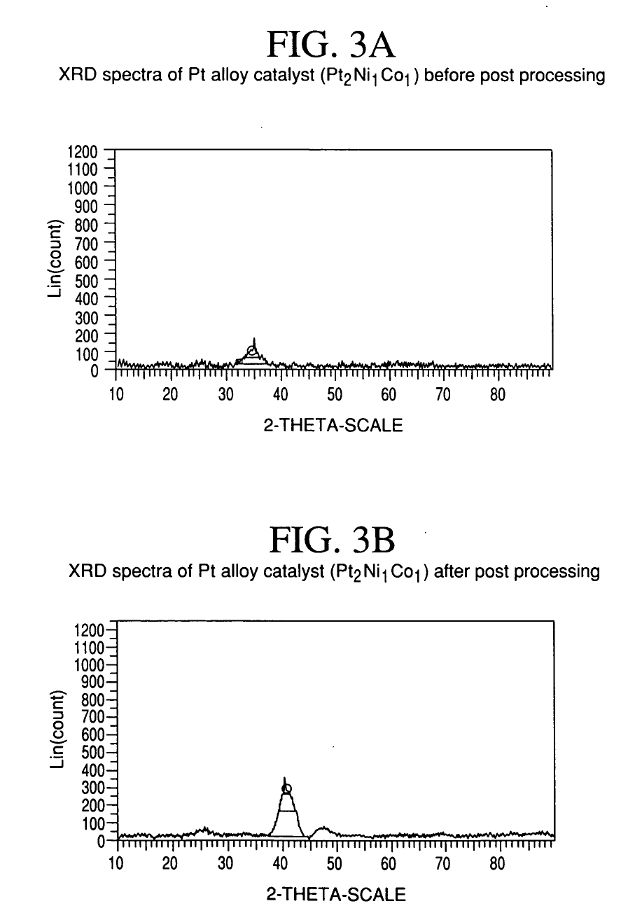

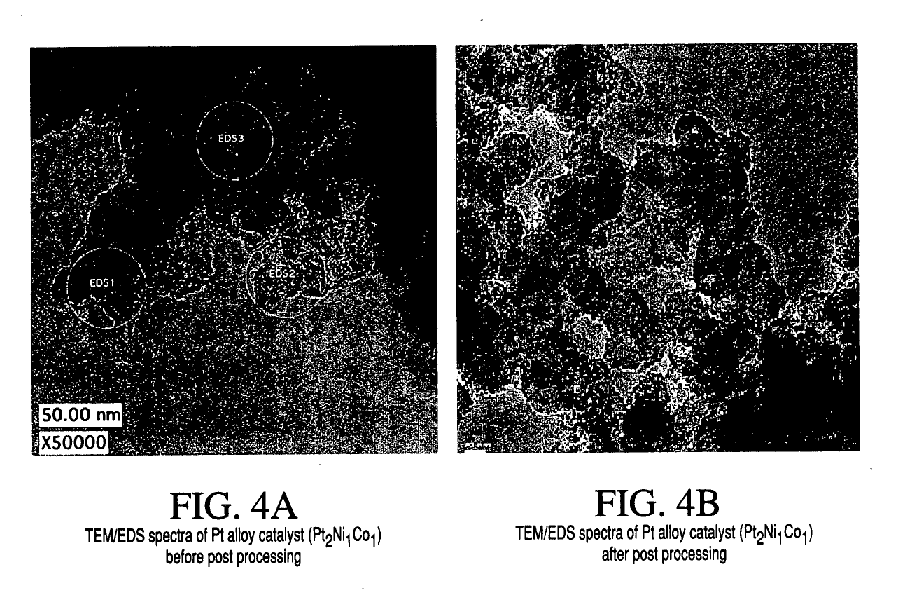

X-ray diffraction (XRD) techniques may be used to determine the degree of alloying. FIGS. 3A-B, for example, provide XRD profiles obtained during the formation of ternary PtNiCo alloy (Pt₂Ni₁Co₁). FIG. 3A provides an XRD profile of spray dried particles, prior to alloying, and FIG. 3B shows an XRD profile of catalyst particles, i.e., after alloying. No Pt fcc phase or precursor peaks can be found in FIG. 3A, which means that metal precursors have been fully decomposed and the precursors to the alloy are intimately mixed. The alloy phase, however, has not been formed. As shown in FIG. 3B, after post-processing in reducing atmosphere at, e.g., 250° C. to 350° C., Pt alloy fcc phase was formed as detected by X-ray Diffraction (XRD) and the position of the Pt(111) peak 2θ=40.36 and face center cubic lattice constant a=3.870 Å being indicative of formation of alloy. For comparison, the position of the Pt(111) peak for pure Pt crystallites is at 2θ=39.8. The average alloy particle size as estimated by XRD peak broadening is d=2.4 nm and corresponds to a surface area of the alloy particles of approximately 154 m²/g. In confirmation of the XRD data, a high resolution TEM of the powders before post processing shows no visible crystallites and confirms that intimate mixing is achieved (FIG. 4A). For the same powder, after the post processing step conducted by heating the catalysts at 250° C. in reducing atmosphere, highly dispersed metal alloy particles were formed with particle size in the range of 1-3 nm as also observed by TEM showing high dispersion in confirmation of the XRD data (FIG. 4B).

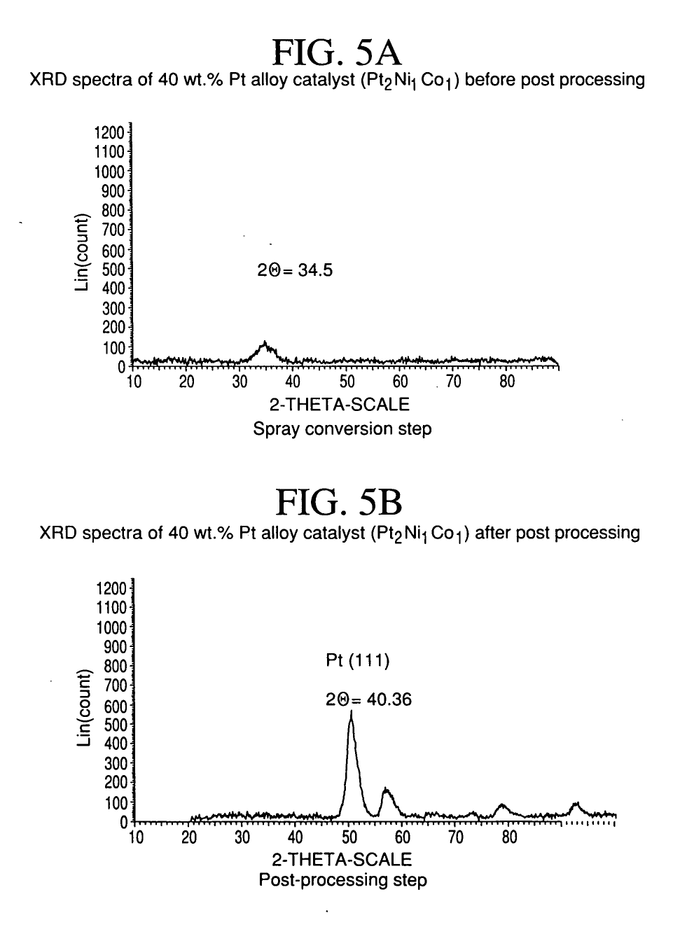

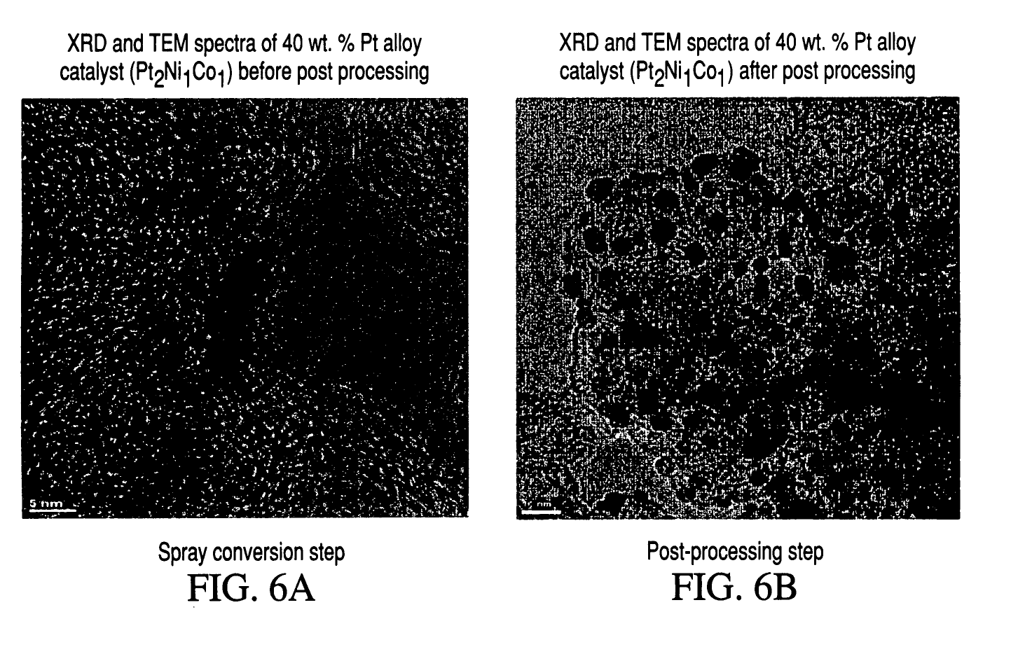

If nanoparticles are formed before alloying, the metal or metal oxide nanoparticles have an average number particle diameter of less than about 5 nm, and typically in a range of from 1 nm to 3 nm, based on electron microscopy, although a higher diameter or diameter range might be more preferred for some applications. One particular advantage of the process of the present invention is the ability to make intimately mixed metal or metal oxide structures, prior to alloying, having a number average particle diameter of from about 1 nm to about 3 nm. This can be demonstrated for supported alloy compositions with broad range of concentrations on the support, ranging from 1 to about 80 wt. % metal content, more preferably from about 20 to 80 wt. % metal and even more preferably from about 40 to 80 wt. % metal supported on carbon. FIGS. 5 and 6 illustrate the above with experimental XRD and TEM data for a 40 wt. % Pt alloy catalysts before and after post processing.

If metal and/or metal oxide nanoparticles are formed before alloying, controlling the size of the nanoparticles may be important in the processes of the present invention in that the size of the metal and/or metal oxide nanoparticles correlate generally to the size of the ultimately formed alloy nanoparticles. That is, larger metal and/or metal oxide nanoparticles will tend to ultimately form larger alloy nanoparticles, and smaller metal and/or metal oxide nanoparticles will tend to ultimately form smaller alloy nanoparticles. With the present invention, there is a significant ability to control nanoparticulate growth through the use of the substrate structure and process conditions. For example, smaller metal or metal oxide nanoparticles are generally favored for production in the gas phase during particle formation through the use of smaller proportions of metal precursors to substrate precursors in the liquid medium and shorter residence times of the aerosol in a thermal zone during processing. Also, because of the retention of the nanoparticles in a distributed state on the surface of the substrate structure, with the present invention the metal and/or metal oxide nanoparticles may be subjected to additional processing steps, either during or after the step of forming the metal and/or metal oxide nanoparticles to achieve sufficient degree of alloying and minimize the growth of the nanoparticles to a desired size, such as for example by relatively low temperature 250-500° C. in reducing atmosphere thermal treatment to minimize the agglomeration or coalescence of smaller nanoparticulate domains and still achieve sufficient degree of alloying necessary for performance and durability of these materials.

As indicated above, the processes for manufacturing composite particles of the present invention form alloy nanoparticles disposed on a surface of the substrate. Accordingly, the precursor medium comprises at least two metal precursors in order to form at least two different metals and/or metal oxides, which can be ultimately alloyed to form the alloy nanoparticles that are disposed on the substrate in the composite particles of the present invention. In several particularly preferred embodiments of the present invention, the precursor medium comprises two, three, four, five, six or more metal precursors to form intimate mixtures of two, three, four, five, six or more corresponding metals and/or metal oxides which consequently can be alloyed to form an alloy particles comprising two, three four or more elements, such as binary, ternary or quaternary alloy nanoparticles.

Additives

In addition to the above-described components, the precursor medium optionally includes one or more additives or reagents. The additive optionally comprises one or more of a surfactant, a reducing agent, an oxidizing agent, one or more polymers and/or surfactant additives.

In one aspect of the invention, the precursor medium comprises one or more reagent additives, in addition to the liquid vehicle and the precursors. As used herein, a “reagent additive” or a “reagent” in the precursor medium is a material, other than the liquid vehicle, that is included in the precursor medium for a reason other than to provide a component for inclusion in the ultimately formed composite particles. Rather, the reagent additive serves another purpose that is beneficial to the formulation of the precursor medium or aids during processing to make the composite particles. An example of a reagent additive would be, for example, a base or acid material added to adjust solution pH of the liquid vehicle.

One important example of a reagent additive for some implementations of the invention is a reducing agent. The optional reducing agent may be in the form of a particulate suspended in the liquid vehicle or, more likely, will be dissolved in the liquid vehicle. The purpose of the reducing agent is to assist creation of an environment during formation of the composite particles that promotes formation of a material in a chemically reduced form that is desired for inclusion in the composite particles as the composite particles are formed. For example, the reducing agent may facilitate the conversion of one or more of the metal precursors to the corresponding metal nanoparticles. In the former embodiment, the reducing agent is included to promote reduction of a metal oxide, salt or other metal precursor compound to the desired metallic form. A reducing agent does not necessarily reduce an oxidized material to form a desired reduced form of the material, but may simply change the chemistry of the precursor medium to favor the formation of the reduced form of the material, such as by scavenging or otherwise tying up oxidizing materials present in the environment. In some implementations, the reduced form of the material could be made without the use of the reducing agent by processing the aerosol at a higher temperature as the composite particles are formed, but use of the reducing agent permits the desired reduced form of the material to be made at a lower temperature. An important application is when making particles that include metallic nanoparticles and substrate including a material that cannot be effectively processed at high temperatures that may be required to prepare the metal and/or metal oxide nanoparticles absent the use of a reducing agent. For example, use of a reducing agent may permit the processing temperature to be maintained below the melting temperature of the substrate precursor, or below the decomposition temperature of the substrate material itself, whereas the processing temperature would exceed those limits without use of the reducing agent.

As an alternative to including a reducing agent in the precursor medium, a reducing agent could instead be included in the gas phase of the aerosol, such as for example using a nitrogen gas phase or other oxygen-free gas composition with addition of some hydrogen gas as a reducing agent. In other situations, the reduced form of the material could be formed even at the desired lower temperature using a nonoxidizing gas phase in the aerosol, such as pure nitrogen gas or some other oxygen-free gas composition. However, by including a reducing agent in the precursor medium, the use of a nonoxidizing gas phase or a reducing agent in the gas phase may often be avoided, and air may instead be used as the gas phase. This is desirable because it is usually much easier and less expensive to generate and process the aerosol using air. The reducing agent preferably donates electrons (is oxidized) and/or is a material that either reacts to bind oxygen or that produces decomposition products that bind with oxygen. The bound oxygen often exits in the gas phase in the form of one or more components such as water vapor, carbon dioxide, carbon monoxide, nitrogen oxides and sulfur oxides. Reducing agents included in the precursor medium optionally are carbon-containing materials with carbon from the reducing agent reacting with oxygen to form carbon dioxide and/or carbon monoxide. In a preferred aspect, the substrate precursor comprises carbon and a portion of the substrate precursor may act as a reducing agent to facilitate the conversion of one or more metal precursors to their corresponding metal and/or metal oxide. The reducing agent may also contain hydrogen, which reacts with oxygen to form water. Table 2 shows some non-limiting examples of reducing agents that may be included in the precursor medium, typically dissolved in the liquid vehicle.

TABLE 2
EXEMPLARY REDUCING AGENTS

| MATERIALS | SPECIFIC EXAMPLES |
|---|---|
| Amines | Triethyl amine; Amino |
| | propanol |
| Boranes | Borane-tetrahydrofuran |
| Borane adducts | Trimethylamineborane |
| Borohydrides | Sodium borohydride, |
| | lithium borohydride |
| Hydrides | Tin hydride, lithium |
| | hydride, lithium aluminum |
| | hydride |
| Alcohols | Methanol, ethanol, |
| | isopropanol, terpineol, t- |
| | butanol, ethylene glycols, |
| | citrates, other polyols |
| Silanes | Dichlorosilane |
| Carboxylic acid | Formic acid |
| Aldehyde | Formaldehyde; octanal, |
| | decanal, dodecanal, glucose |
| Hydrazines | Hydrazine, hydrazine |
| | sulfate |
| Phosphorous compounds | Hypophosphoric Acid |

Table 3 shows non-limiting examples of some preferred combinations of reducing agents and metal precursors that may be included in the precursor medium for manufacture of a variety of metal nanoparticles.

TABLE 3
EXEMPLARY METAL PRECURSOR/
REDUCING AGENT COMBINATIONS

| METAL PRECURSOR | REDUCING AGENT |
|---|---|
| Most Metal Nitrates | Amines (e.g. triethylamine), |
| | ethylene glycols, alcohols |
| | (terpineol), aminopropanol |
| Copper Nitrate | Long chain alcohols; citrates, |
| | carboxylates |
| Most Metal Carboxylates | Amines (e.g. triethylamine), |
| | ethylene glycols, alcohols |
| | (terpineol), aminopropanol |

Another important reagent additive that may be included in the precursor medium in some implementations of the invention is an oxidizing agent. The purpose of an oxidizing agent is to help create an environment during formation of the composite particles that is conducive to making a desired oxidized form of a material for inclusion in particles made during the forming particles. The oxidizing agent may provide oxygen in addition to the oxygen that might be present when air is used as the gas phase to make the aerosol. Alternatively, the oxidizing agent may be used in combination with a nonoxidizing carrier gas, such as pure nitrogen gas, to provide a controlled amount of oxygen to form the desired oxidized form of the material.

Table 4 shows non-limiting examples of some oxidizing agents that may be included in the precursor medium, typically dissolved in the liquid vehicle, such as to assist in the making of oxide materials.

TABLE 4
OXIDIZING AGENTS

| TYPES | EXAMPLES | CHEMICAL FORMULA |
|---|---|---|
| Amine Oxides | Trimethylamine-N-Oxide | Me₃NO |
| Mineral Acids | nitric acid, sulfuric acid, | HNO₃, H₂SO₄, |
| | aqua regia | HNO₃/HCl |
| Organic Acids | carboxylic acids | R—COOH |
| Peroxides | hydrogen peroxide | HOOH |
| Phosphine Oxides | trioctyl phosphine Oxide | OP(C₈H₁₇)₃ |
| Ozone | | O₃ |
| Sulfur Oxides | sulfur dioxide | SO₂ |
| Ammonia in | | NH₃ & O₂ |
| combination with | | |
| Oxygen | | |

The relative quantities of precursors, liquid vehicle and additives in the precursor medium will vary, depending on, for example, the desired composition and morphology of the composite particles to be produced according to the present invention and the particular feed materials used to prepare the aerosol during the generation of the aerosol. In most situations, however, the liquid vehicle will be present in the precursor medium in the largest proportion, with the precursor medium typically comprising at least about 50 weight percent liquid vehicle and often at least about 70 weight percent liquid vehicle.

In one aspect, the precursor medium comprises one or more polymer and/or surfactant additives, which modify the properties of the precursor medium, e.g., to facilitate the spray processing thereof. A non-limiting list of such additives is provided below in Table 5.

TABLE 5
POLYMER AND/OR SURFACTANT ADDITIVES

| Name | Supplier | CAS No. |
|---|---|---|
| Surfynol CT-324 Dispersant | Air Products | 68412-54-4 |
| | | 111-76-2 |
| Surfynol 2502 Surfactant | Air Products | 182211-02-5 |
| Surfynol CT-136 Dispersant | Air Products | 126-86-3 |
| FC 4434 Fluoroaliphatic Polymeric Esters | 3M | 34590-94-8 |
| Ethacryl P Dispersant | Lyondell | 220848-20-4 |

Generation of the Aerosol

As indicated above, in various embodiments of the present invention, a mist or aerosol is generated from the precursor medium. As used herein, the term “aerosol” means a gas dispersion comprising a disperse phase that includes a plurality of droplets dispersed in and suspended by a gas phase. Thus, as generated, the aerosol has a disperse phase of droplets of the precursor medium dispersed in and suspended by the gas phase.

The aerosol may be prepared using any technique for atomizing the precursor medium (e.g., converting the precursor medium to an aerosol of finely divided form of droplets). During the step of generating the aerosol, the atomized droplets of precursor medium are dispersed and suspending in a gas phase.

As noted previously, in the step of generating the aerosol, droplets of the precursor medium are formed, dispersed and suspended in a carrier gas to form the aerosol. The droplets may be generated using any appropriate apparatus for finely dividing liquids to produce droplets. Apparatuses for generating such droplets are referred to by a variety of names, including liquid atomizers, mist generators, nebulizers and aerosol generators. The technique and apparatus used to generate the aerosol may vary depending upon the application.

One example of an apparatus for generating the droplets and mixing the droplets with the carrier gas to form the aerosol is an ultrasonic aerosol generator, in which ultrasonic energy is used to form or assist formation of the droplets. One type of ultrasonic aerosol generator is a nozzle-type apparatus, with the nozzle ultrasonically energizable to aid formation of droplets of a fine size and narrow size distribution. Another example of an ultrasonic aerosol generator ultrasonically energizes a reservoir of precursor medium, causing atomization cones to develop, from which droplets of the precursor medium form, and the droplets are swept away by a flowing carrier gas. The reservoir-type ultrasonic aerosol generators can produce very small droplets of a relatively narrow size distribution and are preferred for use in applications when the final composite particles are desired to be in a range of from about 0.2 to about 5 microns (weight average particle size), and especially when a narrow size distribution of the particles is desired. An example of a reservoir-type ultrasonic aerosol generator is described, for example, in U.S. Pat. No. 6,338,809, the entire contents of which are incorporated by reference herein as if set forth herein in full. Although both the nozzle-type ultrasonic aerosol generator and the reservoir-type ultrasonic aerosol generator produce small droplets of a relatively narrow size distribution, the reservoir-type generally produces finer droplets of a more uniform size.

Another example of an apparatus for generating droplets is a spray nozzle (not ultrasonically energized). Several different types of spray nozzles exist for producing droplets in aerosols, and new spray nozzles continue to be developed. Some examples of spray nozzles include 2-fluid nozzles, gas nozzles and liquid nozzles. Spray nozzle generators have an advantage of very high throughput compared to ultrasonic generators. Droplets produced using spray nozzles, however, tend to be much larger and to have a much wider size distribution than droplets produced by ultrasonic generators. Therefore, spray nozzles are preferred for making relatively large composite particles. Other types of droplet generators that may be used include rotary atomizers, and droplet generators that use expansion of a supercritical fluid or high pressure dissolved gas to provide the energy for droplet formation. Still another process for generating droplets is disclosed in U.S. Pat. No. 6,601,776, the entire contents of which are incorporated herein by reference in as if set forth herein in full.

It will be appreciated that no matter what type of droplet generator is used, the size of the composite particles ultimately produced will depend not only upon the size of the droplets produced by the generator, but also on the composition of the precursor medium (such as the concentration and types of precursor(s) in the precursor medium).

As initially generated, the aerosol will have a gas phase that is wholly, partially or primarily composed of the carrier gas used to generate the aerosol. The gas phase may have some minor components provided by the precursor medium during the generation of the aerosol, such as some liquid vehicle vapor from vaporization of some liquid vehicle during the generation of the aerosol. The carrier gas may be any convenient gas composition and may be, for example, a single component gas composition (such as for example pure nitrogen gas) or a mixture of multiple gas components (such as for example air, or a mixture of nitrogen and hydrogen). As the aerosol is processed, however, the composition of the gas phase will change. For example, during the formation of the particles, the liquid vehicle is removed from the droplets to the gas phase, typically by evaporation caused by heating. Also, if the precursor medium contains reactive precursors or reagents, as the precursors or reagents react, the composition of the gas phase will contain decomposition products and reaction byproducts. At the conclusion of the forming of the composite particles or an intermediate particle thereof, the aerosol will typically comprise an altered gas phase composition and a dispersion of the composite particles.

In some implementations, the carrier gas used to generate the aerosol will be substantially non-reactive. For example, the gas phase may contain only one or more inert gases, such as nitrogen and/or argon, depending upon the situation. Air can be used as a non-reactive carrier gas, when the oxygen component of the air is not reactive during processing. In other cases the carrier gas will include one or more reactive components that react during processing, and often during the formation of the composite particles. For example, the carrier gas, and therefore the gas phase of the aerosol as generated, may contain a reactive precursor to a material for inclusion in the particles (such as for example reactive oxygen gas when making some oxide materials) or a reactive reagent (such as hydrogen gas useful as a reducing agent when making some metallic or alloy containing materials).

Processing of the Droplets

After the aerosol is generated, the aerosol preferably is processed in order to: (1) remove at least a portion of the liquid vehicle in the droplets; (2) convert the substrate precursor to the supporting substrate particles; (3) convert the metal precursors to their corresponding metals and/or metal oxides; and (4) alloy the metals ultimately formed from the metal precursors and form alloy nanoparticles on the substrate particles.

During the processing step(s), the liquid vehicle is removed from the droplets and intermediate particles are formed (at least momentarily), which particles are dispersed in the aerosol. As used herein, the term “intermediate particle” means a particle formed from the precursor medium, which particle has not yet been fully alloyed. The intermediate particle preferably comprises a substrate particle and one or more unalloyed metals and/or metal oxides disposed on the surface of the substrate particle.

Removal of the liquid vehicle from the droplets may be accomplished, for example, by vaporizing the liquid vehicle to form a vaporized vehicle, which is yielded into and mixed with the gas phase. Such vaporization is preferably aided by heating of the aerosol (a process also referred to herein as spray drying). Also during the processing step, precursors (e.g., the metal precursors and/or the substrate precursor(s)) in the aerosol may undergo one or more reactions or other transformations or modifications required to make the intermediate particles and, ultimately, the composite particles.

Thus, the processing step may include, for example, reaction of precursors, material phase redistribution, crystal growth or regrowth, metal alloying (alloy nanoparticle phase formation), substrate phase formation, size growth the substrate particles and/or alloy nanoparticles (such as through particle agglomeration and/or coalescence), compositional modification, particle coating, etc. During the formation of the alloy nanoparticles, several processes such as interaction with the support surface groups, surface diffusion of precursor species, decomposition of precursors to a metal or metal oxide species and agglomeration of metal and metal oxide clusters may occur simultaneously, although at different rates. Depending on the relative rates at which these processes occur, they can lead to the formation of nanoparticles of different sizes, dispersion and uniformity of the their distribution on the surface of the support particles. For example, if the rate of diffusion of the precursor species and agglomeration of nanoparticles is the dominant and faster process (driven by the processing temperature and precursor properties) then nanoparticles with large size and lower active specific surface area will be formed while if precursors with lower decomposition temperature and short processing times are used, highly dispersed nanoparticles will be formed. In the case of formation of alloy nanoparticles, depending on the processing conditions and reaction atmosphere, reduction, segregation and alloying processes may occur in addition to the processes described above, and alloy nanoparticles of various morphology can be generated. For example, the process of agglomerating alloy nanoparticles can be faster compared to the time necessary to achieve uniform mixing and alloying of the nanoparticle elements and, in this case, a large size alloy nanoparticles will be formed with lower active surface area. Alternatively, if the processes of alloying and reduction occur simultaneously and the agglomeration is minimized due to selected processing conditions, highly dispersed alloy nanoparticles will be formed delivering high specific surface area for the catalytic reaction. In one aspect of the current invention, the formation of the alloy nanoparticles is done at relatively dry conditions at the surface of the support at which the rates of diffusion of surface species is lower compared to a synthesis via liquid synthesis routes when the surface diffusion and potential agglomeration of the nanoparticles is favored.

At some point in the processing, metal nanoparticles may be formed from the metal precursors. For example, particles formed in the aerosol may not have undergone all necessary chemical reactions or morphological modifications necessary to form the desired final composite particles. In this case, the particles may be collected from the aerosol and subjected to a subsequent heat treatment during which precursor reactions or other particle transformations or modifications (including alloying) may occur that are required to make the desired final particles. Also, all precursors and reagents required to form the desired final composite particles may be included in the aerosol, or one or more precursor or reagent may be introduced separately during subsequent processing steps.

The formation of the intermediate or composite particles may be performed in any apparatus suitable for removing liquid vehicle from the droplets to the gas phase of the aerosol and reacting or otherwise processing the precursors to make the composite particles. Reactions to be accommodated during formation of the composite particles may include, for example, thermal decomposition of precursor(s), reaction of precursor(s) with other materials, reaction of reagents, and alloying of metals formed from the metal precursors. Other processing of the precursors that may occur during formation of the composite or intermediate particles may include for example, precipitating dissolved precursor(s) from the liquid vehicle and fusing particulate precursor(s).

Removing the liquid vehicle from the droplets, reacting the metal precursor(s) and alloying the resulting metals may occur in the same equipment (e.g., spray pyrolysis) or different equipment (e.g., spray drying followed by oven heating). Accordingly, the steps of (a) removing the liquid vehicle to form intimate mixtures of metals, and (b) alloying the metals to form alloy nanoparticles may occur sequentially or substantially simultaneously.

In a first aspect, the step of removing the liquid vehicle occurs by vaporizing the liquid vehicle and causing the vaporized liquid vehicle to mix into the gas phase of the aerosol. Vaporization of the liquid vehicle is preferably accomplished by heating the aerosol, e.g., in a spray dryer, to a temperature at which most, and preferably substantially all, of the liquid vehicle in the droplets vaporizes. Spray dryers have the advantage of having high throughput, which allows large amounts of particles to be produced. In one embodiment, the step of removing the liquid vehicle comprises heating the droplets, e.g., in a spray dryer, to a maximum temperature of from about 100° C. to about 600° C. (e.g., from about 100° C. to about 500° C. or from about 200° C. to about 400° C.) for a period of time of at least about 1 seconds, e.g., at least 3 second, at least about 20 seconds or at least about 100 seconds. Simultaneously, the metal precursors preferably are converted to their corresponding metals (or possibly to a metal oxide intermediate), which preferably are intimately mixed with one another. The formation of a mixture of (non-alloyed) metals from the metal precursors preferably occurs substantially in the liquid vehicle removal step, although it is contemplated that some of the conversion of one or more metal precursor(s) to their corresponding metal(s) may occur at least partially in the alloying step. The removal of the liquid vehicle from the droplets may be performed in a reactor, furnace or using spray drying equipment, to produce intermediate particles that are collected for further processing.

In some cases, the intermediate particles made by removing the liquid vehicle from the droplets may not have distinct substrate and metal nanoparticulate phases, but may contain a single phase of mixed precursor(s) that have not yet reacted to form the substrate and/or metal or alloy nanoparticles. However, in other cases the substrate precursor(s) and/or the metal precursor(s) may already be in separate phases. The intermediate particles made by removing the liquid vehicle from the droplets may then be subjected to one or more heat treatment steps in a separate reactor or furnace (e.g. box furnace, belt furnace, tray furnace, rotary furnace or hydrogen furnace) to react the precursors and form the desired substrate and metals and/or to alloy the metals formed form the metal precursors and create the alloy nanoparticulate/substrate structure of the final composite particles.

In this embodiment, the alloying of the mixed metals (formed from the metal precursors) on the intermediate particles preferably occurs primarily or totally in a separate step or steps, e.g., in one or more reactors that are separate from the device that removed the liquid vehicle (e.g., spray dryer). By a reactor, it is meant an apparatus in which a chemical reaction or structural change to a material is effected.

The type of reactor(s) used to alloy the metals on the intermediate particles and form the final composite particles may vary widely. In preferred aspects, the reactor used to alloy the metals on the intermediate particles comprises a plasma reactor, a laser reactor or a hot-wall furnace reactor. In other aspects, the reactor includes, for example, a box furnace, hydrogen furnace, belt furnace, a rotary furnace or a tray furnace, with or without the introduction into the furnace of additional reactant(s) or control of the furnace atmosphere.

In a plasma reactor, the aerosol is passed through an ionized plasma zone, which provides the energy for effecting reactions, alloying and/or other modifications in the aerosol. In a laser reactor, the aerosol is passed through a laser beam (e.g., a CO₂ laser), which provides the energy for effecting reactions, alloying and/or other modifications in the aerosol. Plasma reactors and laser reactors have an advantage of being able to reach very high temperatures, but both require relatively complicated peripheral systems and provide little ability for control of conditions within the reactor during particle formation. In a hot-wall furnace reactor, heating elements heat zones of the inside wall of the reactor to provide the necessary energy to the aerosol as it flows through the reactor. Hot-wall furnace reactors have relatively long residence times relative to flame, plasma and laser reactors. Also, by varying the temperature and location of heat input from heating elements in the different heating zones in the reactor, there is significant ability to control and vary the environment within the reactor during particle formation.

In an alternative embodiment, the liquid vehicle removal step occurs substantially simultaneously with the step of alloying the metals formed from the metal precursors. In this embodiment the spray processing method combines the removal of the liquid vehicle (drying) to form intermediate particles and the heating of the intermediate particles to form the composite particles of the present invention in one step, e.g., where both the removal of the liquid vehicle(s) and the conversion (e.g., the formation of metal from the metal precursors and/or the alloying of the metal to form alloy nanoparticles) of a dry intermediate particles to the composite particles essentially simultaneously. This method is referred to as “spray pyrolysis.” In spray pyrolysis, the steps of forming the metals from the metal precursors and the alloying of the metals occur substantially simultaneously. Spray pyrolysis is further described in U.S. Provisional Patent Application Ser. No. 60/645,985, filed on Jan. 21, 2005, the entirety of which is incorporated herein by reference.

It should be noted that in some cases during the heat treatment two or more substrate particles may fuse together to form a continuous structure of substrate material with metal and/or alloy nanoparticles dispersed thereon, as shown in FIGS. 2D and 2E. If it is desirable to have discrete composite particles, the continuous structure may be jet milled or hammer milled to form separate composite particles.

Spray conversion or spray pyrolysis is a valuable processing method because the particles are raised to a high temperature for a short period of time. The relatively high temperature achieves conversion of the metal precursors to the final desired phase (metal compositions, and ultimately alloy nanoparticles), but the short time ensures little surface diffusion that can cause agglomeration of the nanometer-sized alloy phase. Hence, the support phase is formed having well dispersed nanometer sized alloy phase particles disposed thereon.

Collection and Quenching of the Composite Particles

In one embodiment, the process of the present invention includes a step of collecting the composite particles after the formation of the particles. The collecting of the particles may be performed, for example, immediately following formation of the composite particles or after further processing of the particles in aerosol. During the collecting of the particles, at least a portion and preferably substantially all of the particles are separated from the aerosol. The separation may be effected by any solid/gas separation technique, for example by using a filter, a cyclone, bag house, or electrostatic precipitator.

In one preferred embodiment, during the collection of the particles the composite particles are separated from the gas phase of the aerosol directly into a liquid medium. The particles may be collected directly into the liquid medium by spraying the liquid medium into the aerosol, such as by using venturi scrubbers, to capture the particles in the droplets of liquid medium, and then collecting the liquid medium containing the particles. The particles may be collected directly into a liquid medium by impinging the particles into a “wall” of liquid medium, such as by using a wetted wall electrostatic precipitator. The wall of liquid medium may be, for example, a flowing film or sheet of the liquid medium. The gas phase of the aerosol may pass through the wall of liquid medium, or a flow of the aerosol may be subjected to a sudden change in direction, with momentum carrying the particles into the wall of liquid medium. The liquid substance containing the particles is then collected.

One advantage of collecting the particles directly into a liquid medium is to simplify the processing of these particles into an ink used for formation of fuel cell electrodes. For example, if the particles are collected directly into a liquid medium of a type to be used for processing, this eliminates the need to collect and then disperse the collected particles in the liquid medium. The dispersion in the liquid medium has been accomplished as part of the collection. After the particles have been collected into the desired liquid medium, then reagents/reactants may be added to the liquid medium for desired processing (e.g., for modification of nanoparticles or substrate). Alternatively, at the time of particle collection, the liquid medium may already have one or more reagents and/or reactants for such processing.

In another variation of collecting particles directly into a liquid medium during the collecting of the particles, the liquid medium as used during the collecting of the particles may be a solvent for one or more materials of the substrate and also contain one or more reactants and/or reagents for performing a modification of the nanoparticles. Such a modification could involve, for example, a surface modification, compositional modification and/or structural modification of the nanoparticles or the substrate, in a manner as previously discussed. For example, the liquid medium may contain a surface-modifying material, such as a dispersing agent, that surface modifies the nanoparticles in the liquid medium of the collection. As another example, liquid medium used for collection may include reactants for use in attaching functional groups to the surface of the nanoparticles, or reactants for use to compositionally modify the nanoparticles.

In one aspect, the process of the invention includes a step of quenching particles prior to the collecting of the particles. The quenching of the particles may be performed to quickly reduce the temperature of the particles after formation of the particles. Preferably, the quenching of the composite particles occurs within about 1 second, e.g., within about 0.1 seconds, within about 0.01 seconds or within about 0.001 seconds, of the step of collecting the composite particles in the liquid medium. This might be necessary, for example, to maintain a crystalline structure of the nanoparticles or substrate and avoid or limit crystal growth. Additionally, if it is undesirable to have the Pt alloy nanocrystallites agglomerate after the forming of the composite particles, the quenching of the composite particles may be performed to quickly reduce the temperature of the particles to prevent the Pt alloy crystallites from or to minimize agglomerating.

In one embodiment, the composite particles are formed in the aerosol, and a quench gas that is at a lower temperature than the aerosol is used during the quenching of the particles to reduce the temperature of the particles. In this embodiment, the quench gas is mixed into the aerosol after the particles have been formed, such as by injecting a stream of the quench gas cocurrent with or counter current to the flow of the aerosol. In most cases, the quench gas will contain non-reactive gases that merely reduce the temperature of the particles and do not react with any materials in the particles. However, in some cases, the quench gas may contain oxidizing agents, reducing agents or precursors that react with materials in the particles to form a new material or modify existing materials in the particles.

In another embodiment of the process the quenching of the particles may be performed using a liquid medium. In this case, the quenching of the particles and the collecting of the particles may be accomplished in a single step using a single liquid medium. The liquid medium used for collection of the particles may also quench the particles as they are collected in the liquid medium. The liquid medium used to collect and quench the particles may contain a variety of materials for modifying the substrate and/or the nanoparticles.

### III. Catalyst Compositions of the Present Invention Overview

The above-described processes for making catalysts is generally applicable to a variety of combinations of metals. It is well known from the literature that the alloying of Pt with base metals leads to enhanced activity in the oxygen reduction reaction (ORR) and/or for methanol oxidation (PtRu catalysts). Various hypotheses exist for the mechanism of this effect. Structural, geometric and electronic factors have been suggested, along with effects of surface composition of the alloys on the preferred reaction pathways. Without limiting the invention to any particular theory, there are several contributing factors thought to have an impact on how catalytically active a composition will be towards oxygen reduction reactions. These factors include Metal-Oxygen (M-O) bond strength, d-band vacancy, geometry (e.g., Pt—Pt bond distance), crystallite size, alloy phase, and, to a lesser extent, conductivity of the alloy phase. For example, in the oxygen reduction reaction at a fuel cell cathode, it is believed that the rate-determining step is the breaking of the O—O bond, which is strongly influenced by the metal-oxygen (M-O) bond at the active phase surface. Too strong of a M-O interaction slows down the reaction, as more energy is required to desorb the products (H₂O), resulting in surface-bonded species. Conversely, too weak of an interaction would result in the oxygen being displaced too easily thereby not reacting, and again resulting in a reduced reaction rate. Alloy geometry, metal crystallite size, and phase are other important factors and are intimately related with the electronic factors to determine the overall electrochemical activity of metal alloy crystallites.

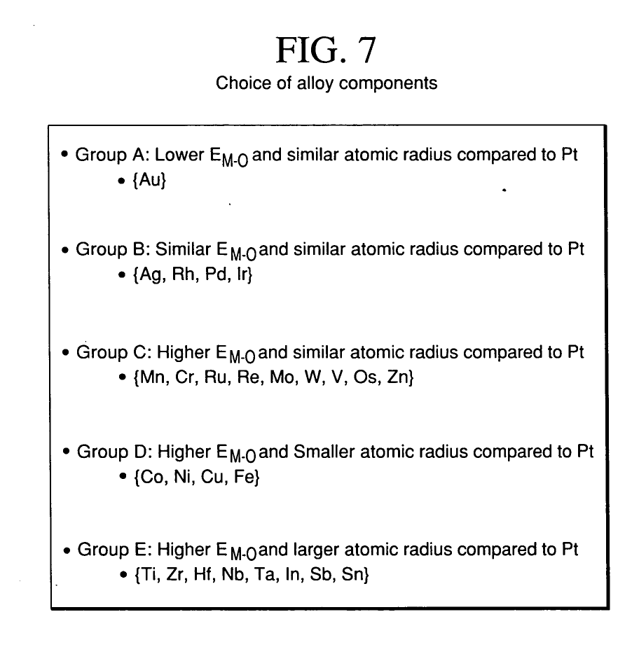

Because of the lack of understanding of the mechanism for the enhancement of the ORR activity as a function of the choice of elements, the combination of electronic and geometrical factors and the limitations of prior preparation methods, the existing examples in the literature have somewhat random and limited scope on disclosing and demonstrating examples of what combination of metals can deliver the best activity in ORR. To establish a more systematic approach for choosing elements and their combinations to be studied for their ORR activity, FIG. 7 shows various metals separated into groups based on a combination of electronic and geometric factors (E_{M-O} bond strength and atomic radius). As shown in FIG. 7, five groups of elements were determined (Groups A, B, C, D, E). Any combination of one or more elements of each group with one or more elements of a second group, and/or any combination of one or more elements of one group with one or more elements of two other groups are within the scope of the current invention. In one preferred embodiment of the current invention, one or more elements of Group D are combined with Pt to form alloy electrocatalysts. In another preferred embodiment of the current invention, one or more elements of Group C are combined with Pt to form alloy electrocatalysts. In yet another preferred embodiment of the current invention, a combination of one or more elements from Group C and Group D are combined with Pt to form an alloy electrocatalyst. In yet another combination of the current invention, one or more elements of Group B, C, D and E can be combined with Pt to form an alloy electrocatalyst.

As indicated above, in one embodiment, the present invention is directed to alloy catalyst compositions, e.g., electrocatalyst compositions. In one aspect, the catalyst composition of the present invention comprises a plurality of alloy nanoparticles disposed on a surface of a substrate particle, wherein the plurality of alloy nanoparticles has a d50 value (by volume) or an average particle size of from about 1 nm to about 10 nm, e.g., from about 1 nm to about 7 nm, from about 1 to about 5 nm, from about 1 nm to about 4 nm, from about 1 nm to about 3 nm, from about 1 nm to about 2.5 nm, or from about 3 nm to about 5 nm.

The invention is also to a plurality of composite particles, e.g., electrocatalyst particles, optionally as a powder, comprising alloy nanoparticles disposed on a plurality of substrate particles. The substrate particles in this aspect preferably comprise porous microparticles, optionally comprising nanosized aggregates. For example, the plurality of substrate particles, each of which optionally comprises an aggregation of smaller substrate nanoparticles (as shown in FIGS. 2D and 2E), has a number average particle diameter of greater than about 0.1 μm and less than about 20 μm, e.g., greater than about 0.5 μm and less than about 10 μm, based on electron microscopy. The plurality of substrate particles optionally has a d50 particle diameter, based on volume, greater than about 0.1 μm and less than 20 μm, e.g., greater than about 0.2 μm and less than 10 μm or greater than about 0.2 μm and less than about 5 μm, as determined by light scattering techniques. These ranges also pertain to the size of the overall composite particle(s) of the present invention since the alloy nanoparticles disposed on the substrate particle(s) contribute insignificantly to the size of the overall composite particle(s).

The composition of the alloy nanoparticles may vary widely according to various alternative embodiments of the present invention. For example, the alloy nanoparticles may comprise platinum and one or more additional metals, which have been formed into an alloy. The invention, in some aspects, is to particular alloy compositions, which provide outstanding catalytic performance.

That is, the present invention, in one embodiment, is directed to one or more composite electrocatalyst particles. Such particles may be formed, for example, by any of the processes of the present invention, discussed below. It is also contemplated, however, that these particles may be formed by other heretofore undiscovered processes.

Composition and Properties of the Substrate Particle(s)

As noted previously, the electrocatalyst particles of the present invention include alloy nanoparticles dispersed on a substrate particle. As used herein, the term “substrate particle” means a particle comprising one or more components capable of supporting the alloy nanoparticles thereon. The substrate particle may include one or more components (e.g., additives), which, standing alone, would be incapable of adequately supporting the alloy nanoparticles, but which in combination with one or more other components may be capable of supporting the nanoparticles. In this aspect, the substrate particle comprises a plurality of components.

The substrate particle may comprise one or more inorganic components, one or more organic components or both inorganic and organic components. Preferably, the substrate particle comprises a conductive composition. For example, in various aspects, the substrate comprises a component selected from the group consisting of: carbon, boron carbide, tantalum boride, titanium carbide, reduced titanium oxides, titanium-ruthenium oxide composites, and combinations thereof.

In some aspects of the current invention, an additional support phase (e.g., supported on or mixed with the support particles) can be utilized to further increase the specific surface area of the substrate particle(s), thereby improving the performance of the alloy nanoparticle-containing active phase. A support phase that increases the surface area of a support particle is referred to herein as an “internal phase.” The internal phase may have predominantly or exclusively one or more components such as metal or metal oxides that are different from the active species (e.g., outmost monolayer(s) of alloy nanoparticles that are catalytically active). This internal phase, in one embodiment of the current invention, can serve as additional support to the active species (e.g., alloy nanoparticles), which could be present as one or a few monolayers deposited on top of the internal phase. The internal phase can be different from of the support phase and/or be dispersed on the support (e.g., carbon) phase. The internal phase can be formed separately prior to the deposition of the active species or be formed simultaneously with the deposition of the active species. For this to occur, in one embodiment of the current invention, the internal phase (e.g., metal oxide) preferably has a lower decomposition temperature and melting point than the metal precursors, and the precursor to the internal phase has properties such that the internal phase is formed in a way that the active species deposits on its outer surface. The composition of the internal phase can be selected so that it is very resistant to corrosion in acidic conditions and under fuel cell operating conditions. Therefore, little or no leaching of internal phase or morphology changes occur during continuous operation of the electrocatalyst in a fuel cell. In some aspects, a Pt alloy phase is deposited on a highly dispersed metal oxide internal phase (e.g., MnOₓ, SnOₓ, ZnO, RuO₂, In₂O₃), metal carbide, or metal nitride, which is supported on and/or mixed with support particle, preferably carbon support particle. The carbon support could be any type of carbon black, graphitized carbon or a carbon doped or mixed with another support constituent such as metal oxide, metal carbide, or metal nitride, or of combinations thereof.

In a preferred embodiment, the substrate particle comprises carbon. In another aspect, the substrate particle consists essentially of carbon. The carbon may be in a variety of forms such as, for example, graphitic carbon, carbon nanotubes, carbon black porous carbon, carbon-60 (bucky ball), or a combination thereof.

In one embodiment, the ultimately formed substrate particle comprises carbon in an amount greater than about 50 weight percent, e.g., greater than about 60 weight percent, greater than about 70 weight percent, greater than about 80 weight percent or greater than about 90 weight percent, based on the total weight of the substrate particle.

Additionally or alternatively, the substrate particle may comprise boron carbide. Optionally, the substrate particle consists essentially of boron carbide. In one embodiment, the substrate particle comprises boron carbide in an amount greater than about 50 weight percent, e.g., greater than about 60 weight percent, greater than about 70 weight percent, greater than about 80 weight percent or greater than about 90 weight percent, based on the total weight of the substrate particle.

Additionally or alternatively, the substrate particle may comprise tantalum boride. Optionally, the substrate particle consists essentially of tantalum boride. In one embodiment, the substrate particle comprises tantalum boride in an amount greater than about 50 weight percent, e.g., greater than about 60 weight percent, greater than about 70 weight percent, greater than about 80 weight percent or greater than about 90 weight percent, based on the total weight of the substrate particle.

Additionally or alternatively, the substrate particle may comprise titanium carbide. Optionally, the substrate particle consists essentially of titanium carbide. In one embodiment, the substrate particle comprises titanium carbide in an amount greater than about 50 weight percent, e.g., greater than about 60 weight percent, greater than about 70 weight percent, greater than about 80 weight percent or greater than about 90 weight percent, based on the total weight of the substrate particle.

Additionally or alternatively, the substrate particle may comprise one or more reduced titanium oxides. Optionally, the substrate particle consists essentially of one or more reduced titanium oxides. The one or more reduced titanium oxides may be in variety of forms such as, for example, Ti₄O₇ or Ti₅O₉, or a combination thereof. In one embodiment, the substrate particle comprises one or more reduced titanium oxides in an amount greater than about 50 weight percent, e.g., greater than about 60 weight percent, greater than about 70 weight percent, greater than about 80 weight percent or greater than about 90 weight percent, based on the total weight of the substrate particle.

In another aspect, the substrate particle comprises two or more compositions, each of the two compositions being selected from the group consisting of: porous carbon, graphitized carbon, a metal carbide, a metal nitride, and a metal oxide. Ideally, the substrate particle has a high surface area, e.g., on the order of at least about 100 m²/g, such as at least about 300 m²/g or at least about 500 m²/g.

As indicated above, it is contemplated that the substrate particle, as a whole, may also include one or more additives. In one non-limiting example, the substrate particles might contains 1-5% Boron, which might change the oxidation potential of a carbon support.

The substrate particle may further include one or more surfactant compounds, such as anionic surfactants, cationic surfactants, or nonionic surfactants. Examples of anionic surfactants include alkyl sulfates, alkyl sulfonates, alkyl benzene sulfates, alkyl benzene sulfonates, fatty acids, sulfosuccinates, and phosphates. Examples of cationic surfactants include quaternary ammonium salts and alkylated pyridinium salts. Examples of nonionic surfactants include alkyl primary, secondary, and tertiary amines, alkanolamides, ethoxylated fatty alcohols, alkyl phenol polyethoxylates, fatty acid esters, glycerol esters, glycol esters, polyethers, alkyl polygycosides, and amineoxides. In addition, Zwitterionic surfactants (surface active additives with a cationic and anionic functional group on the same molecule) may be included within the substrate. Examples include betaines, such as alkyl ammonium carboxylates (e.g., [(CH₃)₃N⁺—CH(R)COO⁻] or sulfonates (sulfo-betaines) such as [R—N⁺(CH₃)₂(CH₂)₃SO₃⁻]). Examples include: n-dodecyl-N-benzyl-N-methylglycine [C₁₂H₂₅N⁺(CH₂—C₆H₅)(CH₃)CH₂COO⁻], N-alkyl N-benzyl N-methyltaurines [CₙH₂ₙ₊₁N⁺(CH₂C₆H₅)(CH₃)CH₂CH₂SO₃⁻], Amido Betaine C (Zohar Dallia)—Coconut amido alkyl beatine, Amphosol CB3 (Stepan Europe) alkyl amido propyl betaine, Amphoteen 24 (Akzo Nobel) C₁₂-C₁₄ alkyldimethylbetaine, Betadet SHR (Kao Corporation, S.A.), Cocoamidopropyl hydroxysultaine, and Dehyton MC (Cogis IB) sodium cocoamplioacetate. A more complete list of surfactants that may be used as part of the substrate particle (including ionic, nonionic polymeric and those with a variety of functional groups) may be found in McCutcheons Emulsifiers and Detergents Vol. I, Int. Ed, 2002, The Manufacturing Confectioner Publishing Co. (ISBN 944254-84-5).

Depending on the desired application the substrate particle(s) may have little or may have significant porosity. The porosity is optionally open and comprises mesoporosity or microporosity. Mesoporosity in the range of 10-100 nm is preferable, and a mesoporosity in the range of 20-60 nm is even more preferable. In various embodiments, the substrate particle has a porosity of from about 25 volume percent, to more preferably 35 volume percent, to even more preferably to 50 volume percent. The porosity can be controlled by use of carbon or other supports with high surface area but preferably without significant degree of microporosity. See, e.g., U.S. Pat. Nos. 6,280,871; 6,881,511, the entireties of which are incorporated herein by reference, and published U.S. Patent Applications Nos. US 2005/0233183 A1 and US 2005/0233203 A1, the entireties of which are incorporated herein by reference. A high ratio of micropores (e.g., pore sizes in the range of 1-3 nm) are generally undesirable.

The substrate particle(s) function to support the alloy nanoparticles on a surface thereof. The substrate particle(s) may simply provide a structure to retain the alloy nanoparticles in a desired dispersed state thereon without interfering with proper functioning of the nanoparticles in the desired application. Alternatively, the substrate particle(s) may also provide some function for the application. The substrate particle(s) may, for example, have a function that is different than that of the alloy nanoparticles, have a function that compliments that of the alloy nanoparticles, or have a function that is the same as that of the alloy nanoparticles.

As shown in FIGS. 2C-2E, the substrate particle optionally comprises an agglomeration of a plurality of smaller substrate nanoparticles. These substrate nanoparticles optionally have a number average particle size, as determined by TEM and/or SEM, of greater than about 5 nm, e.g., greater than about 10 nm, greater than about 20 nm greater than about 30 nm, greater than about 50 nm, or greater than about 100 nm. In terms of upper range limits, the substrate nanoparticles optionally have a number average particle size less than about 500 nm, e.g., less than about 250 nm, less than about 100 nm or less than about 50 nm. In terms of ranges, the substrate nanoparticles optionally have a number average particle size of from about 5 nm to about 200 nm, e.g., from about 5 nm to about 100 nm, from about 10 nm to about 50 nm, or from about 20 nm to about 40 nm.

Composition and Properties of the Alloy Catalysts

As indicated above, the composite particles (e.g., electrocatalyst particles) of the present invention include alloy nanoparticles dispersed on a surface of the substrate particle(s). As used herein, the term “alloy nanoparticle” means a nanoparticle comprising a solid solution of a plurality of metals. The alloy nanoparticles may comprise a substitutional alloy (in which atoms of one metal are substituted for atoms of a second host metal), an interstitial alloy (in which interstices formed by the closest packed metal structure of a host metal are occupied by a second metal), or a combination of the two. The alloy nanoparticles optionally comprise an ordered solid solution alloy or a disordered solid solution alloy. In contrast, an “intermediate particle” is a particle formed from the precursor medium, which particle has not been fully alloyed. An intermediate particle preferably comprises a non-alloyed intimate mixture comprising at least one non-elemental metal-containing compound (e.g., metal oxide) and preferably at least one metal species. In addition, intermediate particles may be amorphous and show no degree of crystallinity.

The number average particle diameter of the alloy nanoparticles may be characterized by electron microscopy. Preferably, the alloy nanoparticles have a number average particle size (e.g., diameter) of from about 1 nm to about 10 nm, e.g., from about 1 nm to about 5 nm, from about 1 nm to about 4 nm, from about 1 nm to about 3 nm, from about 1 nm to about 2.5 nm, or from about 3 nm to about 5 nm.

The distance between adjacent alloy nanoparticles in the composite catalyst particle may vary widely depending on the desired end use for the electrocatalyst particles. In terms of absolute numbers, the average distance between adjacent alloy nanopartricles in the composite particles optionally is less than about 30 nm, e.g., less than about 20 nm, less than about 10 nm, less than about 5 nm, less than about 3 nm or less than about 2 nm. In terms of absolute numbers, the average distance between adjacent nanoparticles in the composite particles optionally is greater than about 1 nm, e.g., greater than about 3 nm, greater than about 5 nm, greater than about 10 nm, greater than about 20 nm.

In one aspect, the alloy nanoparticles of the present invention are spheroidal, meaning that they are generally of spherical shape, even if not perfectly spherical. Optionally, a majority of the nanoparticles have a morphology that is spherical, hollow, rod, flake, platelet, cubed or trigonal.

The optimal weight ratio of alloy nanoparticles to the total weight of the catalyst (nanoparticles and substrate particle) can vary depending mostly on the surface area of the support. In one embodiment, the average weight ratio of the nanoparticles to the entire composite particle, e.g., electrocatalyst composition, ranges from about 5 to about 95, or from about 10 to 90 or from about 20 to about 80. The nanoparticle loading also may be expressed as a “surface concentration,” defined herein as the mass of alloy nanoparticles per unit area of the surface of the substrate particles. In this aspect, surface concentration optionally ranges from about 0.01 g/m² to about 1 g/m², e.g., from about 0.01 g/m² to about 0.1 g/m² or from about 0.05 g/m² to about 0.5 g/m². In another aspect, referred to herein as “normalized active surface area,” the nanoparticle loading may be expressed in terms of active area normalized by the substrate surface area. In this aspect, the normalized active surface area optionally ranges from about 0.01 to about 0.8, e.g., from about 0.05 to about 0.5 or from about 0.1 to about 0.3.

The elemental composition of the nanoparticles may vary widely depending on the desired application and the catalytic activity that is desired. In a preferred embodiment the alloy nanoparticles comprise platinum. Additionally, the alloy nanoparticles comprise a second metal, which optionally is selected from the group consisting of Au, Ag, Rh, Pd, Ir, Mn, Cr, Ru, Re, Mo, W, V, Os, Zn, Co, Ni, Cu, Fe, Ti, Zr, Hf, Nb, Ta, Sn, Sb, and In. In another aspect, the second metal comprises Au. In another aspect, the alloy nanoparticles comprise a second metal selected from the group consisting of Ag, Rh, Pd and Ir. In another aspect, the alloy nanoparticles comprise a second metal selected from the group consisting of Mn, Cr, Ru, Re, Mo, W, V, Os and Zn. In another aspect, the alloy nanoparticles comprise a second metal selected from the group consisting of Co, Ni, Cu, and Fe. In another aspect, the alloy nanoparticles comprise a second metal selected from the group consisting of Ti, Zr, Hf, Nb, Ta, In, Sb and Sn. In another aspect, the alloy nanoparticles comprise a second metal selected from the group consisting of Mn, Cr, Ru, Re, Mo, W, V, Os, Zn, Co, Ni, Cu and Fe. In another aspect, the alloy nanoparticles comprise a second metal selected from the group consisting of nickel, cobalt, iron, copper, manganese, chromium, ruthenium, rhenium, molybdenum, tungsten, vanadium, zinc, titanium, zirconium, tantalum, iridium, palladium and gold.

In a preferred embodiment, the alloy nanoparticles comprise a third metal, which is different from the second metal. In one aspect, for example, the third metal is selected from the group consisting of Au, Ag, Rh, Pd, Ir, Mn, Cr, Ru, Re, Mo, W, V, Os, Zn, Co, Ni, Cu, Fe, Ti, Zr, Hf, Nb, Ta, Sn, Sb, and In. In another aspect, the third metal comprises Au. In another aspect, the alloy nanoparticles comprise a third metal selected from the group consisting of Ag, Rh, Pd and Ir. In another aspect, the alloy nanoparticles comprise a third metal selected from the group consisting of Mn, Cr, Ru, Re, Mo, W, V, Os and Zn. In another aspect, the alloy nanoparticles comprise a third metal selected from the group consisting of Co, Ni, Cu, and Fe. In another aspect, the alloy nanoparticles comprise a third metal selected from the group consisting of Ti, Zr, Hf, Nb, Ta, In, and Sn. In another aspect, the alloy nanoparticles comprise a third metal selected from the group consisting of Mn, Cr, Ru, Re, Mo, W, V, Os, Zn, Co, Ni, Cu and Fe. In another aspect, the alloy nanoparticles comprise a third metal selected from the group consisting of nickel, cobalt, iron, copper, manganese, chromium, ruthenium, rhenium, molybdenum, tungsten, vanadium, zinc, titanium, zirconium, tantalum, iridium, palladium and gold.

In another aspect, the alloy nanoparticles comprise a quaternary alloy. In this aspect, the alloy nanoparticles comprise a fourth metal, which is different from the second and third metals. In one aspect, for example, the fourth metal is selected from the group consisting of Au, Ag, Rh, Pd, Ir, Mn, Cr, Ru, Re, Mo, W, V, Os, Zn, Co, Ni, Cu, Fe, Ti, Zr, Hf, Nb, Ta, Sn, Sb, and In. In another aspect, the fourth metal comprises Au. In another aspect, the alloy nanoparticles comprise a fourth metal selected from the group consisting of Ag, Rh, Pd and Ir. In another aspect, the alloy nanoparticles comprise a fourth metal selected from the group consisting of Mn, Cr, Ru, Re, Mo, W, V, Os and Zn. In another aspect, the alloy nanoparticles comprise a fourth metal selected from the group consisting of Co, Ni, Cu, and Fe. In another aspect, the alloy nanoparticles comprise a fourth metal selected from the group consisting of Ti, Zr, Hf, Nb, Ta, In, and Sn. In another aspect, the alloy nanoparticles comprise a fourth metal selected from the group consisting of Mn, Cr, Ru, Re, Mo, W, V, Os, Zn, Co, Ni, Cu and Fe. In another aspect, the alloy nanoparticles comprise a fourth metal selected from the group consisting of nickel, cobalt, iron, copper, manganese, chromium, ruthenium, rhenium, molybdenum, tungsten, vanadium, zinc, titanium, zirconium, tantalum, iridium, palladium and gold.

Of course, the alloy nanoparticles of the present invention are not limited to alloys of two, three or four metals. In various other embodiments, the alloy nanoparticles may comprise 5, 6, 7 or more metals, optionally selected from the metals listed above.

The relative amounts of the platinum, the second metal the (optional) third metal and optionally additional metals may vary widely depending on the desired application of the catalyst particle(s) of the present invention. It has now been discovered, however, that alloy nanoparticles having certain ratios of various metal combinations result in electrocatalyst particles having surprisingly high activity for catalyzing various chemical processes. These preferred combinations and ratios of metals will now be disclosed in greater detail.

Platinum-Cobalt-Copper Nanoparticles

In one aspect of the invention, the alloy nanoparticles comprise platinum, cobalt and copper. The amounts of these three metals, relative to one another, that are contained in the alloy nanoparticles of the present invention may vary widely, although several ranges of ratios of these elements may be particularly preferred for various catalytic applications, e.g., in oxygen reduction reactions.

The amount of platinum, cobalt and copper that is present in the nanoparticles according to this aspect of the present invention may be expressed by the formula:
PtₓCo_{y}Cu_{z}
wherein “x,” “y” and “z” represent the mole fractions of platinum, cobalt and copper, respectively, present in the alloy nanoparticles.

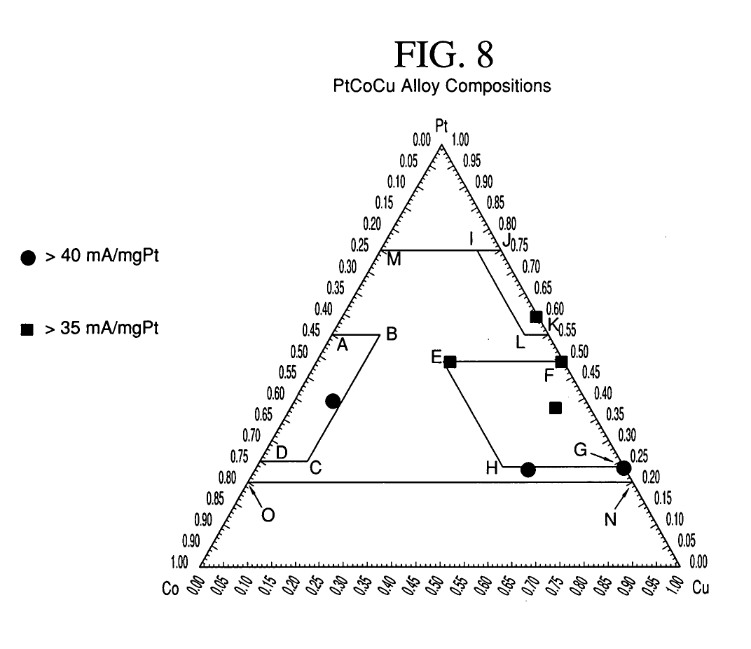

In one aspect, these mole fractions are within the compositional area defined by points A, B, C and D of the ternary compositional diagram depicted in FIG. 8 of the drawings, wherein the points A, B, C, and D are represented by the following values for “x,” “y” and “z.”

TABLE 6
MOLE FRACTIONS REPRESENTED BY POINTS A, B, C AND D

| Point | X | Y | Z |
|---|---|---|---|
| A | 0.55 | 0.45 | 0.00 |
| B | 0.55 | 0.35 | 0.10 |
| C | 0.25 | 0.65 | 0.10 |
| D | 0.25 | 0.75 | 0.00 |

In this aspect, the amount of platinum in the alloy nanoparticles ranges from about 0.25 to about 0.55 mole percent, based on the total moles of all metals in the alloy nanoparticles. The amount of cobalt in the alloy nanoparticles ranges from about 0.35 to about 0.75 mole percent, based on the total moles of all metals in the alloy nanoparticles. The amount of copper in the alloy nanoparticles ranges from about 0.00 to about 0.10 mole percent, based on the total moles of all metals in the alloy nanoparticles.

A non-limiting list of several particularly preferred alloy nanoparticle compositions according to this aspect of the present invention includes Pt_{˜0.50}Cu_{˜0.50}, Pt_{˜0.25}Co_{˜0.75}, and Pt_{˜0.39}Co_{˜0.54}Cu_{˜0.07}. As used herein, the symbol “˜” shall be construed to mean ± about 0.02 mole percent.

In a preferred aspect, electrocatalyst activity of alloy catalysts can be measured by testing the electrocatalyst's oxygen reduction activity in a half cell, 3 electrode configuration with a liquid sulfuric acid electrolyte. In this aspect, the activity is presented in terms of mass activity, defined as mA/mg Pt, where mA is the maximum current generated by the oxygen reduction reaction, the potential being measured at 0.55 V vs. standard calomel electrode, normalized per unit weight of Pt (mg Pt). The mass activity is a measure of the effectiveness of the of the alloy electrocatalysts normalized per unit weight of Pt (mg Pt). Alloy nanoparticles according to this aspect of the present invention may exhibit a mass activity, when measured in a 3-electrode, half-cell configuration, of from about 30 to about 45 mA/mg Pt as presented in Table 26, below. For comparison a mass activity of 26 mA/mg Pt is exhibited for non-alloyed Pt.

In another aspect, these mole fractions are within the compositional area defined by points E, F, G and H of the ternary compositional diagram depicted in FIG. 8 of the drawings, wherein the points E, F, G and H are represented by the following values for “x,” “y” and “z.”

TABLE 7
MOLE FRACTIONS REPRESENTED BY POINTS E, F, G AND H

| Point | X | Y | Z |
|---|---|---|---|
| E | 0.50 | 0.25 | 0.25 |
| F | 0.50 | 0.00 | 0.50 |
| G | 0.25 | 0.00 | 0.75 |
| H | 0.25 | 0.25 | 0.50 |

In this aspect, the amount of platinum in the alloy nanoparticles ranges from about 0.25 to about 0.50 mole percent, based on the total moles of all metals in the alloy nanoparticles. The amount of cobalt in the alloy nanoparticles ranges from about 0.00 to about 0.25 mole percent, based on the total moles of all metals in the alloy nanoparticles. The amount of copper in the alloy nanoparticles ranges from about 0.25 to about 0.75 mole percent, based on the total moles of all metals in the alloy nanoparticles.

A non-limiting list of several particularly preferred alloy nanoparticle compositions according to this aspect of the present invention includes Pt_{˜0.50}Co_{˜0.25}Cu_{˜0.25}, Pt_{˜0.50}Cu_{˜0.50}, Pt_{˜0.25}, C_{˜0.10}Cu_{˜0.65}, Pt_{˜0.25}CO_{˜0.21}Cu_{˜0.54} and Pt_{˜0.39}Co_{˜0.07}Cu_{˜0.54}.

Alloy nanoparticles according to this aspect of the present invention may exhibit a mass activity, when measured in a 3-electrode, half-cell configuration, of from about 35 to about 45 mA/mg Pt as presented in Table 26.

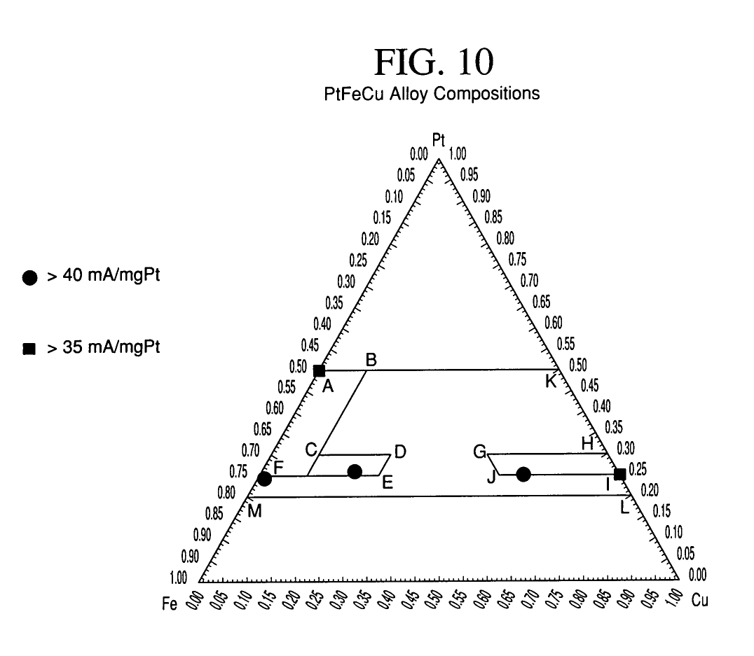

In another aspect, these mole fractions are within the compositional area defined by points I, J, K and L of the ternary compositional diagram depicted in FIG. 10 of the drawings, wherein the points I, J, K and L are represented by the following values for “x,” “y” and “z.”

TABLE 8
MOLE FRACTIONS REPRESENTED BY POINTS I, J, K AND L

| Point | x | y | z |
|---|---|---|---|
| I | 0.75 | 0.05 | 0.20 |
| J | 0.75 | 0.00 | 0.25 |
| K | 0.55 | 0.00 | 0.45 |
| L | 0.55 | 0.05 | 0.40 |

In this aspect, the amount of platinum in the alloy nanoparticles ranges from about 0.55 to about 0.75 mole percent, based on the total moles of all metals in the alloy nanoparticles. The amount of cobalt in the alloy nanoparticles ranges from about 0.00 to about 0.05 mole percent, based on the total moles of all metals in the alloy nanoparticles. The amount of copper in the alloy nanoparticles ranges from about 0.20 to about 0.45 mole percent, based on the total moles of all metals in the alloy nanoparticles.

A non-limiting list of two particularly preferred alloy nanoparticle compositions according to this aspect of the present invention includes Pt_{˜0.75}Cu_{˜0.25} and Pt_{˜0.61}Cu_{˜0.39}.

Alloy nanoparticles according to this aspect of the present invention may exhibit a current density, when measured by a 3-electrode, half-cell configuration, of from about 30 to about 40 mA/mg Pt as presented in Table 26.

In another aspect, these mole fractions are within the compositional area defined by points M, J, N and O of the ternary compositional diagram depicted in FIG. 8 of the drawings, wherein the points M, J, N and O are represented by the following values for “x,”“y” and “z.”

TABLE 9
MOLE FRACTIONS REPRESENTED BY POINTS M, J, N AND O

| Point | x | y | z |
|---|---|---|---|
| M | 0.75 | 0.25 | 0.00 |
| J | 0.75 | 0.00 | 0.25 |
| N | 0.20 | 0.00 | 0.80 |
| O | 0.20 | 0.80 | 0.00 |

In this aspect, the amount of platinum in the alloy nanoparticles ranges from about 0.20 to about 0.75 mole percent, based on the total moles of all metals in the alloy nanoparticles. The amount of cobalt in the alloy nanoparticles ranges from about 0.00 to about 0.80 mole percent, based on the total moles of all metals in the alloy nanoparticles. The amount of copper in the alloy nanoparticles ranges from about 0.00 to about 0.80 mole percent, based on the total moles of all metals in the alloy nanoparticles.

Platinum-Cobalt-Iron Nanoparticles

In one aspect of the invention, the alloy nanoparticles comprise platinum, cobalt and iron. The amounts of these three metals, relative to one another, that are contained in the alloy nanoparticles of the present invention may vary widely, although several ranges of ratios of these elements may be particularly preferred for various catalytic applications.

The amount of platinum, cobalt and iron that is present in the nanoparticles according to this aspect of the present invention may be expressed by the formula:
PtₓCo_{y}Fe_{z}
wherein “x,” “y” and “z” represent the mole fractions of platinum, cobalt and iron, respectively, present in the alloy nanoparticles.

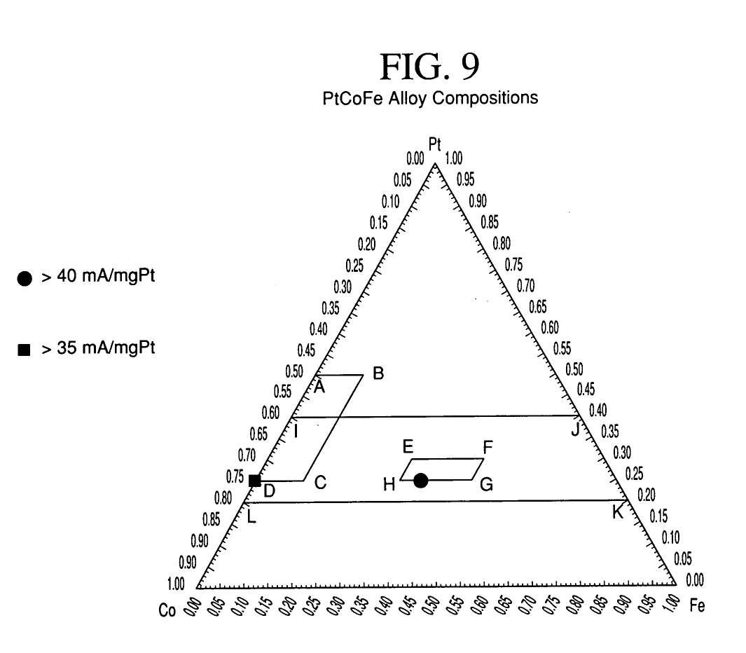

In one aspect, these mole fractions are within the compositional area defined by points A, B, C and D of the ternary compositional diagram depicted in FIG. 9 of the drawings, wherein the points A, B, C, and D are represented by the following values for “x,” “y” and “z.”

TABLE 10
MOLE FRACTIONS REPRESENTED BY POINTS A, B, C AND D

| Point | X | Y | Z |
|---|---|---|---|
| A | 0.50 | 0.50 | 0.00 |
| B | 0.50 | 0.40 | 0.10 |
| C | 0.25 | 0.65 | 0.10 |
| D | 0.25 | 0.75 | 0.00 |

In this aspect, the amount of platinum in the alloy nanoparticles ranges from about 0.25 to about 0.50 mole percent, based on the total moles of all metals in the alloy nanoparticles. The amount of cobalt in the alloy nanoparticles ranges from about 0.40 to about 0.75 mole percent, based on the total moles of all metals in the alloy nanoparticles. The amount of iron in the alloy nanoparticles ranges from about 0.00 to about 0.10 mole percent, based on the total moles of all metals in the alloy nanoparticles.

A non-limiting list of two particularly preferred alloy nanoparticle compositions according to this aspect of the present invention includes Pt_{˜0.50}Co_{˜0.50} and Pt_{˜0.25}Co_{˜0.75}.

Alloy nanoparticles according to this aspect of the present invention may exhibit a mass activity, when measured in a 3-electrode, half-cell configuration, of from about 25 to about 40 mA/mg Pt as presented in Table 27.

In another aspect, these mole fractions are within the compositional area defined by points E, F, G and H of the ternary compositional diagram depicted in FIG. 9 of the drawings, wherein the points E, F, G and H are represented by the following values for “x,” “y” and “z.”

TABLE 11
MOLE FRACTIONS REPRESENTED BY POINTS E, F, G AND H

| Point | X | Y | Z |
|---|---|---|---|
| E | 0.30 | 0.40 | 0.30 |
| F | 0.30 | 0.25 | 0.45 |
| G | 0.25 | 0.30 | 0.45 |
| H | 0.25 | 0.45 | 0.30 |

In this aspect, the amount of platinum in the alloy nanoparticles ranges from about 0.25 to about 0.30 mole percent, based on the total moles of all metals in the alloy nanoparticles. The amount of cobalt in the alloy nanoparticles ranges from about 0.25 to about 0.45 mole percent, based on the total moles of all metals in the alloy nanoparticles. The amount of iron in the alloy nanoparticles ranges from about 0.30 to about 0.45 mole percent, based on the total moles of all metals in the alloy nanoparticles.

A non-limiting example of a particularly preferred alloy nanoparticle composition according to this aspect of the present invention is Pt_{˜0.25}Co_{˜0.37}Fe_{˜0.38}.

Alloy nanoparticles according to this aspect of the present invention may exhibit a mass activity, when measured in a 3-electrode, half-cell configuration, of from about 40 to about 50 mA/mg Pt as presented in Table 27.

In another aspect, these mole fractions are within the compositional area defined by points I, J, K and L of the ternary compositional diagram depicted in FIG. 9 of the drawings, wherein the points I, J, K and L are represented by the following values for “x,” “y” and “z.”

TABLE 12
MOLE FRACTIONS REPRESENTED BY POINTS I, J, K AND L

| Point | X | Y | Z |
|---|---|---|---|
| I | 0.40 | 0.60 | 0.00 |
| J | 0.40 | 0.00 | 0.60 |
| K | 0.20 | 0.00 | 0.80 |
| L | 0.20 | 0.80 | 0.00 |

In this aspect, the amount of platinum in the alloy nanoparticles ranges from about 0.20 to about 0.40 mole percent, based on the total moles of all metals in the alloy nanoparticles. The amount of cobalt in the alloy nanoparticles ranges from about 0.00 to about 0.60 mole percent, based on the total moles of all metals in the alloy nanoparticles. The amount of iron in the alloy nanoparticles ranges from about 0.00 to about 0.60 mole percent, based on the total moles of all metals in the alloy nanoparticles.

Platinum-Iron-Copper Nanoparticles

In one aspect of the invention, the alloy nanoparticles comprise platinum, iron and copper. The amounts of these three metals, relative to one another, that are contained in the alloy nanoparticles of the present invention may vary widely, although several ranges of ratios of these elements may be particularly preferred for various catalytic applications.

The amount of platinum, iron and copper that is present in the nanoparticles according to this aspect of the present invention may be expressed by the formula:
PtₓFe_{y}Cu_{z}
wherein “x,” “y” and “z” represent the mole fractions of platinum, iron and copper, respectively, present in the alloy nanoparticles.

In one aspect, these mole fractions are within the compositional area defined by points A, B, C, D, E and F of the ternary compositional diagram depicted in FIG. 10 of the drawings, wherein the points A, B, C, D, E and F are represented by the following values for “x,” “y” and “z.”

TABLE 13
MOLE FRACTIONS REPRESENTED BY
POINTS A, B, C, D, E AND F

| Point | X | y | z |
|---|---|---|---|
| A | 0.50 | 0.50 | 0.00 |
| B | 0.50 | 0.40 | 0.10 |
| C | 0.30 | 0.60 | 0.10 |
| D | 0.30 | 0.45 | 0.25 |
| E | 0.25 | 0.50 | 0.25 |
| F | 0.25 | 0.75 | 0.00 |

In this aspect, the amount of platinum in the alloy nanoparticles ranges from about 0.25 to about 0.50 mole percent, as the amount of iron in the alloy nanoparticles ranges from about 0.40 to about 0.75 mole percent, and as the amount of copper in the alloy nanoparticles ranges from about 0.00 to about 0.10 mole percent, based on the total moles of all metals in the alloy nanoparticles. Additionally, in this aspect, the amount of platinum in the alloy nanoparticles ranges from about 0.25 to about 0.30 mole percent, as the amount of iron in the alloy nanoparticles ranges from about 0.45 to about 0.65 mole percent, and as the amount of copper in the alloy nanoparticles ranges from about 0.10 to about 0.25 mole percent, based on the total moles of all metals in the alloy nanoparticles.

A non-limiting list of several particularly preferred alloy nanoparticle compositions according to this aspect of the present invention includes Pt_{˜0.50}Fe_{˜0.50}, Pt_{˜0.39}Fe_{˜0.54}Cu_{˜0.07}, Pt_{˜0.35}Fe_{˜0.60}Cu_{˜0.05}, Pt_{˜0.25}Fe_{˜0.75}, and Pt_{˜0.25} Fe_{˜0.54}Cu_{˜0.21}.

Alloy nanoparticles according to this aspect of the present invention may exhibit a mass activity, when measured in a 3-electrode, half-cell configuration, of from about 30 to about 55 mA/mg Pt as presented in Table 28.

In another aspect, these mole fractions are within the compositional area defined by points G, H, I and J of the ternary compositional diagram depicted in FIG. 10 of the drawings, wherein the points G, H, I and J are represented by the following values for “x,” “y” and “z.”

TABLE 14
MOLE FRACTIONS REPRESENTED BY POINTS G, H, I AND J

| Point | x | y | z |
|---|---|---|---|
| G | 0.30 | 0.25 | 0.45 |
| H | 0.30 | 0.00 | 0.70 |
| I | 0.25 | 0.00 | 0.75 |
| J | 0.25 | 0.25 | 0.50 |

In this aspect, the amount of platinum in the alloy nanoparticles ranges from about 0.25 to about 0.30 mole percent, based on the total moles of all metals in the alloy nanoparticles. The amount of iron in the alloy nanoparticles ranges from about 0.00 to about 0.25 mole percent, based on the total moles of all metals in the alloy nanoparticles. The amount of copper in the alloy nanoparticles ranges from about 0.45 to about 0.75 mole percent, based on the total moles of all metals in the alloy nanoparticles.

A non-limiting list of two particularly preferred alloy nanoparticle compositions according to this aspect of the present invention includes Pt_{˜0.25}Cu_{˜0.75} and Pt_{˜0.25}Fe_{˜0.21}Cu_{˜0.54}.

Alloy nanoparticles according to this aspect of the present invention may exhibit a mass activity, when measured in a 3-electrode, half-cell configuration, of from about 35 to about 45 mA/mg Pt as presented in Table 28.

In another aspect, these mole fractions are within the compositional area defined by points A, K, L and M of the ternary compositional diagram depicted in FIG. 10 of the drawings, wherein the points A, K, L and M are represented by the following values for “x,” “y,” and “z.”

TABLE 15
MOLE FRACTIONS REPRESENTED BY POINTS A, K, L AND M

| Point | x | y | z |
|---|---|---|---|
| A | 0.50 | 0.50 | 0.00 |
| K | 0.50 | 0.00 | 0.50 |
| L | 0.20 | 0.00 | 0.80 |
| M | 0.20 | 0.80 | 0.00 |

In this aspect, the amount of platinum in the alloy nanoparticles ranges from about 0.20 to about 0.50 mole percent, based on the total moles of all metals in the alloy nanoparticles. The amount of iron in the alloy nanoparticles ranges from about 0.00 to about 0.80 mole percent, based on the total moles of all metals in the alloy nanoparticles. The amount of copper in the alloy nanoparticles ranges from about 0.00 to about 0.80 mole percent, based on the total moles of all metals in the alloy nanoparticles.

Platinum-Nickel-Copper Nanoparticles

In one aspect of the invention, the alloy nanoparticles comprise platinum, nickel and copper. The amounts of these three metals, relative to one another, that are contained in the alloy nanoparticles of the present invention may vary widely, although several ranges of ratios of these elements may be particularly preferred for various catalytic applications.

The amount of platinum, nickel and copper that is present in the nanoparticles according to this aspect of the present invention may be expressed by the formula:
PtₓNi_{y}Cu_{z}
wherein “x,” “y” and “z” represent the mole fractions of platinum, nickel and copper, respectively, present in the alloy nanoparticles.

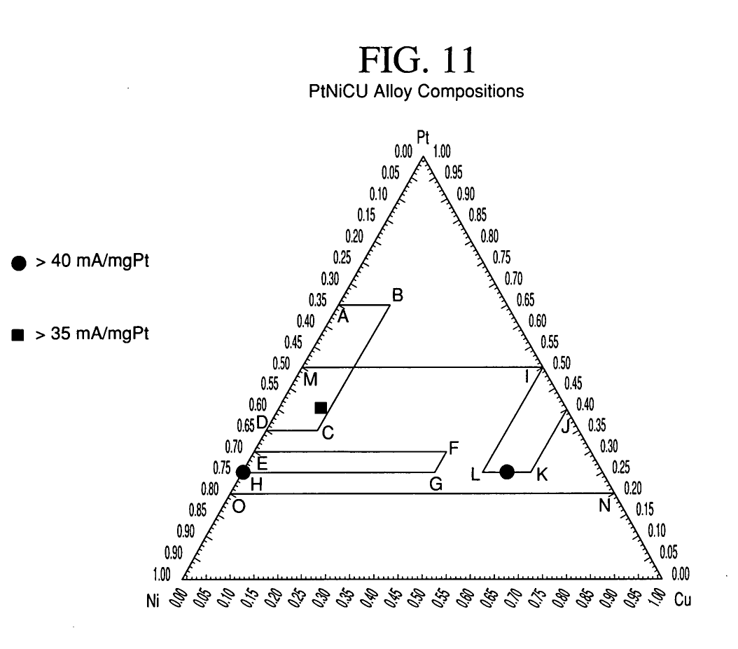

In one aspect, these mole fractions are within the compositional area defined by points A, B, C and D of the ternary compositional diagram depicted in FIG. 11 of the drawings, wherein the points A, B, C, and D are represented by the following values for “x,” “y” and “z.”

TABLE 16
MOLE FRACTIONS REPRESENTED BY POINTS A, B, C AND D

| Point | x | y | z |
|---|---|---|---|
| A | 0.65 | 0.35 | 0.00 |
| B | 0.65 | 0.25 | 0.10 |
| C | 0.35 | 0.55 | 0.10 |
| D | 0.35 | 0.65 | 0.00 |

In this aspect, the amount of platinum in the alloy nanoparticles ranges from about 0.35 to about 0.65 mole percent, based on the total moles of all metals in the alloy nanoparticles. The amount of nickel in the alloy nanoparticles ranges from about 0.25 to about 0.65 mole percent, based on the total moles of all metals in the alloy nanoparticles. The amount of copper in the alloy nanoparticles ranges from about 0.00 to about 0.10 mole percent, based on the total moles of all metals in the alloy nanoparticles.

A non-limiting list of several particularly preferred alloy nanoparticle compositions according to this aspect of the present invention includes Pt_{˜0.39}Ni_{˜0.54}Cu_{˜0.07}, Pt_{˜0.61}Ni_{˜0.39}, Pt_{˜0.45}Ni_{˜0.55}, and Pt_{˜0.50}Ni_{˜0.50}.

Alloy nanoparticles according to this aspect of the present invention may exhibit a mass activity, when measured by a 3-electrode, half-cell configuration, of from about 30 to about 40 mA/mg Pt as presented in Table 29.

In another aspect, these mole fractions are within the compositional area defined by points E, F, G and H of the ternary compositional diagram depicted in FIG. 11 of the drawings, wherein the points E, F, G and H are represented by the following values for “x,” “y” and “z.”

TABLE 17
MOLE FRACTIONS REPRESENTED BY POINTS E, F, G AND H

| Point | x | y | z |
|---|---|---|---|
| E | 0.30 | 0.70 | 0.00 |
| F | 0.30 | 0.30 | 0.40 |
| G | 0.25 | 0.35 | 0.40 |
| H | 0.25 | 0.75 | 0.00 |

In this aspect, the amount of platinum in the alloy nanoparticles ranges from about 0.25 to about 0.30 mole percent, based on the total moles of all metals in the alloy nanoparticles. The amount of nickel in the alloy nanoparticles ranges from about 0.30 to about 0.75 mole percent, based on the total moles of all metals in the alloy nanoparticles. The amount of copper in the alloy nanoparticles ranges from about 0.00 to about 0.40 mole percent, based on the total moles of all metals in the alloy nanoparticles.

A non-limiting example of a particularly preferred alloy nanoparticle compositions according to this aspect of the present invention includes Pt_{˜0.25}Ni_{˜0.75}, Pt_{˜0.25}Ni_{˜0.54}Cu_{˜0.21}, and Pt_{˜0.25}Ni_{˜0.38}Cu_{˜0.37}.

Alloy nanoparticles according to this aspect of the present invention may exhibit a mass activity, when measured by a 3-electrode, half-cell configuration, of from about 30 to about 45 mA/mg Pt as presented in Table 29.

In another aspect, these mole fractions are within the compositional area defined by points I, J, K and L of the ternary compositional diagram depicted in FIG. 11 of the drawings, wherein the points I, J, K and L are represented by the following values for “x,” “y” and “z.”

TABLE 18
MOLE FRACTIONS REPRESENTED BY POINTS I, J, K AND L

| Point | x | y | z |
|---|---|---|---|
| I | 0.50 | 0.00 | 0.50 |
| J | 0.40 | 0.00 | 0.60 |
| K | 0.25 | 0.15 | 0.60 |
| L | 0.25 | 0.25 | 0.50 |

In this aspect, the amount of platinum in the alloy nanoparticles ranges from about 0.25 to about 0.50 mole percent, based on the total moles of all metals in the alloy nanoparticles. The amount of nickel in the alloy nanoparticles ranges from about 0.00 to about 0.25 mole percent, based on the total moles of all metals in the alloy nanoparticles. The amount of copper in the alloy nanoparticles ranges from about 0.50 to about 0.60 mole percent, based on the total moles of all metals in the alloy nanoparticles.

A non-limiting list of two particularly preferred alloy nanoparticle compositions according to this aspect of the present invention includes Pt_{˜0.39}Ni_{˜0.07}Cu_{˜54} and Pt_{˜0.25}Ni_{˜0.21}Cu_{˜0.54}.

Alloy nanoparticles according to this aspect of the present invention may exhibit a current mass activity, when measured by a 3-electrode, half-cell configuration, of from about 30 to about 45 mA/mg Pt as presented in Table 29.

In another aspect, these mole fractions are within the compositional area defined by points M, I, N and O of the ternary compositional diagram depicted in FIG. 11 of the drawings, wherein the points M, I, N and O are represented by the following values for “x,” “y” and “z.”

TABLE 19
MOLE FRACTIONS REPRESENTED BY POINTS M, I, N AND O

| Point | x | y | z |
|---|---|---|---|
| M | 0.50 | 0.50 | 0.00 |
| I | 0.50 | 0.00 | 0.50 |
| N | 0.20 | 0.00 | 0.80 |
| O | 0.20 | 0.80 | 0.00 |

In this aspect, the amount of platinum in the alloy nanoparticles ranges from about 0.20 to about 0.50 mole percent, based on the total moles of all metals in the alloy nanoparticles. The amount of nickel in the alloy nanoparticles ranges from about 0.00 to about 0.80 mole percent, based on the total moles of all metals in the alloy nanoparticles. The amount of copper in the alloy nanoparticles ranges from about 0.00 to about 0.80 mole percent, based on the total moles of all metals in the alloy nanoparticles.

Platinum-Nickel-Iron Nanoparticles

In one aspect of the invention, the alloy nanoparticles comprise platinum, nickel and iron. The amounts of these three metals, relative to one another, that are contained in the alloy nanoparticles of the present invention may vary widely, although several ranges of ratios of these elements may be particularly preferred for various catalytic applications.

The amount of platinum, nickel and iron that is present in the nanoparticles according to this aspect of the present invention may be expressed by the formula:
PtₓNi_{y}Fe_{z}
wherein “x,” “y” and “z” represent the mole fractions of platinum, nickel and iron, respectively, present in the alloy nanoparticles.

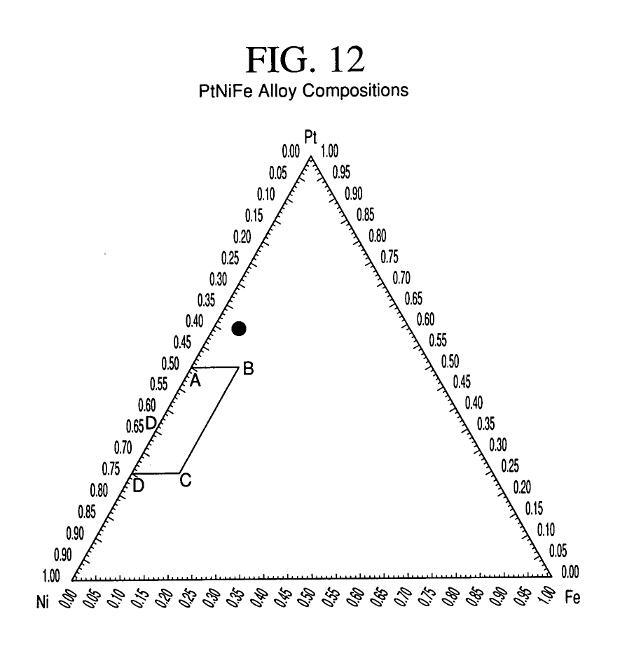

In one aspect, these mole fractions are within the compositional area defined by points A, B, C and D of the ternary compositional diagram depicted in FIG. 12 of the drawings, wherein the points A, B, C, and D are represented by the following values for “x,” “y” and “z.”

TABLE 20
MOLE FRACTIONS REPRESENTED BY POINTS A, B, C AND D

| Point | x | y | z |
|---|---|---|---|
| A | 0.50 | 0.50 | 0.00 |
| B | 0.50 | 0.40 | 0.10 |
| C | 0.25 | 0.65 | 0.10 |
| D | 0.25 | 0.75 | 0.00 |

In this aspect, the amount of platinum in the alloy nanoparticles ranges from about 0.25 to about 0.50 mole percent, based on the total moles of all metals in the alloy nanoparticles. The amount of nickel in the alloy nanoparticles ranges from about 0.40 to about 0.75 mole percent, based on the total moles of all metals in the alloy nanoparticles. The amount of iron in the alloy nanoparticles ranges from about 0.00 to about 0.10 mole percent, based on the total moles of all metals in the alloy nanoparticles.

A non-limiting list of several particularly preferred alloy nanoparticle compositions according to this aspect of the present invention includes Pt_{˜0.25}Ni_{˜0.75}, Pt_{˜0.50}Ni_{˜0.50}, and Pt_{˜0.39}Ni_{˜0.54}Fe_{˜0.07}.

Alloy nanoparticles according to this aspect of the present invention may exhibit a mass activity, when measured a 3-electrode, half-cell configuration, of from about 30 to about 50 mA/mg Pt as presented in Table 30.

Platinum-Palladium-Copper Nanoparticles

In one aspect of the invention, the alloy nanoparticles comprise platinum, palladium and copper. The amounts of these three metals, relative to one another, that are contained in the alloy nanoparticles of the present invention may vary widely, although several ranges of ratios of these elements may be particularly preferred for various catalytic applications.

The amount of platinum, palladium and copper that is present in the nanoparticles according to this aspect of the present invention may be expressed by the formula:
PtₓPd_{y}Cu_{z}
wherein “x,” “y” and “z” represent the mole fractions of platinum, palladium and copper, respectively, present in the alloy nanoparticles.

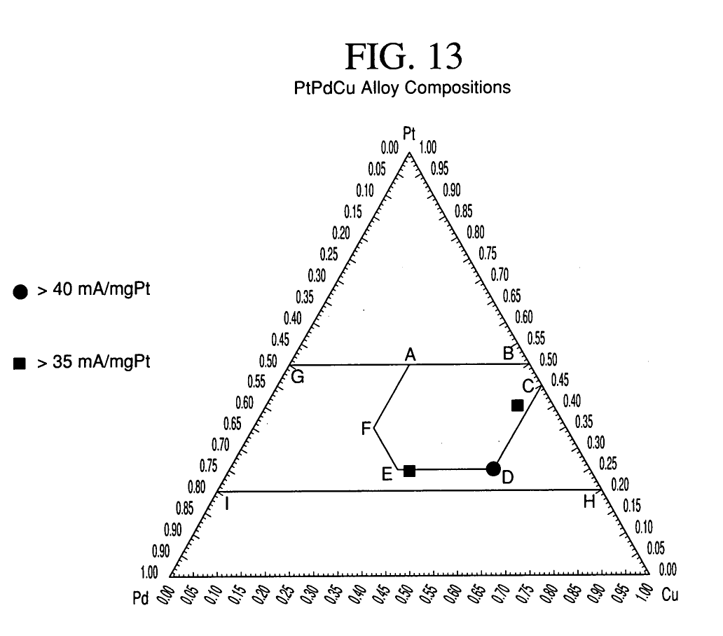

In one aspect, these mole fractions are within the compositional area defined by points A, B, C, D, E and F of the ternary compositional diagram depicted in FIG. 13 of the drawings, wherein the points A, B, C, D, E and F are represented by the following values for “x,” “y” and “z.”

TABLE 21
MOLE FRACTIONS REPRESENTED BY POINTS A, B, C, D, E
AND F

| Point | x | y | z |
|---|---|---|---|
| A | 0.50 | 0.25 | 0.25 |
| B | 0.50 | 0.00 | 0.50 |
| C | 0.45 | 0.00 | 0.55 |
| D | 0.25 | 0.20 | 0.55 |
| E | 0.25 | 0.40 | 0.35 |
| F | 0.35 | 0.40 | 0.25 |

In this aspect, the amount of platinum in the alloy nanoparticles ranges from about 0.25 to about 0.50 mole percent, based on the total moles of all metals in the alloy nanoparticles. The amount of palladium in the alloy nanoparticles ranges from about 0.00 to about 0.40 mole percent, based on the total moles of all metals in the alloy nanoparticles. The amount of copper in the alloy nanoparticles ranges from about 0.25 to about 0.55 mole percent, based on the total moles of all metals in the alloy nanoparticles.

A non-limiting list of several particularly preferred alloy nanoparticle compositions according to this aspect of the present invention includes Pt_{˜0.39}Pd_{˜0.07}Cu_{˜0.54}, Pt_{˜0.50}Pd_{˜0.25}Cu_{˜0.25}, Pt_{˜0.25}Pd_{˜0.37}Cu_{˜0.38}, and Pt_{˜0.25}Pd_{˜0.21}Cu_{˜0.54}.

Alloy nanoparticles according to this aspect of the present invention may exhibit a mass activity, when measured by a 3-electrode, half-cell configuration, of from about 30 to about 45 mA/mg Pt as presented in Table 31.

In another aspect, these mole fractions are within the compositional area defined by points G, B, H and I of the ternary compositional diagram depicted in FIG. 13 of the drawings, wherein the points G, B, H and I are represented by the following values for “x,” “y” and “z.”

TABLE 22
MOLE FRACTIONS REPRESENTED BY POINTS F, B, G AND H

| Point | x | y | z |
|---|---|---|---|
| G | 0.50 | 0.50 | 0.00 |
| B | 0.50 | 0.00 | 0.50 |
| H | 0.20 | 0.00 | 0.80 |
| I | 0.20 | 0.80 | 0.00 |

In this aspect, the amount of platinum in the alloy nanoparticles ranges from about 0.20 to about 0.50 mole percent, based on the total moles of all metals in the alloy nanoparticles. The amount of palladium in the alloy nanoparticles ranges from about 0.00 to about 0.80 mole percent, based on the total moles of all metals in the alloy nanoparticles. The amount of copper in the alloy nanoparticles ranges from about 0.00 to about 0.80 mole percent, based on the total moles of all metals in the alloy nanoparticles.

Platinum-Palladium-Cobalt Nanoparticles

In one aspect of the invention, the alloy nanoparticles comprise platinum, palladium and cobalt. The amounts of these three metals, relative to one another, that are contained in the alloy nanoparticles of the present invention may vary widely, although several ranges of ratios of these elements may be particularly preferred for various catalytic applications.

The amount of platinum, palladium and cobalt that is present in the nanoparticles according to this aspect of the present invention may be expressed by the formula:
PtₓPd_{y}Co_{z}
wherein “x,” “y” and “z” represent the mole fractions of platinum, palladium and cobalt, respectively, present in the alloy nanoparticles.

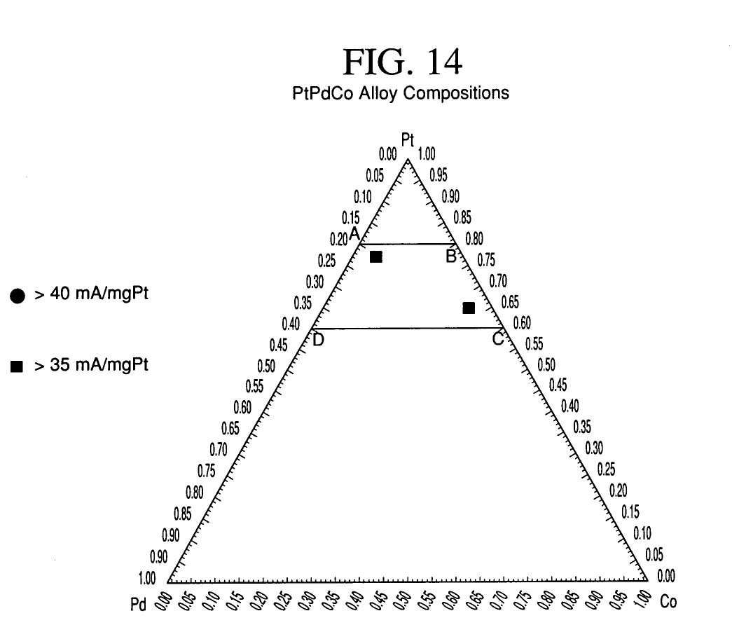

In one aspect, these mole fractions are within the compositional area defined by points A, B, C and D of the ternary compositional diagram depicted in FIG. 14 of the drawings, wherein the points A, B, C, and D are represented by the following values for “x,” “y” and “z.”

TABLE 23
MOLE FRACTIONS REPRESENTED BY POINTS A, B, C AND D

| Point | x | y | z |
|---|---|---|---|
| A | 0.80 | 0.20 | 0.00 |
| B | 0.80 | 0.00 | 0.20 |
| C | 0.60 | 0.00 | 0.40 |
| D | 0.60 | 0.40 | 0.00 |

In this aspect, the amount of platinum in the alloy nanoparticles ranges from about 0.60 to about 0.80 mole percent, based on the total moles of all metals in the alloy nanoparticles. The amount of palladium in the alloy nanoparticles ranges from about 0.00 to about 0.40 mole percent, based on the total moles of all metals in the alloy nanoparticles. The amount of cobalt in the alloy nanoparticles ranges from about 0.00 to about 0.40 mole percent, based on the total moles of all metals in the alloy nanoparticles.

A non-limiting list of several particularly preferred alloy nanoparticle compositions according to this aspect of the present invention includes Pt_{˜0.65}Pd_{˜0.05}Co_{˜0.30}, Pt_{˜0.70}Pd_{˜0.20}Co_{˜0.10}, Pt_{˜0.60}Pd_{˜0.20}Co_{˜0.20}, and Pt_{˜0.70}Pd_{˜0.10}Co_{˜0.20}.

Alloy nanoparticles according to this aspect of the present invention may exhibit a mass activity, when measured by a 3-electrode, half-cell configuration, of from about 30 to about 40 mA/mg Pt as presented in Table 32.

Platinum-Nickel-Cobalt Nanoparticles

In another aspect of the invention, the alloy nanoparticles comprise platinum, nickel and cobalt. The amounts of these three metals, relative to one another, that are contained in the alloy nanoparticles of the present invention may vary widely, although several ranges of ratios of these elements may be particularly preferred for various catalytic applications.

The amount of platinum, nickel and cobalt that is present in the nanoparticles according to this aspect of the present invention may be expressed by the formula:
PtₓNi_{y}Co_{z}
wherein “x,” “y” and “z” represent the mole fractions of platinum, nickel and cobalt, respectively, present in the alloy nanoparticles.

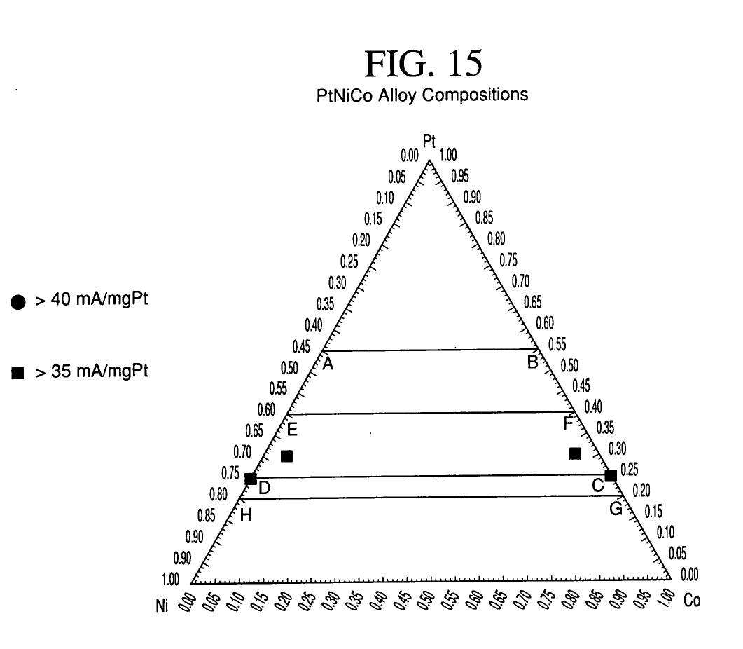

In one aspect, these mole fractions are within the compositional area defined by points A, B, C and D of the ternary compositional diagram depicted in FIG. 15 of the drawings, wherein the points A, B, C, and D are represented by the following values for “x,” “y” and “z.”

TABLE 24
MOLE FRACTIONS REPRESENTED BY POINTS A, B, C AND D

| Point | x | y | z |
|---|---|---|---|
| A | 0.55 | 0.45 | 0.00 |
| B | 0.55 | 0.00 | 0.45 |
| C | 0.25 | 0.00 | 0.75 |
| D | 0.25 | 0.75 | 0.00 |

In this aspect, the amount of platinum in the alloy nanoparticles ranges from about 0.25 to about 0.55 mole percent, based on the total moles of all metals in the alloy nanoparticles. The amount of nickel in the alloy nanoparticles ranges from about 0.00 to about 0.75 mole percent, based on the total moles of all metals in the alloy nanoparticles. The amount of cobalt in the alloy nanoparticles ranges from about 0.00 to about 0.75 mole percent, based on the total moles of all metals in the alloy nanoparticles.

A non-limiting list of several particularly preferred alloy nanoparticle compositions according to this aspect of the present invention includes Pt_{˜0.50}Ni_{˜0.25}Co_{˜0.25}, Pt_{˜0.30}Ni_{˜0.65}Co_{˜0.5}, Pt_{˜0.30}Ni_{˜0.5}Cu_{˜0.65}, and Pt_{˜0.30}Ni_{˜0.35}Co_{˜0.35}.

Alloy nanoparticles according to this aspect of the present invention may exhibit a mass activity, when measured in a 3-electrode, half-cell configuration, of from about 30 to about 40 mA/mg Pt as presented in Table 36.

In another aspect, these mole fractions are within the compositional area defined by points E, F, G and H of the ternary compositional diagram depicted in FIG. 15 of the drawings, wherein the points E, F, G and H are represented by the following values for “x,” “y” and “z.”

TABLE 25
MOLE FRACTIONS REPRESENTED BY POINTS A, B, C AND D

| Point | x | y | z |
|---|---|---|---|
| E | 0.40 | 0.60 | 0.00 |
| F | 0.40 | 0.00 | 0.60 |
| G | 0.20 | 0.00 | 0.80 |
| H | 0.20 | 0.80 | 0.00 |

In this aspect, the amount of platinum in the alloy nanoparticles ranges from about 0.20 to about 0.40 mole percent, based on the total moles of all metals in the alloy nanoparticles. The amount of nickel in the alloy nanoparticles ranges from about 0.00 to about 0.60 mole percent, based on the total moles of all metals in the alloy nanoparticles. The amount of cobalt in the alloy nanoparticles ranges from about 0.00 to about 0.60 mole percent, based on the total moles of all metals in the alloy nanoparticles.

Platinum-Palladium-Nickel-Cobalt Nanoparticles

In another aspect of the invention, electrocatalyst composition comprises quaternary alloy nanoparticles. In one aspect, for example, the alloy nanoparticles comprise platinum, palladium, nickel and cobalt. The amounts of these four metals, relative to one another, contained in the alloy nanoparticles of the present invention may vary widely, although several ranges of ratios of these elements may be particularly preferred for various catalytic applications.

The amount of platinum, palladium, nickel and cobalt that is present in the alloy nanoparticles according to this aspect of the present invention may be expressed by the formula:
Pt_{w}PdₓNi_{y}Co_{z}

wherein “w,” “x,” “y” and “z” represent the mole fractions of platinum, palladium, nickel and cobalt, respectively, present in the alloy nanoparticles.

In this aspect, the amount of platinum in the alloy nanoparticles ranges from about 0.40 to about 0.60 mole percent, based on the total moles of all metals in the alloy nanoparticles. The amount of palladium in the alloy nanoparticles ranges from about 0.05 to about 0.25 mole percent, based on the total moles of all metals in the alloy nanoparticles. The amount of nickel in the alloy nanoparticles ranges from about 0.05 to about 0.30 mole percent, based on the total moles of all metals in the alloy nanoparticles. The amount of cobalt in the alloy nanoparticles ranges from about 0.05 to about 0.30 mole percent, based on the total moles of all metals in the alloy nanoparticles.

A non-limiting list of several particularly preferred alloy nanoparticle compositions according to this aspect of the present invention includes Pt_{˜}0.40Pd_{˜}0.05Ni_{˜}0.30Co_{˜}0.25, Pt_{˜}0.40Pd_{˜}0.05Ni_{˜}0.25Co_{˜}0.30, Pt_{˜}0.40Pd_{˜}0.25Ni_{˜}0.30Co_{˜}0.05, and Pt_{˜0.60}Pd_{˜}0.05Ni_{˜0.30}Co_{˜0.05}.

Alloy nanoparticles according to this aspect of the present invention may exhibit a mass activity, when measured in a 3-electrode, half-cell configuration, of from about 35 to about 50 mA/mg Pt as presented in Table 37, below.

Properties of the Composite Particles

As indicated above, the composite particles (e.g., the electrocatalyst particles) may have a variety of different particle sizes, which preferably correspond generally with the particle sizes of the ultimately formed substrate particles (which may be comprised of a plurality of agglomerated nanosized substrate particles), since the nanoparticles do not contribute substantially to the size of the overall composite particles. In one embodiment, the invention is to a plurality of composite particles having a number average particle diameter of greater than about 0.1 μm and less than about 20 μm based on electron microscopy, e.g., greater than about 0.5 μm and less than about 10 μm, greater than about 0.1 μm and less than about 10 μm, or greater than about 0.2 μm and less than about 3 μm. In other embodiments, the plurality of composite particles has a d50 particle diameter greater than about 0.1 μm and less than about 20 μm, e.g., greater than about 0.5 μm and less than about 10 μm, greater than about 0.1 μm and less than about 10 μm, or greater than about 0.2 μm and less than about 3 gm, based on volume, as determined by light scattering techniques. In yet another embodiment, the invention is to a composite particle having a largest dimension (e.g., particle diameter of a substantially spherical composite particle) of greater than about 0.1 μm and less than about 20 μm based on electron microscopy, e.g., greater than about 0.5 μm and less than about 10 μm, greater than about 0.1 μm and less than about 10 μm, or greater than about 0.2 gm and less than about 3 μm.

Additionally, the composite particles preferably are porous, having porosity characteristics substantially identical to those provided above with reference to the description of the substrate particles.

The composite particles also may have a variety of particle size distributions. In one embodiment, the composite particles have a monomodal particle size distribution, meaning the particle size distribution has a generally Gaussian form or log normal. Alternatively, the composite particles have a multi-modal particle size distribution, meaning there are several modes of particle formation, and therefore producing 2 or more distributions of particle populations.

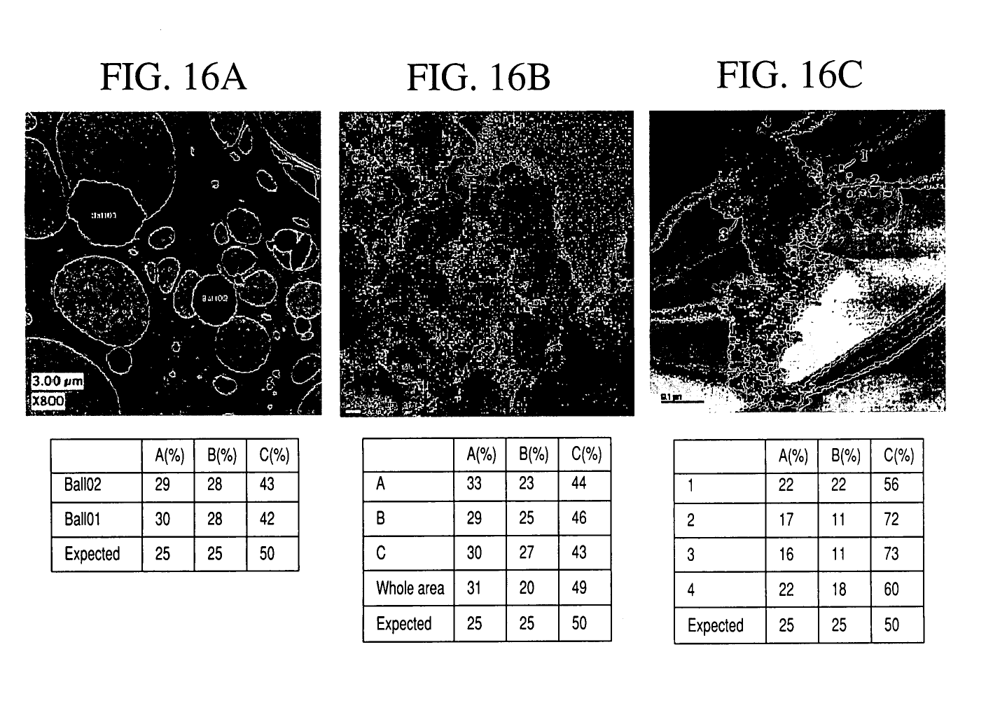

Additionally, the composite particles of the current invention have a high degree of uniformity as shown in FIGS. 16A-C, e.g., the composition of a first composite particle is substantially identical to the composition of a second composite particle (FIG. 16A). In addition, each submicron region within the submicron particle is substantially identical to a second region witching the same micron size particle. That is, a high degree of uniformity is achieved in a sub-micron scale as presented in FIG. 16B. Moreover, the composition of the alloy nanoparticles (e.g., crystallites) deposited within the micron and submicron size particles are substantially identical as presented in FIG. 16C.

Additionally, the composite particles of the invention (more particularly, the alloy nanoparticles thereof) provide high activity for various catalytic or electrocatalytic processes. In a preferred aspect, electrocatalyst activity may be measured by testing the electrocatalyst's oxygen reduction activity in a half cell, 3 electrode configuration with a liquid sulfuric acid electrolyte. In this aspect, the activity is presented in terms of mass activity, defined as mA/mg Pt, where mA is the maximum current generated by the oxygen reduction reaction, the potential being measured at 0.55 V vs. standard calomel electrode, normalized per unit weight of Pt (mg Pt). The mass activity is a measure of the effectiveness of the of the alloy electrocatalysts normalized per unit weight of Pt (mg Pt). High mass activity can be achieved either by an increase in the specific activity of the active sites or by increase of the surface area of the active phase (e.g. the particle size of the alloy nanoparticles is reduced).

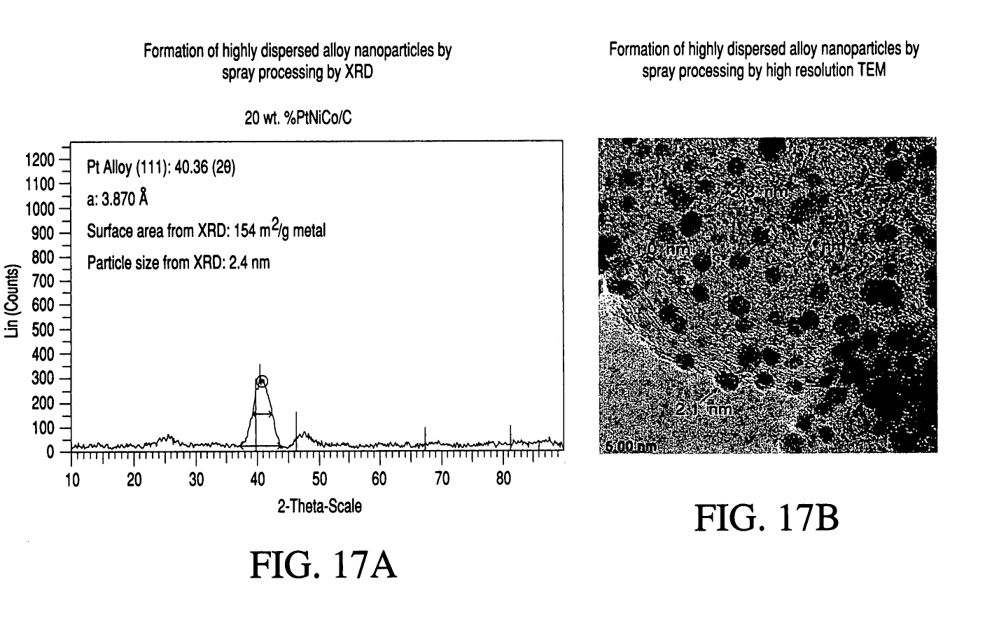

The process for manufacturing the alloy electrocatalysts subject of the current invention allows for formation of highly active alloy compositions available as alloy nanoparticles with an average size of less than 5 nm, even more preferably less than 3 nm, even more preferably less than 2 nm, and even more preferably less than 1.5 nm. FIG. 17A presents an X-ray diffraction profile for a 20 wt. percent loading of PtNiCo alloy catalyst on carbon where the position of Pt(111), 2∂=40.36 (for comparison Pt(111) peak for pure Pt crystallites has a position at 2∂=39.8), which is an indication of formation of alloy crystallites. Furthermore, these alloy nanoparticles have an average crystallite size of approximately 2.4 nm based on XRD peak width. An estimation of the average alloy nanoparticle size performed by TEM (FIG. 177B) shows similar result of 2.1 nm. Generally, average nanoparticle size may be determined by TEM techniques optionally in combination with XRD analysis.

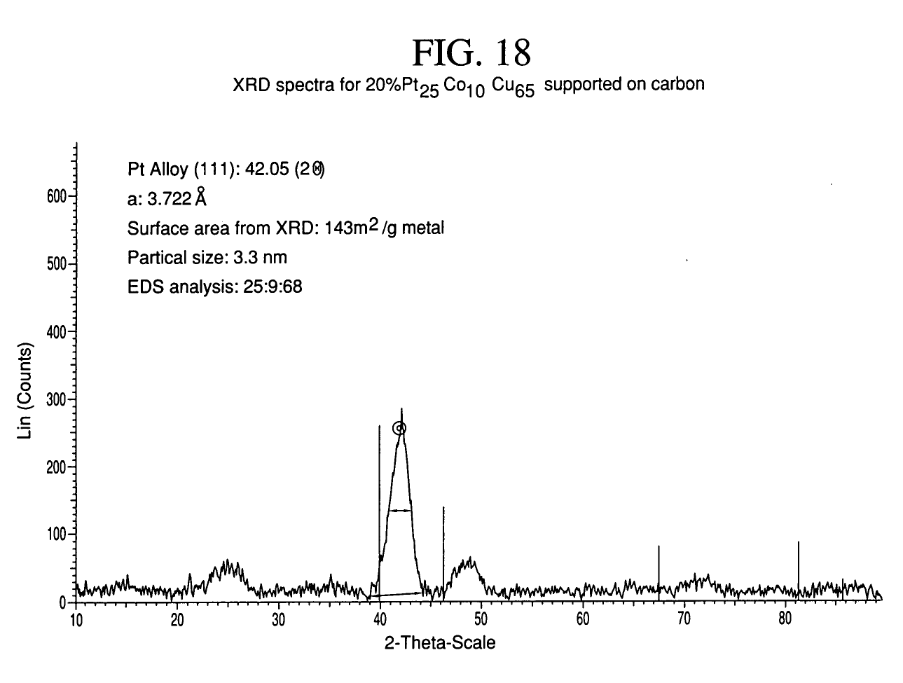

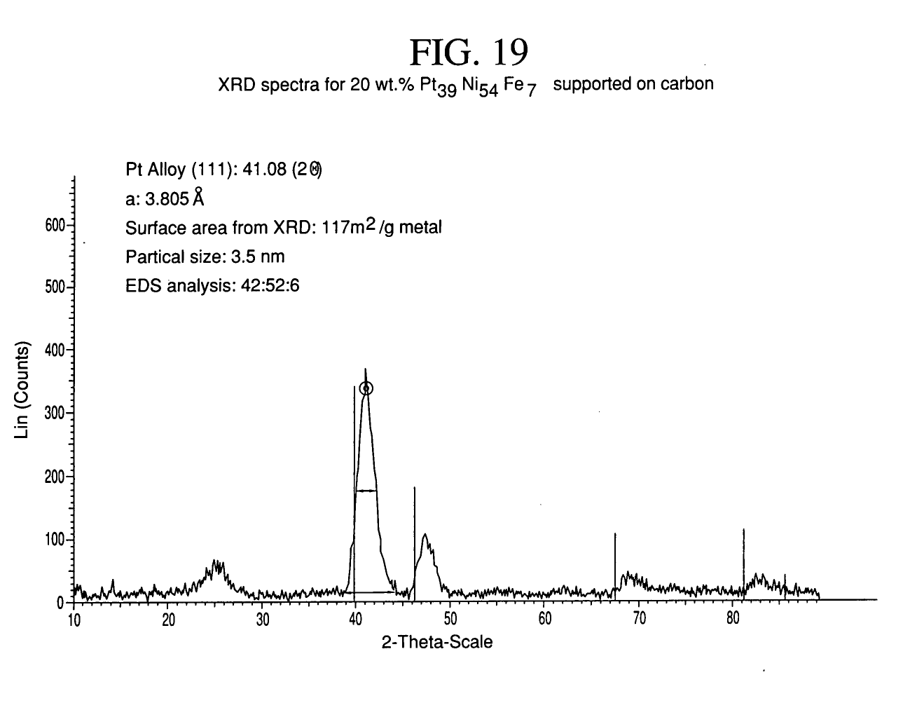

These results indicate the manufacturing processes of the current invention offer a unique ability to achieve high dispersions of the alloy nanoparticles with a sufficient degree of alloying achieved and therefore high specific activity of the active sites. The examples of XRD data presented in FIGS. 18 and 19 for selected alloy compositions, Pt₂₅CO₁₀Cu₆₅ (FIG. 18) and Pt₃₉Ni₅₄Fe₇ (FIG. 19) illustrate that highly dispersed alloy clusters can be achieved by the spray conversion method, however the method is not limited to any combination of metals, loading of the metals onto a support or the nature of the support (composition, surface area or porosity). The ability to achieve simultaneously high dispersion and high degree of alloying for the crystallites has high impact on the electrochemical performance of these materials as measured in terms of mass activity (in liquid electrolyte, as defined above and presented in Tables 26-37) or when these electrocatalysts are formulated in ink and deposited as an electrodes onto a Polymer Electrolyte Membrane (PEM) or Gas Diffusion Electrodes (GDL) and tested in a single membrane electrode assembly (MEA) fuel cell configuration.

Therefore, the activity of an alloy electrocatalyst of the present invention may be additionally measured in a single fuel cell MEA and evaluated in terms of electrochemical performance derived in an MEA and expressed in terms of absolute performance (mA/cm² achieved by an MEA with an electrode containing alloy electrocatalyst) and/or in terms of normalized performance (mA/mgPt in the electrode or MEA, or alternatively in terms of gPt/kW, e.g., the amount of Pt used to deliver certain power density).

A non-limiting example of ink formulation used to deposit the alloy catalyst composition of interest is as follows. 1 g of 20 wt. % Pt alloy/C catalyst is wetted with 8 ml distilled water. 10 ml of a 5 wt. % NAFION solution (EW 950) are added to the wetted catalyst. The solution container is placed into a 250 W, 40 kHz ultrasonic agitator for 10 min. The ink is than further formulated to an appropriate rheology and deposited onto a onto a Polymer Electrolyte Membrane (PEM) or Gas Diffusion Electrodes (GDL) by methods such as spraying, screen printing, ink jetting and others known to the skilled in the art.

The alloy electrocatalysts subject of the current invention were tested in an single cell configuration using 50 cm² MEA with NAFION™ 112 membrane, where a standard anode composition of 0.05 mgPt/cm² was used by printing 10 wt. % Pt/C electrocatalyst. The standard test conditions were as follows: cell temperature was 80° C., the anode flow rate was constant flow rate of fully humidified 510 ml/min hydrogen and the cathode flow rate was 2060 ml/min air, which corresponds to 1.5H₂ and 2.5 air stoichiometry at 1 A/cm² current density; 30 psig pressure was used on both anode and cathode inlets; with 100% humidification of air and hydrogen gases, 80 C dew points; the testing was done at galvanostatic mode, 10 min per point, and results were presented as a polarization curves. Other testing conditions known to those skilled in the art, such as at fixed and various stoichiometry of air and hydrogen, various humidification levels of the reactant gases, pressures and/or type of membranes and GDI layers, can be utilized to evaluate the performance of the alloy electrocatalysts in a single fuel cell or fuel cell stack. Therefore, the current invention is not limited to any particular test conditions or to any particular MEA configuration.

To optimize the performance of the alloy electrocatalysts as part of an electrode and an MEA, various amounts of NAFION™ ionomer can be used in the ink composition and the electrode layer, such as between 0.3 and 0.67 NAFION™ to carbon ratio. In order to optimize the electrode structure containing the alloy electrocatalysts, various conditions of lamination of the MEA layers can be employed such as using pressure (3000-8000 pounds for 50 cm² MEA) and temperature, such as between 130 and 150° C.

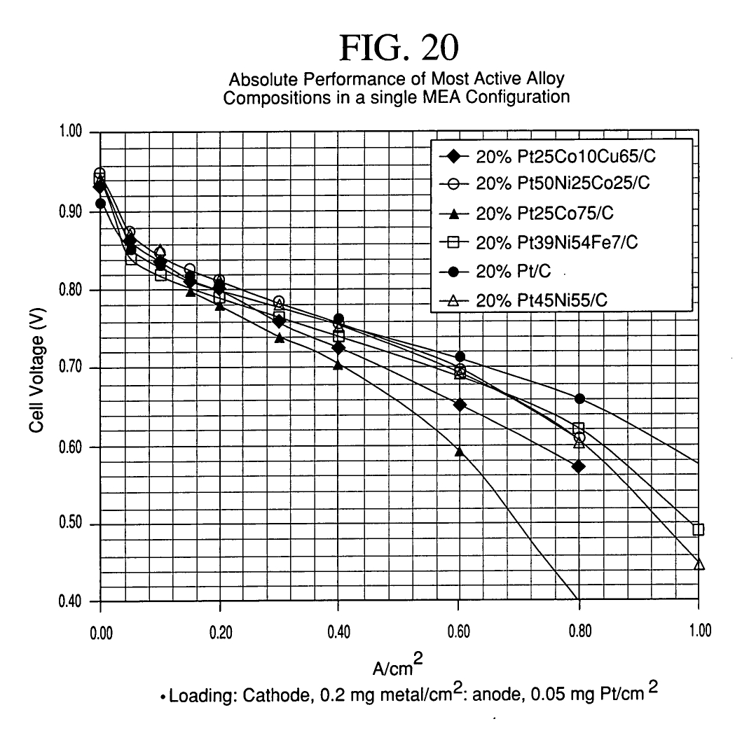

FIG. 20 presents the polarization curves for single cell MEA containing electrodes comprised of the selected best performing alloy compositions tested as described above. The cathode layers contained identical amounts of catalyst loading, and at identical metal loading of 0.2 mg metal/cm², to maintain identical layer thickness. The anode loading was identical for all MEAs, at 0.05 mg Pt/cm². The data clearly demonstrate that at high voltages, e.g., above 0.75 V, which are desirable for fuel cell operation because of the higher fuel utilization, most of the alloy composition has higher absolute performance despite their much lower Pt content.

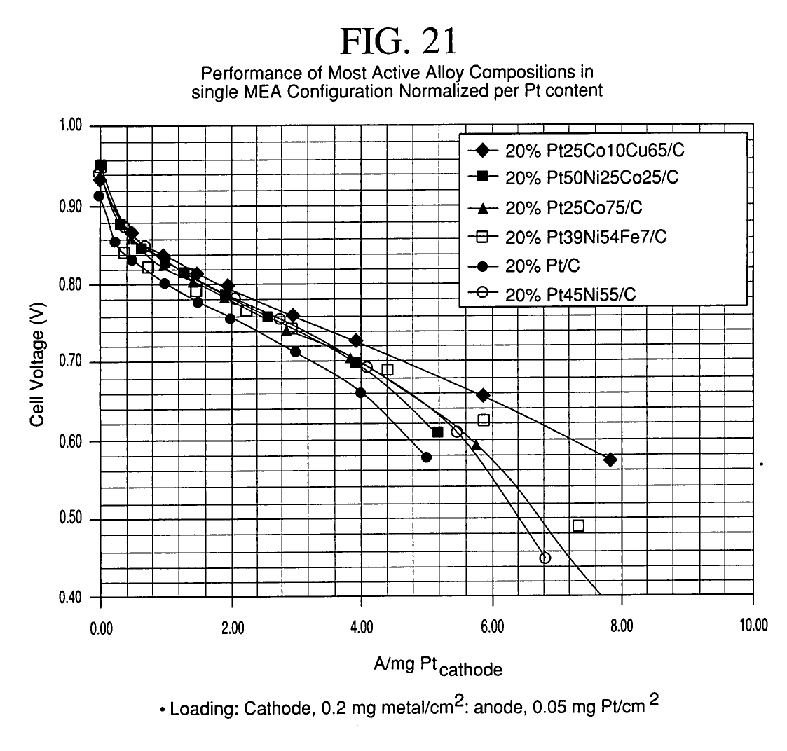

FIG. 21 presents the polarization curves as in FIG. 20 where the performance is presented as function of the mass activity or normalized by the total amount of Pt in the MEA (amount of Pt in the cathode layer depending on the Pt content in the alloy plus the amount of Pt in the anode layer, the latter being constant for all MEA). The data clearly indicate that the normalized performance of the alloy composition delivers up to 2 fold increase in the mass activity.

Therefore, the alloy electrocatalysts can be compared based on the maximum current density achieved at a potential of choice derived from a polarization curve in a single cell MEA at certain loading of Pt/cm² of electrode area, or in terms of g Pt/kW power, minimum amount of Pt needed to achieve certain power characteristics in a single fuel cell. Since it is generally desirable to reduce the amount of expensive electrocatalyst components, such as Pt, contained in various electrocatalysts, lower numbers of gPt/kW are desirable since the same power can be derived with lower amount of Pt.

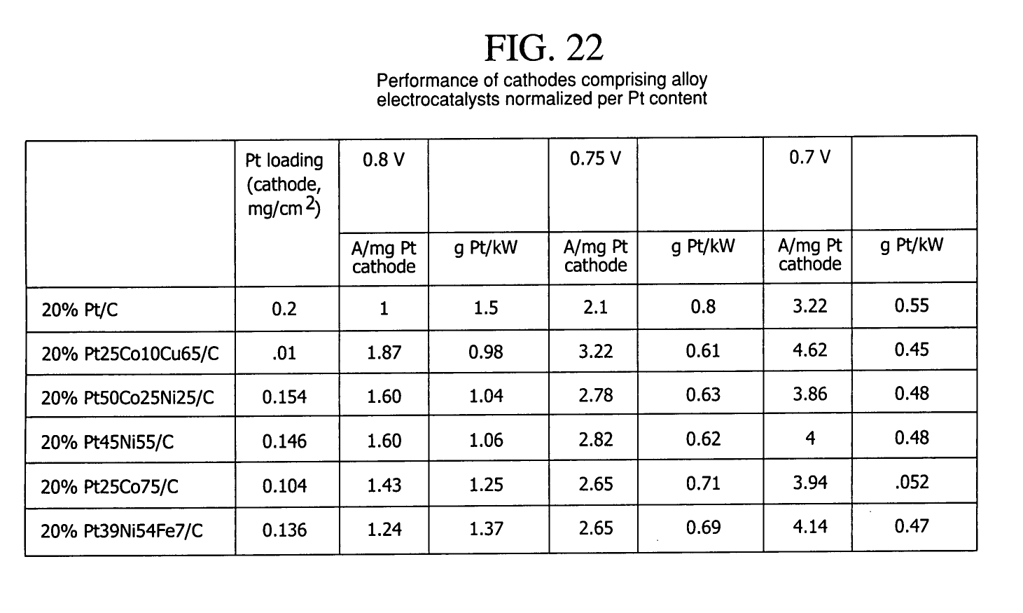

FIG. 22 presents a table where the performance of the 20 wt. % Pt alloy electrocatalysts is compared to that of pure 20 wt. % Pt supported on carbon in various metrics as mass activity and in terms of gPt/kW at 0.8, 0.75 and 0.7 V. The normalized performance of the alloy catalysts is significantly higher than that of pure Pt in terms of mass activity (mA/gPt cathode) and corresponds to a significantly lower amount of Pt metal to achieve identical power density (gPt/kW), especially at 0.8 and 0.75 V.

At lower voltages, 0.7 V and below, (see FIGS. 20, 21 and 22) the advantage of the alloy compositions is not as significant and even lower at operating voltages of 0.65 and 0.6 V. Without being limited to any theory, this is most likely due to mass transport limitation due to the increased hydrophilic nature of the alloy crystallites, and/or to an increase of ohmic losses in the cathode layer due to deposition of transition metal ions not incorporated in the alloy crystallites onto the carbon support surface. It was further established that the performance of the cathode layers comprising alloy compositions can be significantly improved by treating the electrocatalysts with acid which leads to a removal of the surface ionic species which are bound to the carbon surface and do not contribute to the formation of the alloy nanocrystallites.

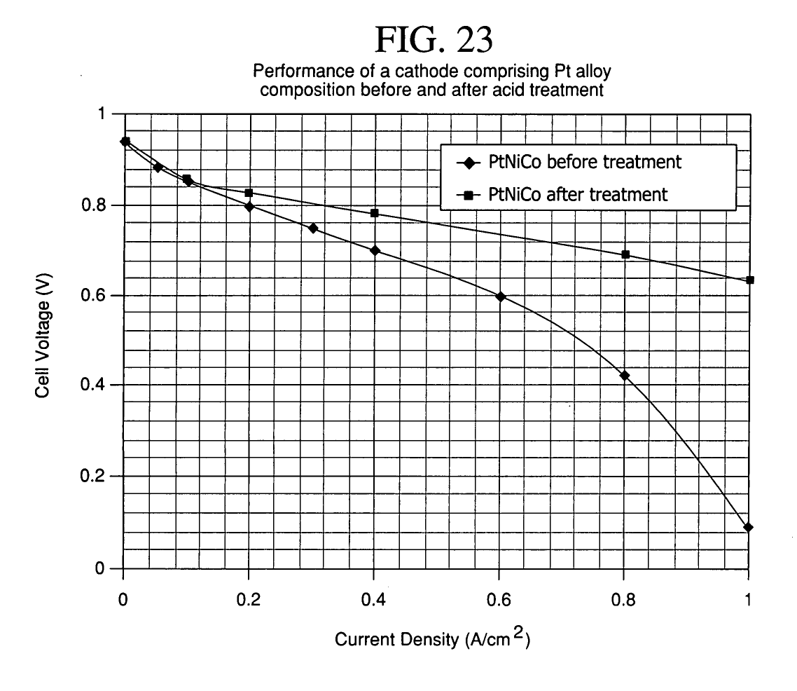

FIG. 23 presents a comparison between an alloy cathode composition before and after acid treatment. The performance of the alloy composition is unchanged at high voltages (0.9 V and above) indicating that no change in alloy crystallite phase occurred. However, the performance at lower voltages, 0.8 V to 0.6 V is significantly improved after treatment, and in terms of gPt/kW normalized performance the treated catalyst MEA delivers 0.8 gPt/kW at 0.8V, 0.5 gPt/kW at 0.75 V and 0.4 gPt/kW at 0.7 V

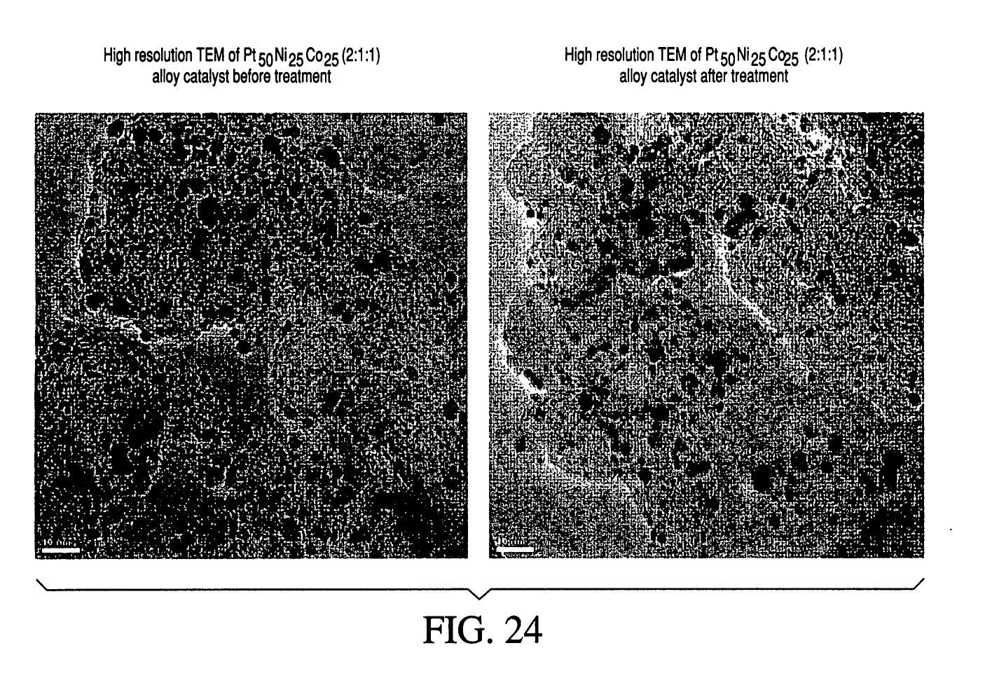

FIG. 24 presents high resolution TEM images of an alloy electrocatalyst before and after acid treatment showing no appreciable change in crystallite size as a result of the treatment. The acid treatment was performed by treating the electrocatalyst powder in 1 M H₂SO₄ acid for 24 hours. As discussed above, the goal of this treatment is to change the hydrophilic/hydrophobic and conductive properties of the electrocatalyst by removing some of metal oxide species not included in the alloy nanoparticles.

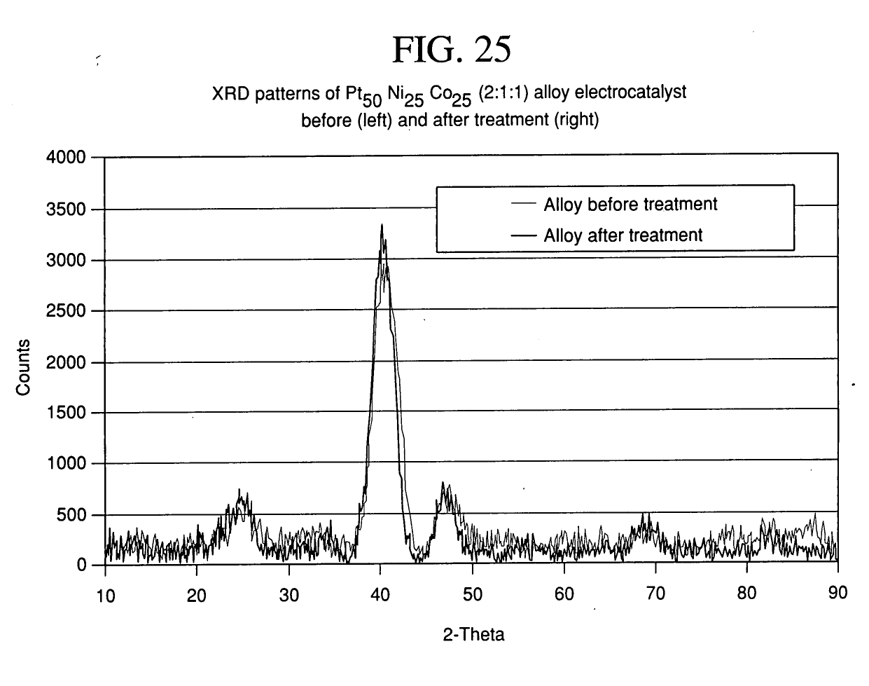

FIG. 25 compares the XRD patterns of 20 wt. % PtNiCo/C catalysts before and after acid treatment. The position of the Pt (111) peak at 2 theta (=40.359) and lattice parameter (a=3.872) is almost identical to the position of the same peak for the powder subjected to the acid treatment, Pt(111) peak at 2 theta (=40.287) and lattice parameter (a=3.879), and close to the position expected for a disordered PtNiCo alloy. In addition, there is no appreciable change in the corresponding average alloy crystallite size (estimated to be 2.36 nm for the alloy before the treatment and 2.78 nm after the treatment) demonstrating that no change of the alloy crystallites has occurred as a result of the acid treatment.

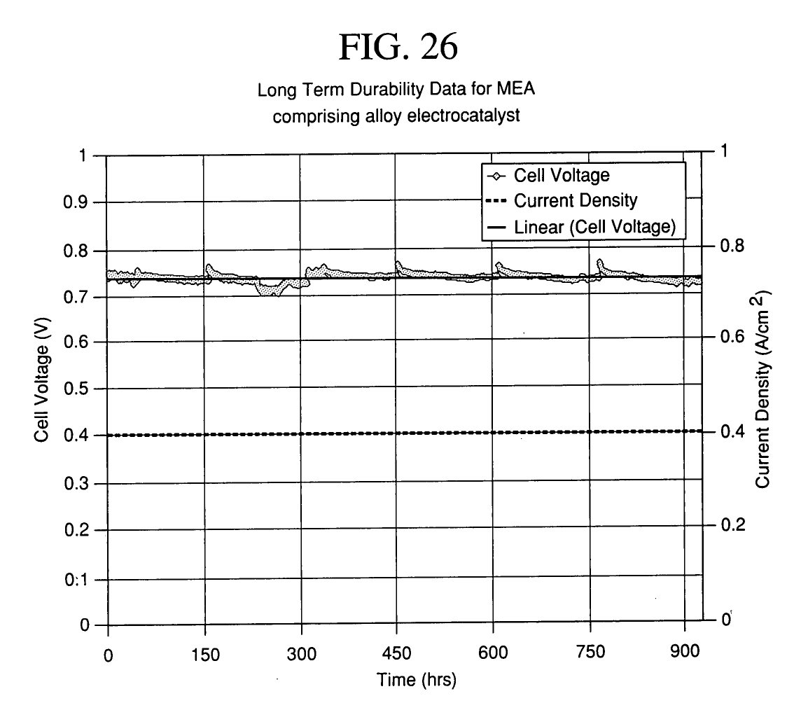

Long term durability of alloy electrocatalysts is a very important characteristic, since the mass activity advantage of alloy-based electrocatalysts as compared to pure Pt supported electrocatalysts preferably is preserved for over 2000 h, more preferably over 5000 h and even more preferably over 10000 h. The alloy compositions subject of the current invention demonstrate a high degree of durability. FIG. 26 presents the test results of long term testing of an MEA containing alloy electrocatalyst as cathode catalysts. The test was performed at constant current density of 400 mA/cm², for over 900 h, with an average decay rate of less than 6 microvolts per hour.

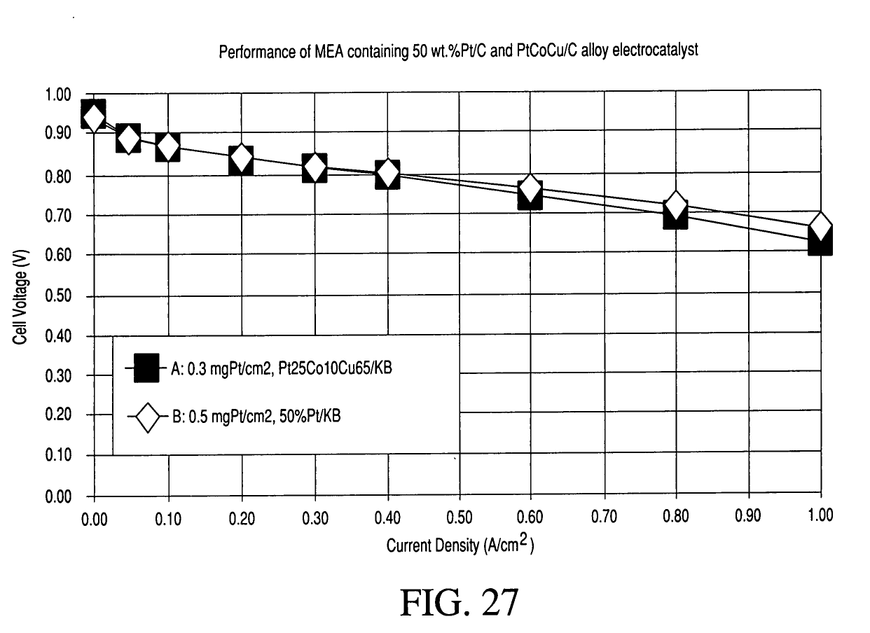

For high power fuel cell applications there is a need to simultaneously meet the absolute and normalized performance requirements, e.g., simultaneously achieve high current density at given operation voltage and achieve this with lower amount of Pt or other expensive precious metals. For these applications, high metal loading alloy electrocatalysts of selected active composition have particularly strong benefit. FIG. 27 presents polarization curves comparing the performance of single MEA for two electrocatalysts: 50 wt. % Pt/C electrocatalysts at 0.5 mgPt/cm² cathode loading and PtCoCu alloy composition electrocatalysts at 0.3 mgPt/cm² loading. The PtCoCu alloy electrocatalyst produced according to one embodiment of the current invention demonstrates high absolute performance with nearly 2 times less Pt in the layer.

Applications for the Composite Particles

The composite particles according to the present invention have a variety of applications such as electrocatalysts for applications in PEM fuel cells, high temperature fuel cells, alkaline and phosphoric acid fuel cells, direct methanol fuel cells, electrolyzers, batteries, and other devices utilizing electrochemical reactions known to the skilled in the art.

The composite particles of the present invention have many applications in the catalysis field. For example, fabrication of membrane electrode assemblies (MEAs) for use in fuel cells can also benefit from the use of inks containing the nanoparticles made using the present invention. MEAs are fully described in Published U.S. Patent Application No. US 2003/0198849 A1, published Oct. 23, 2003, the entirety of which is incorporated herein by reference. For example, an ink containing alloy nanoparticles (e.g., on substrate particles) can be printed, e.g., direct write printed, on an electrode substrate of an polymer electrolyte membrane to form an electrocatalyst layer. See U.S. Pat. No. 6,911,412 B2, the entirety of which is incorporated herein by reference, for a description of direct-write deposition processes for forming MEA electrodes. Catalysts used in MEAs can be very expensive (e.g., platinum metal), and the ability to fabricate MEAs using alloy nanoparticulate-sized catalyst particles can greatly reduce the cost of manufacturing MEAs. This reduction in cost may be achieved because the nanoparticles have a very high overall surface area which provides increased catalytic efficiency and increases specific activity per surface area due to formation of an alloy phase. Additionally, platinum is generally an expensive components, and to the extent the platinum loading in the nanoparticles can be reduced, e.g., by alloying with less expensive metals, the overall cost of raw materials used in MEA and fuel cell fabrication may be significantly reduced. Additionally, increased surface area and change in the physical properties of the surface of electrocatalysts containing alloys can also contribute to improved performance of the MEAs such as operation at lower humidification levels of the reactant gases and/or for an increased durability of the MEAs and fuel cells due to higher stability of the alloy nanoparticles when MEA is exposed to higher operating temperatures and cycling conditions.

As shown in FIG. 27, alloy electrocatalysts produced according to various embodiments of the present invention demonstrate a high absolute performance at low Pt loadings. Thus, in another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species (e.g., alloy nanoparticles)/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 400 mA/cm² at 80° C. as measured with anode constant flow rate of 100% humidified 510 ml/min hydrogen and the cathode flow rate of fully humidified 2060 ml/min air, at 30 psig (207 kPa) pressure at both anode and cathode inlets. Preferably, the electrocatalyst layer has a platinum loading of not greater than 0.4, not greater than about 0.3, not greater than about 0.2 or not greater than about 1 mgPt/cm².

In another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 600 mA/cm² at 80° C. as measured with anode constant flow rate of 100% humidified 510 ml/min hydrogen and the cathode flow rate of fully humidified 2060 ml/min air, at 30 psig pressure at both anode and cathode inlets. Preferably, the electrocatalyst layer has a platinum loading of not greater than 0.4, not greater than about 0.3, not greater than about 0.2 or not greater than about 1 mgPt/cm².

In yet another embodiment, the invention is to a membrane electrode assembly comprising an anode, an anode inlet, a cathode, a cathode inlet, and a membrane separating the anode and the cathode. The cathode comprises an electrocatalyst layer comprising alloy nanoparticles and having an alloy nanoparticle loading of not greater than about 0.5 mg of active species/cm² (e.g., not greater than about 0.45, not greater than about 4, not greater than about 3.5, not greater than about 3, not greater than about 2.5, not greater than about 2, not greater than about 1.5, or not greater than about 1.0 mg of active species/cm²). The membrane electrode assembly has a cell voltage of at least about 0.5 V (e.g., at least about 0.6 V, at least about 0.7 V, at least about 0.75 V, at least about 0.8 V, at least about 1.0 V or at least about 1.2 V) at a constant current density of about 850 mA/cm² at 80° C. as measured with anode constant flow rate of 100% humidified 510 ml/min hydrogen and the cathode flow rate of fully humidified 2060 ml/min air, at 30 psig pressure at both anode and cathode inlets.

The alloy nanoparticle compositions made according to the embodiments of the current invention can also have broad applications in various areas of catalytic reactions such as use as heterogeneous catalysts in gas phase and liquid phase catalytic reactions without limitations to any specific catalytic reaction.

### IV. Examples

The present invention will be better understood in view of the following non-limiting examples. In each example, the precursor medium was processed using a lab scale system, which had a droplet generator box having an ultrasonic spray nozzle.

### PROCESS EXAMPLES

### Examples 1-15

### Synthesis of Pt—Co—Cu Alloy Nanoparticles on Carbon Substrate Particles

In Examples 1-15, electrocatalyst particles comprising platinum, cobalt and copper alloy nanoparticles disposed on a carbon substrate were synthesized according to one aspect of the present invention.

Specifically, 1.02 g tetra amine platinum nitrate, 0.64 g cobalt nitrate hexahydrate and 1.3 g copper nitrate hemipentahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or can be alternatively produced on a spray dryer with inlet temperature of about 580° C. A black powder with composition of 20% Pt₂₅CO₁₀Cu₆₅/carbon was obtained. The powder was further reduced under 5% hydrogen balanced with nitrogen atmosphere at 300° C. for 2 hr.

The degree of alloying was determined by X-Ray Diffraction (XRD) techniques. Specifically, XRD diffraction patterns were acquired on a Difractometer with X-rays having 1.5405 Å (0.15405 nm) wavelength. The diffraction peaks of Pt face centered cubic lattice structures are associated with the (111), (200) and (220) planes and were used to evaluate the type of crystalline structure. By evaluation of the fwhm (full width at half maximum), the Pt crystallite size was estimated. The formation of alloys (or a solid solution) was also revealed by a shift in the position of the (111) peak towards lower d spacing. Disordered or ordered solid solutions can be formed. For Pt alloys that is an ordered solid solution, additional diffraction peaks are observed corresponding to (100), (110) and (210) planes. For all alloy compositions subject of the current invention no peaks of Pt(100) were observed indicating that disordered structure alloys were present at the supported catalysts prepared and analyzed.

The composition of the nanoparticles in the electrocatalyst particles formed in Examples 1-15 are provided below in Table 26. Table 26 also presents the mass activity of the electrocatalyst particles at 0.55 V vs. standard calomel electrode in a three-electrode, half-cell liquid electrolyte configuration as defined above.

TABLE 26
PT-CO-CU ALLOY NANOPARTICLES
ON CARBON SUBSTRATE PARTICLES

| | | | | mA/mg Pt |
|---|---|---|---|---|
| | Pt | Co | Cu | 0.55 V vs. |
| Example | (mole %) | (mole %) | (mole %) | SCE |
| 1 | 0.25 | 0.21 | 0.54 | 42.98 |
| 2 | 0.5 | 0.25 | 0.25 | 35.88 |
| 3 | 0.5 | 0.5 | 0 | 38.99 |
| 4 | 0.39 | 0.54 | 0.07 | 40.91 |
| 5 | 0.5 | 0 | 0.5 | 39.35 |
| 6 | 0.39 | 0.07 | 0.54 | 37.12 |
| 7 | 0.25 | 0.37 | 0.38 | 21.92 |
| 8 | 0.25 | 0 | 0.75 | 54.00 |
| 9 | 0.61 | 0.18 | 0.21 | 16.77 |
| 10 | 0.61 | 0 | 0.39 | 37.15 |
| 11 | 0.75 | 0 | 0.25 | 31.75 |
| 12 | 0.75 | 0.25 | 0 | 31.17 |
| 13 | 0.61 | 0.39 | 0 | 22.24 |
| 14 | 0.25 | 0.54 | 0.21 | 0.00 |
| 15 | 0.25 | 0.75 | 0 | 34.78 |

### Examples 16-30

### Synthesis of Pt—Co—Fe Alloy Nanoparticles on Carbon Substrate Particles

In Examples 16-30, electrocatalyst particles comprising platinum, cobalt and iron alloy nanoparticles disposed on a carbon substrate were synthesized according to one aspect of the present invention.

Specifically, 1.54 g tetra amine platinum nitrate, 0.58 g cobalt nitrate hexahydrate and 0.34 g iron acetate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₂₅CO₃₇Fe₃₈/carbon was obtained. The powder was further reduced under 5% hydrogen balanced with nitrogen atmosphere at 300° C. for 2 hours.

The composition of the nanoparticles in the electrocatalyst particles formed in Examples 16-30 are provided below in Table 27. Table 27 also presents the mass activity of the electrocatalyst particles at 0.55 V vs. standard calomel electrode in a three-electrode, half-cell liquid electrolyte configuration as defined above.

TABLE 27
PT-CO-FE ALLOY NANOPARTICLES
ON CARBON SUBSTRATE PARTICLES

| | | | | mA/mg Pt |
|---|---|---|---|---|
| | Pt | Co | Fe | at 0.55 V vs. |
| Example | (mole %) | (mole %) | (mole %) | SCE |
| 16 | 0.75 | 0 | 0.25 | 18.03 |
| 17 | 0.25 | 0.21 | 0.54 | 33.42 |
| 18 | 0.5 | 0.25 | 0.25 | 20.60 |
| 19 | 0.39 | 0.54 | 0.07 | 19.29 |
| 20 | 0.5 | 0 | 0.5 | 23.36 |
| 21 | 0.39 | 0.07 | 0.54 | 25.63 |
| 22 | 0.25 | 0.37 | 0.38 | 45.21 |
| 23 | 0.25 | 0 | 0.75 | 26.50 |
| 24 | 0.61 | 0.18 | 0.21 | 17.40 |
| 25 | 0.61 | 0 | 0.39 | 20.52 |
| 26 | 0.61 | 0.39 | 0 | 22.11 |
| 27 | 0.5 | 0.5 | 0 | 26.06 |
| 28 | 0.25 | 0.54 | 0.21 | 24.57 |
| 29 | 0.25 | 0.75 | 0 | 37.96 |
| 30 | 0.75 | 0.25 | 0 | 21.42 |

### Examples 31-45

### Synthesis of Pt—Fe—Cu Alloy Nanoparticles on Carbon Substrate Particles

In Examples 31-45, electrocatalyst particles comprising platinum, iron and copper alloy nanoparticles disposed on a carbon substrate were synthesized according to one aspect of the present invention.

Specifically, 1.53 g tetra amine platinum nitrate, 0.34 g iron acetate and 0.45 g copper nitrate hemipentahydrate were dissolved in 80 milliliters of distilled water, followed by the addition of 18.2 g of a carbon suspension containing 22 weight percent Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₂₅Fe₂₁Cu₅₄/carbon was obtained. The powder was further reduced under 5% hydrogen balanced with nitrogen at 300° C. for 2 hr.

The composition of the nanoparticles in the electrocatalyst particles formed in Examples 31-45 are provided below in Table 28. Table 28 also presents the mass activity of the electrocatalyst particles as determined by at 0.55 V vs. standard calomel electrode in a three-electrode, half-cell liquid electrolyte configuration as defined above.

TABLE 28
PT—FE—CU ALLOY NANOPARTICLES
ON CARBON SUBSTRATE PARTICLES

| | | | | mA/mg Pt |
|---|---|---|---|---|
| | Pt | Fe | Cu | at 0.55 V vs. |
| Example | (mole %) | (mole %) | (mole %) | SCE |
| 31 | 0.5 | 0.25 | 0.25 | 25.77 |
| 32 | 0.39 | 0.54 | 0.07 | 30.34 |
| 33 | 0.39 | 0.07 | 0.54 | 19.94 |
| 34 | 0.5 | 0 | 0.5 | 21.48 |
| 35 | 0.25 | 0.37 | 0.38 | 24.31 |
| 36 | 0.25 | 0 | 0.75 | 37.05 |
| 37 | 0.61 | 0.18 | 0.21 | 24.34 |
| 38 | 0.61 | 0 | 0.39 | 18.56 |
| 39 | 0.75 | 0 | 0.25 | 21.74 |
| 40 | 0.61 | 0.39 | 0 | 23.65 |
| 41 | 0.5 | 0.5 | 0 | 36.68 |
| 42 | 0.25 | 0.54 | 0.21 | 51.50 |
| 43 | 0.25 | 0.21 | 0.54 | 41.60 |
| 44 | 0.25 | 0.75 | 0 | 45.13 |
| 45 | 0.75 | 0.25 | 0 | 27.20 |

### Examples 46-59

### Synthesis of Pt—Ni—Cu Alloy Nanoparticles on Carbon Substrate Particles

In Examples 46-59, electrocatalyst particles comprising platinum, nickel and copper alloy nanoparticles disposed on a carbon substrate were synthesized according to one aspect of the present invention.

Specifically, 1.53 g tetra amine platinum nitrate, 0.57 g nickel nitrate hexahydrate and 0.45 g copper nitrate hemipentahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₂₅Ni₂₁Cu₅₄/carbon was obtained. The powder was further reduced under 5% hydrogen balanced with nitrogen at 300° C. for 2 hr.

The composition of the nanoparticles in the electrocatalyst particles formed in Examples 46-59 are provided below in Table 29. Table 29 also presents the mass activity of the electrocatalyst particles as determined at 0.55 V vs. standard calomel electrode in a three-electrode, half-cell liquid electrolyte configuration as defined above.

TABLE 29
PT-NI-CU ALLOY NANOPARTICLES
ON CARBON SUBSTRATE PARTICLES

| | | | | mA/mg Pt |
|---|---|---|---|---|
| | Pt | Ni | Cu | at 0.55 V vs |
| Example | (mole %) | (mole %) | (mole %) | SCE |
| 46 | 0.25 | 0.21 | 0.54 | 40.21 |
| 47 | 0.5 | 0.25 | 0.25 | 29.27 |
| 48 | 0.39 | 0.54 | 0.07 | 36.43 |
| 49 | 0.5 | 0 | 0.5 | 30.08 |
| 50 | 0.39 | 0.07 | 0.54 | 32.67 |
| 51 | 0.25 | 0.37 | 0.38 | 33.37 |
| 52 | 0.61 | 0.18 | 0.21 | 23.18 |
| 53 | 0.61 | 0 | 0.39 | 25.72 |
| 54 | 0.75 | 0 | 0.25 | 21.71 |
| 55 | 0.61 | 0.39 | 0 | 30.10 |
| 56 | 0.5 | 0.5 | 0 | 33.37 |
| 57 | 0.25 | 0.54 | 0.21 | 36.28 |
| 58 | 0.25 | 0.75 | 0 | 42.99 |
| 59 | 0.75 | 0.25 | 0 | 25.39 |

### Examples 60-74

### Synthesis of Pt—Ni—Fe Alloy Nanoparticles on Carbon Substrate Particles

In Examples 60-74, electrocatalyst particles comprising platinum, nickel and iron alloy nanoparticles disposed on a carbon substrate were synthesized according to one aspect of the present invention.

Specifically, 1.54 g tetra amine platinum nitrate, 0.58 g nickel nitrate hexahydrate and 0.34 g iron nitrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₃₉Ni₅₄Fe₇/carbon was obtained. The powder was further reduced under 5% hydrogen balanced with nitrogen atmosphere at 300° C.

The composition of the nanoparticles in the electrocatalyst particles formed in Examples 60-74 are provided below in Table 30. Table 30 also presents the mass activity of the electrocatalyst particles as determined at 0.55 V vs. standard calomel electrode in a three-electrode, half-cell liquid electrolyte configuration as defined above.

TABLE 30
PT-NI-FE ALLOY NANOPARTICLES
ON CARBON SUBSTRATE PARTICLES

| | | | | mA/mg Pt |
|---|---|---|---|---|
| | Pt | Ni | Fe | at 0.55 V vs |
| Example | (mole %) | (mole %) | (mole %) | SCE |
| 60 | 0.25 | 0.21 | 0.54 | 25.98 |
| 61 | 0.5 | 0.25 | 0.25 | 20.89 |
| 62 | 0.39 | 0.54 | 0.07 | 48.01 |
| 63 | 0.39 | 0.07 | 0.54 | 26.86 |
| 64 | 0.5 | 0 | 0.5 | 26.79 |
| 65 | 0.25 | 0.37 | 0.38 | 18.89 |
| 66 | 0.25 | 0 | 0.75 | 32.81 |
| 67 | 0.61 | 0.18 | 0.21 | 10.44 |
| 68 | 0.61 | 0 | 0.39 | 16.69 |
| 69 | 0.75 | 0 | 0.25 | 20.59 |
| 70 | 0.61 | 0.39 | 0 | 20.72 |
| 71 | 0.5 | 0.5 | 0 | 31.96 |
| 72 | 0.25 | 0.54 | 0.21 | 20.08 |
| 73 | 0.25 | 0.75 | 0 | 31.78 |
| 74 | 0.75 | 0.25 | 0 | 26.01 |

### Examples 75-89

### Synthesis of Pt—Pd—Cu Alloy Nanoparticles on Carbon Substrate Particles

In Examples 75-89, electrocatalyst particles comprising platinum, palladium and copper alloy nanoparticles disposed on a carbon substrate were synthesized according to one aspect of the present invention.

Specifically, 1.39 g tetra amine platinum nitrate, 0.52 g tetraamine palladium nitrate and 0.41 g copper nitrate hemipentahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₂₅Pd₂₁Cu₅₄/carbon was obtained. The powder was further reduced under 5% hydrogen balanced with nitrogen atmosphere at 300° C. for 2 hr.

The composition of the nanoparticles in the electrocatalyst particles formed in Examples 75-89 are provided below in Table 31. Table 31 also presents the mass activity of the electrocatalyst particles as determined at 0.55 V vs. standard calomel electrode in a three-electrode, half-cell liquid electrolyte configuration as defined above.

TABLE 31
PT-PD-CU ALLOY NANOPARTICLES
ON CARBON SUBSTRATE PARTICLES

| | | | | mA/mg Pt |
|---|---|---|---|---|
| | Pt | Pd | Cu | at 0.55 V vs. |
| Example | (mole %) | (mole %) | (mole %) | SCE |
| 75 | 0.25 | 0.21 | 0.54 | 40.69 |
| 76 | 0.5 | 0.25 | 0.25 | 30.47 |
| 77 | 0.39 | 0.54 | 0.07 | 22.74 |
| 78 | 0.39 | 0.07 | 0.54 | 38.50 |
| 79 | 0.5 | 0 | 0.5 | 33.06 |
| 80 | 0.25 | 0.37 | 0.38 | 36.96 |
| 81 | 0.25 | 0 | 0.75 | 32.04 |
| 82 | 0.61 | 0.18 | 0.21 | 26.38 |
| 83 | 0.61 | 0 | 0.39 | 24.06 |
| 84 | 0.75 | 0 | 0.25 | 23.56 |
| 85 | 0.75 | 0.25 | 0 | 23.21 |
| 86 | 0.61 | 0.39 | 0 | 17.63 |
| 87 | 0.5 | 0.5 | 0 | 21.62 |
| 88 | 0.25 | 0.54 | 0.21 | 23.75 |
| 89 | 0.25 | 0.75 | 0 | 23.64 |

### Examples 90-99

### Synthesis of Pt—Pd—Co Alloy Nanoparticles on Carbon Substrate Particles

In Examples 90-99, electrocatalyst particles comprising platinum, palladium and cobalt alloy nanoparticles disposed on a carbon substrate were synthesized according to one aspect of the present invention.

Specifically, 1.41 g tetra amine platinum nitrate, 0.53 g tetraamine palladium nitrate and 0.53 g cobalt nitrate hexahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₆₅Pd₅CO₂/carbon was obtained. The powder was further reduced under 5% hydrogen balanced with nitrogen atmosphere at 300° C. for 2 hr.

The composition of the nanoparticles in the electrocatalyst particles formed in Examples 90-99 are provided below in Table 32. Table 32 also presents the mass activity of the electrocatalyst particles as determined at 0.55 V vs. standard calomel electrode in a three-electrode, half-cell liquid electrolyte configuration as defined above.

TABLE 32
PT-PD-CO ALLOY NANOPARTICLES
ON CARBON SUBSTRATE PARTICLES

| | | | | mA/mg Pt |
|---|---|---|---|---|
| | Pt | Pd | Co | at 0.55 V vs. |
| Example | (mole %) | (mole %) | (mole %) | SCE |
| 90 | 65 | 5 | 30 | 36.33 |
| 91 | 77.5 | 17.5 | 5 | 35.76 |
| 92 | 70 | 20 | 10 | 34.91 |
| 93 | 60 | 20 | 20 | 34.47 |
| 94 | 70 | 10 | 20 | 34.41 |
| 95 | 77.5 | 5 | 17.5 | 33.20 |
| 96 | 60 | 30 | 10 | 33.08 |
| 97 | 60 | 10 | 30 | 32.78 |
| 98 | 90 | 5 | 5 | 30.23 |
| 99 | 80 | 10 | 10 | 18.11 |

### Examples 100-116

### Synthesis of Pt—Pd—Fe Alloy Nanoparticles on Carbon Substrate Particles

In Examples 100-116, electrocatalyst particles comprising platinum, palladium and iron alloy nanoparticles disposed on a carbon substrate were synthesized according to one aspect of the present invention.

Specifically, 1.41 g tetra amine platinum nitrate, 0.53 g tetraamine palladium nitrate and 0.32 g iron acetate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₆₀Fe₄₀/carbon was obtained. The powder was further reduced under 5% hydrogen balanced with nitrogen at 300° C. for 2 hr.

The composition of the nanoparticles in the electrocatalyst particles formed in Examples 100-116 are provided below in Table 33. Table 33 also presents the mass activity of the electrocatalyst particles as determined at 0.55 V vs. standard calomel electrode in a three-electrode, half-cell liquid electrolyte configuration as defined above.

TABLE 33
PT-PD-FE ALLOY NANOPARTICLES
ON CARBON SUBSTRATE PARTICLES

| | | | | mA/mg Pt |
|---|---|---|---|---|
| | Pt | Pd | Fe | at 0.55 V vs. |
| Example | (mole %) | (mole %) | (mole %) | SCE |
| 100 | 60 | 0 | 40 | 36.09 |
| 101 | 65 | 5 | 30 | 33.99 |
| 102 | 60 | 10 | 30 | 32.89 |
| 103 | 60 | 20 | 20 | 32.86 |
| 104 | 70 | 0 | 30 | 31.63 |
| 105 | 80 | 0 | 20 | 31.44 |
| 106 | 60 | 30 | 10 | 31.32 |
| 107 | 90 | 5 | 5 | 31.30 |
| 108 | 65 | 30 | 5 | 31.24 |
| 109 | 70 | 20 | 10 | 31.10 |
| 110 | 77.5 | 17.5 | 5 | 30.06 |
| 111 | 70 | 10 | 20 | 29.48 |
| 112 | 80 | 10 | 10 | 29.36 |
| 113 | 77.5 | 5 | 17.5 | 29.00 |
| 114 | 70 | 30 | 0 | 28.84 |
| 115 | 80 | 20 | 0 | 27.30 |
| 116 | 60 | 40 | 0 | 16.53 |

### Examples 117-133

### Synthesis of Pt—Mn—Fe Alloy Nanoparticles on Carbon Substrate Particles

In Examples 117-133, electrocatalyst particles comprising platinum, manganese and iron alloy nanoparticles disposed on a carbon substrate were synthesized according to one aspect of the present invention.

Specifically, 1.56 g tetra amine platinum nitrate, 0.36 g manganese nitrate and 0.35 g iron acetate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₆₀Mn₁₀Fe₃₀/carbon was obtained. The powder was further reduced under 5% hydrogen balanced with nitrogen atmosphere at 300° C. for 2 hr.

The composition of the nanoparticles in the electrocatalyst particles formed in Examples 117-133 are provided below in Table 34. Table 34 also presents the mass activity of the electrocatalyst particles as determined at 0.55 V vs. standard calomel electrode in a three-electrode, half-cell liquid electrolyte configuration as defined above.

TABLE 34
PT-MN-FE ALLOY NANOPARTICLES
ON CARBON SUBSTRATE PARTICLES

| | | | | mA/mg Pt |
|---|---|---|---|---|
| | Pt | Mn | Fe | at 0.55 V vs |
| Example | (mole %) | (mole %) | (mole %) | SCE |
| 117 | 60 | 10 | 30 | 33.24 |
| 118 | 65 | 5 | 30 | 32.44 |
| 119 | 70 | 30 | 0 | 31.44 |
| 120 | 70 | 15 | 15 | 31.03 |
| 121 | 60 | 30 | 10 | 30.81 |
| 122 | 60 | 20 | 20 | 29.21 |
| 123 | 60 | 0 | 40 | 29.04 |
| 124 | 60 | 40 | 0 | 28.48 |
| 125 | 65 | 30 | 5 | 27.77 |
| 126 | 77.5 | 5 | 17.5 | 27.31 |
| 127 | 70 | 10 | 20 | 27.23 |
| 128 | 80 | 10 | 10 | 27.02 |
| 129 | 70 | 20 | 10 | 26.63 |
| 130 | 80 | 20 | 0 | 26.41 |
| 131 | 80 | 0 | 20 | 26.00 |
| 132 | 90 | 5 | 5 | 24.25 |
| 133 | 70 | 0 | 30 | 21.68 |

### Examples 134-146

### Synthesis of Pt—Pd—Mn Alloy Nanoparticles on Carbon Substrate Particles

In Examples 134-146, electrocatalyst particles comprising platinum, palladium and manganese alloy nanoparticles disposed on a carbon substrate were synthesized according to one aspect of the present invention.

Specifically, 1.42 g tetra amine platinum nitrate, 0.53 g tetraamine palladium nitrate and 0.32 g manganese nitrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₅₀Pd₄₀Mn₁₀/carbon was obtained. The powder was further reduced under 5% hydrogen balanced with nitrogen atmosphere at 300° C. for 2 hr. The composition of the nanoparticles in the electrocatalyst particles formed in Examples 134-146 are provided below in Table 35. Table 35 also presents the mass activity of the electrocatalyst particles as determined at 0.55 V vs. standard calomel electrode in a three-electrode, half-cell liquid electrolyte configuration as defined above.

TABLE 35
PT-PD-MN ALLOY NANOPARTICLES
ON CARBON SUBSTRATE PARTICLES

| | | | | mA/mg Pt |
|---|---|---|---|---|
| | Pt | Pd | Mn | at 0.55 V vs. |
| Example | (mole %) | (mole %) | (mole %) | SCE |
| 134 | 50 | 40 | 10 | 35.11 |
| 135 | 50 | 20 | 30 | 34.56 |
| 136 | 50 | 30 | 20 | 34.29 |
| 137 | 60 | 20 | 20 | 30.21 |
| 138 | 75 | 5 | 20 | 30.20 |
| 139 | 60 | 30 | 10 | 29.15 |
| 140 | 60 | 10 | 30 | 28.36 |
| 141 | 75 | 20 | 5 | 27.98 |
| 142 | 70 | 10 | 20 | 27.60 |
| 143 | 70 | 20 | 10 | 26.36 |
| 144 | 90 | 5 | 5 | 25.92 |
| 145 | 80 | 10 | 10 | 24.41 |
| 146 | 50 | 10 | 40 | 19.39 |

### Examples 147-155

### Synthesis of Pt—Ni—Co Alloy Nanoparticles on Carbon Substrate Particles

In Examples 147-155, electrocatalyst particles comprising platinum, nickel and cobalt alloy nanoparticles disposed on a carbon substrate were synthesized according to one aspect of the present invention.

Specifically, 1.54 g tetra amine platinum nitrate, 0.57 g nickel nitrate hexahydrate and 0.57 g cobalt nitrate hexahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₃₀Ni₅CO₆₅/carbon was obtained. The powder was further reduced under 5% hydrogen balanced with nitrogen atmosphere at 300° C. for 2 hr.

The composition of the nanoparticles in the electrocatalyst particles formed in examples 147-155 are provided below in Table 36. Table 36 also presents the mass activity of the electrocatalyst particles as determined at 0.55 V vs. standard calomel electrode in a three-electrode, half-cell liquid electrolyte configuration as defined above.

TABLE 36
PT-NI-CO ALLOY NANOPARTICLES
ON CARBON SUBSTRATE PARTICLES

| | | | | mA/mg Pt |
|---|---|---|---|---|
| | Pt | Ni | Co | at 0.55 V vs. |
| Example | (mole %) | (mole %) | (mole %) | SCE |
| 147 | 30 | 5 | 65 | 36.51 |
| 148 | 30 | 5 | 65 | 37.10 |
| 149 | 90 | 5 | 5 | 25.15 |
| 150 | 30 | 65 | 5 | 36.90 |
| 151 | 75 | 25 | 0 | 29.72 |
| 152 | 25 | 75 | 0 | 37.67 |
| 153 | 75 | 0 | 25 | 26.69 |
| 154 | 25 | 0 | 75 | 36.33 |
| 155 | 50 | 25 | 25 | 30.58 |

### Examples 156-170

### Synthesis of Pt—Pd—Ni—Co Alloy Nanoparticles on Carbon Substrate Particles

In Examples 156-170, electrocatalyst particles comprising platinum, palladium, nickel and cobalt alloy nanoparticles disposed on a carbon substrate were synthesized according to one aspect of the present invention.

1.35 g tetra amine platinum nitrate, 0.13 g tetramaine palladium nitrate, 0.63 g nickel nitrate hexahydrate and 0.75 g cobalt nitrate hexahydrate were dissolved in 80 milliliters of distilled water, followed by the addition of 18.2 g of a carbon suspension containing 22 weight percent of Vulcan™ XC72R from Cabot Corporation in water. The resulting mixture was converted to an aerosol by ultrasonic spray nozzle using air as a carrier gas in a spray conversion apparatus, such as horizontal tube reactor or a spray dryer. The aerosol was processed in a horizontal tube furnace set up at a temperature of about 550° C. or a spray dryer with inlet temperature of about 580° C. A black powder with composition of 20% Pt₄₀Pd₅Ni₂₅CO₃₀/carbon was obtained. The powder was further reduced under 5% hydrogen balanced with nitrogen atmosphere at 300° C. for 2 hr.

The composition of the nanoparticles in the electrocatalyst particles formed in Examples 156-170 are provided below in Table 37. Table 37 also presents the mass activity of the electrocatalyst particles as determined at 0.55 V vs. standard calomel electrode in a three-electrode, half-cell liquid electrolyte configuration as defined above.

TABLE 37
PT-PD-NI-CO ALLOY NANOPARTICLES
ON CARBON SUBSTRATE PARTICLES

| | | | | | mA/mg Pt |
|---|---|---|---|---|---|
| | Pt | Pd | Ni | Co | at 0.55 V vs. |
| Example | (mole %) | (mole %) | (mole %) | (mole %) | SCE |
| 156 | 40 | 5 | 25 | 30 | 47.75 |
| 157 | 40 | 25 | 30 | 5 | 38.15 |
| 158 | 60 | 5 | 30 | 5 | 37.38 |
| 159 | 40 | 5 | 30 | 25 | 37.13 |
| 160 | 55 | 20 | 20 | 5 | 34.40 |
| 161 | 40 | 30 | 25 | 5 | 33.47 |
| 162 | 60 | 5 | 5 | 30 | 31.17 |
| 163 | 40 | 25 | 5 | 30 | 26.98 |
| 164 | 60 | 10 | 15 | 15 | 26.66 |
| 165 | 40 | 30 | 5 | 25 | 23.74 |
| 166 | 85 | 5 | 5 | 5 | 20.99 |
| 167 | 70 | 5 | 5 | 20 | 20.40 |
| 168 | 40 | 15 | 30 | 15 | 15.98 |
| 169 | 60 | 30 | 5 | 5 | 14.02 |
| 170 | 70 | 20 | 5 | 5 | 12.25 |

The foregoing discussion of the invention has been presented for purposes of illustration and description. The foregoing is not intended to limit the invention to only the form or forms specifically disclosed herein. Although the description of the invention has included description of one or more embodiments and certain implementations, variations and modifications, other implementations, variations and modifications are within the scope of the invention, e.g., as may be within the skill and knowledge of those in the art after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Furthermore, any feature described with respect to any disclosed embodiment, implementation or variation of any aspect of the invention may be combined in any combination with one or more features of any other embodiment, implementation or variation of the same or any other aspect of the invention. For example, additional processing steps can be included at any point before, during or after processing disclosed in any of the process embodiments described herein or shown in any of the figures, so long as the additional steps are not incompatible with the disclosed processing according to the present invention. Moreover, processing steps disclosed in any of the process embodiments described herein can be combined with any other processing steps described with any other process embodiment. The terms “comprising,” “containing,” “including,” and “having,” and variations thereof, are intended to be non-limiting in that the use of such terms indicates the presence of some condition or feature, but not to the exclusion of the presence of any other condition or feature. Percentages stated herein are by weight unless otherwise expressly stated.

We claim:

1. A process for forming composite particles, wherein the process comprises the steps of:
(a) providing a precursor medium comprising a first metal precursor, a second metal precursor, a liquid vehicle, and a substrate precursor to substrate particles;
(b) spray drying the precursor medium to vaporize at least a portion of the liquid vehicle and form intermediate particles; and
(c) heating the intermediate particles to a temperature of no greater than about 600° C. under conditions effective to form the composite particles, wherein the composite particles comprise alloy nanoparticles dispersed on the substrate particles.

2. The process of claim 1, wherein the intermediate particles comprise the substrate particles and a plurality of metal-containing compositions disposed thereon, wherein the metal-containing compositions are formed from the first and second metal precursors.

3. The process of claim 2, wherein at least one of the metal-containing compositions comprises an elemental metal.

4. The process of claim 2, wherein at least one of the metal-containing compositions comprises a metal oxide.

5. The process of claim 1, wherein the alloy nanoparticles are formed from metals derived from the first metal precursor and the second metal precursor.

6. The process of claim 1, wherein the first metal precursor comprises platinum and the second metal precursor comprises a second metal selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

7. The process of claim 6, wherein the alloy nanoparticles comprise a solid solution of the platinum and the second metal.

8. The process of claim 6, wherein the precursor medium further comprises a third metal precursor comprising a third metal, different from the second metal, the third metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

9. The process of claim 8, wherein the alloy nanoparticles comprise a solid solution of the platinum and the second and third metals.

10. The process of claim 8, wherein the second metal comprises cobalt and the third metal comprises nickel.

11. The process of claim 8, wherein the precursor medium further comprises a fourth metal precursor comprising a fourth metal, different from the second and third metals, the fourth metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

12. The process of claim 11, wherein the alloy nanoparticles comprise a solid solution of the platinum and the second, third and fourth metals.

13. The process of claim 1, wherein the temperature in step (c) is no greater than about 500° C.

14. The process of claim 13, wherein the temperature in step (c) is no greater than about 400° C.

15. The process of claim 14, wherein the temperature in step (c) is no greater than about 250° C.

16. The process of claim 1, wherein the alloy nanoparticles have an average particle size of from about 1 nm to about 10 nm.

17. The process of claim 16, wherein the alloy nanoparticles have an average particle size of from about 3 nm to about 5 nm.

18. The process of claim 16, wherein the alloy nanoparticles have an average particle size of from about 1 nm to about 3 mm.

19. The process of claim 1, wherein the substrate particles comprise carbon microparticles.

20. The process of claim 19, wherein the carbon microparticles have a d50 value, by volume, of from about 1 μm to about 20 μm.

21. The process of claim 1, wherein the average distance between adjacent alloy nanoparticles on a given substrate particle is from about 1 nm to about 10 nm.

22. The process of claim 1, wherein the liquid vehicle comprises water.

23. The process of claim 1, wherein steps (b) and (c) occur substantially simultaneously through spray pyrolysis.

24. The process of claim 1, wherein step (b) occurs at least partially before step (c).

25. The process of claim 1, wherein the precursor medium comprises the substrate precursor in an amount from about 1 to about 10 weight percent, based on the total weight of the precursor medium.

26. The process of claim 1, wherein the alloy nanoparticles comprise a disordered alloy.

27. The process of claim 1, wherein the first metal precursor comprises platinum, wherein the second metal precursor comprises manganese, wherein the precursor medium further comprises an iron precursor, and wherein the alloy nanoparticles comprise a solid solution of platinum, manganese and iron.

28. The process of claim 1, wherein the first metal precursor comprises platinum, wherein the second metal precursor comprises palladium, wherein the precursor medium further comprises a manganese precursor, and wherein the alloy nanoparticles comprise a solid solution of platinum, palladium and manganese.

29. The process of claim 1, wherein the first metal precursor comprises platinum, wherein the second metal precursor comprises palladium, wherein the precursor medium further comprises a nickel precursor and a cobalt precursor, and wherein the alloy nanoparticles comprise a solid solution of platinum, palladium, nickel and cobalt.

30. The process of claim 1, wherein the first metal precursor comprises platinum, wherein the second metal precursor comprises cobalt, wherein the precursor medium further comprises a copper precursor, and wherein the alloy nanoparticles comprise a solid solution of platinum, cobalt and copper.

31. The process of claim 30, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points A, B, C and D of the ternary diagram which is FIG. 8.

32. The process of claim 30, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points E, F, G and H of the ternary diagram which is FIG. 8.

33. The process of claim 30, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points I, J, K and L of the ternary diagram which is FIG. 8.

34. The process of claim 30, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points M, J, N and O of the ternary diagram which is FIG. 8.

35. The process of claim 1, wherein the first metal precursor comprises platinum, wherein the second metal precursor comprises cobalt, wherein the precursor medium further comprises an iron precursor, and wherein the alloy nanoparticles comprise a solid solution of platinum, cobalt and iron.

36. The process of claim 35, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points A, B, C and D of the ternary diagram which is FIG. 9.

37. The process of claim 35, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points E, F, G and H of the ternary diagram which is FIG. 9.

38. The process of claim 35, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points I, J, K and L of the ternary diagram which is FIG. 9.

39. The process of claim 1, wherein the first metal precursor comprises platinum, wherein the second metal precursor comprises iron, wherein the precursor medium further comprises a copper precursor, and wherein the alloy nanoparticles comprise a solid solution of platinum, iron and copper.

40. The process of claim 39, wherein the alloy nanoparticles comprise a solid solution of platinum, iron and copper in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points A, B, C, D, E and F of the ternary diagram which is FIG. 10.

41. The process of claim 39, wherein the alloy nanoparticles comprise a solid solution of platinum, cobalt and iron in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points G, H, I and J of the ternary diagram which is FIG. 10.

42. The process of claim 39, wherein the alloy nanoparticles comprise a solid solution of platinum, cobalt and iron in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points A, K, L and M of the ternary diagram which is FIG. 10.

43. The process of claim 1, wherein the first metal precursor comprises platinum, wherein the second metal precursor comprises nickel, wherein the precursor medium further comprises a copper precursor, and wherein the alloy nanoparticles comprise a solid solution of platinum, nickel and copper.

44. The process of claim 43, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points A, B, C, and D of the ternary diagram which is FIG. 11.

45. The process of claim 43, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points E, F, G and H of the ternary diagram which is FIG. 11.

46. The process of claim 43, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points I, J, K and L of the ternary diagram which is FIG. 11.

47. The process of claim 43, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points M, I, N and O of the ternary diagram which is FIG. 11.

48. The process of claim 1, wherein the first metal precursor comprises platinum, wherein the second metal precursor comprises nickel, wherein the precursor medium further comprises an iron precursor, and wherein the alloy nanoparticles comprise a solid solution of platinum, nickel and iron.

49. The process of claim 48, wherein the alloy nanoparticles comprise a solid solution of platinum, nickel and iron in amounts represented by the formula PtₓNi_{y}Fe_{z}, wherein x, y and z represent the mole fractions of platinum, nickel and iron, respectively, present in the alloy nanoparticles, the mole fractions being such that they are within the compositional area defined by points A, B, C, and D of the ternary diagram which is FIG. 12.

50. The process of claim 1, wherein the first metal precursor comprises platinum, wherein the second metal precursor comprises palladium, wherein the precursor medium further comprises an copper precursor, and wherein the alloy nanoparticles comprise a solid solution of platinum, palladium and copper.

51. The process of claim 50, wherein the alloy nanoparticles comprise a solid solution of platinum, palladium and copper in amounts represented by the formula PtₓPd_{y}Cu₂, wherein x, y and z represent the mole fractions of platinum, palladium and copper, respectively, present in the alloy nanoparticles, the mole fractions being such that they are within the compositional area defined by points A, B, C, D, E, and F of the ternary diagram which is FIG. 13.

52. The process of claim 50, wherein the alloy nanoparticles comprise a solid solution of platinum, palladium and copper in amounts represented by the formula PtₓPd_{y}Cu_{z}, wherein x, y and z represent the mole fractions of platinum, palladium and copper, respectively, present in the alloy nanoparticles, the mole fractions being such that they are within the compositional area defined by points G, B, H and I of the ternary diagram which is FIG. 13.

53. The process of claim 1, wherein the first metal precursor comprises platinum, wherein the second metal precursor comprises palladium, wherein the precursor medium further comprises a cobalt precursor, and wherein the alloy nanoparticles comprise a solid solution of platinum, palladium and cobalt.

54. The process of claim 53, wherein the alloy nanoparticles comprise a solid solution of platinum, palladium and cobalt in amounts represented by the formula PtₓPd_{y}Co_{z}, wherein x, y and z represent the mole fractions of platinum, palladium and cobalt, respectively, present in the alloy nanoparticles, the mole fractions being such that they are within the compositional area defined by points A, B, C, and D of the ternary diagram which is FIG. 14.

55. The process of claim 1, wherein the first metal precursor comprises platinum, wherein the second metal precursor comprises palladium, wherein the precursor medium further comprises an iron precursor, and wherein the alloy nanoparticles comprise a solid solution of platinum, palladium and iron.

56. The process of claim 1, wherein the first metal precursor comprises platinum, wherein the second metal precursor comprises nickel, wherein the precursor medium further comprises a cobalt precursor, and wherein the alloy nanoparticles comprise a solid solution of platinum, nickel and cobalt.

57. The process of claim 56, wherein the alloy nanoparticles comprise a solid solution of platinum, nickel and cobalt in amounts represented by the formula PtₓNi_{y}Co_{z}, wherein x, y and z represent the mole fractions of platinum, nickel and cobalt, respectively, present in the alloy nanoparticles, the mole fractions being such that they are within the compositional area defined by points A, B, C, and D of the ternary diagram which is FIG. 15.

58. The process of claim 56, wherein the alloy nanoparticles comprise a solid solution of platinum, nickel and cobalt in amounts represented by the formula PtₓNi_{y}Co_{z}, wherein x, y and z represent the mole fractions of platinum, nickel and cobalt, respectively, present in the alloy nanoparticles, the mole fractions being such that they are within the compositional area defined by points E, F, G and H of the ternary diagram which is FIG. 15.

59. A process for forming composite particles, wherein the process comprises the steps of:
(a) providing a precursor medium comprising a first metal precursor, a second metal precursor, a liquid vehicle and a substrate precursor to a substrate particle;
(b) aerosolizing the precursor medium to form a flowable aerosol comprising droplets of the liquid mixture; and
(c) heating the flowable aerosol to a temperature of from about 400° C. to about 800° C. under conditions effective to at least partially vaporize the liquid vehicle and form the composite particles, wherein the composite particles comprise alloy nanoparticles disposed on the substrate particles.

60. The process of claim 59, wherein step (b) forms intermediate particles comprising the substrate particles and a plurality of metal-containing compositions disposed thereon, wherein the metal-containing compositions are formed from the first and second metal precursors.

61. The process of claim 60, wherein at least one of the metal-containing compositions comprises an elemental metal.

62. The process of claim 60, wherein at least one of the metal-containing compositions comprises a metal oxide.

63. The process of claim 59, wherein the alloy nanoparticles are formed from metals derived from the first metal precursor and the second metal precursor.

64. The process of claim 59, wherein the first metal precursor comprises platinum and the second metal precursor comprises a second metal selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

65. The process of claim 64, wherein the alloy nanoparticles comprise a solid solution of the platinum and the second metal.

66. The process of claim 64, wherein the precursor medium further comprises a third metal precursor comprising a third metal, different from the second metal, the third metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

67. The process of claim 66, wherein the alloy nanoparticles comprise a solid solution of the platinum and the second and third metals.

68. The process of claim 66, wherein the second metal comprises cobalt and the third metal comprises nickel.

69. The process of claim 66, wherein the precursor medium further comprises a fourth metal precursor comprising a fourth metal, different from the second and third metals, the fourth metal being selected from the group consisting of: nickel, cobalt, iron, copper, manganese, chromium, ruthenium, rhenium, molybdenum, tungsten, vanadium, zinc, titanium, zirconium, tantalum, iridium, palladium and gold.

70. The process of claim 69, wherein the alloy nanoparticles comprise a solid solution of the platinum and the second, third and fourth metals.

71. The process of claim 59, wherein the temperature in step (c) is no greater than about 700° C.

72. The process of claim 71, wherein the temperature in step (c) is no greater than about 600° C.

73. The process of claim 72, wherein the temperature in step (c) is no greater than about 500° C.

74. The process of claim 59, wherein the alloy nanoparticles have an average particle size of from about 1 nm to about 10 nm.

75. The process of claim 74, wherein the alloy nanoparticles have an average particle size of from about 3 nm to about 5 nm.

76. The process of claim 74, wherein the alloy nanoparticles have an average particle size of from about 1 nm to about 3 nm.

77. The process of claim 59, wherein the substrate particles comprise carbon microparticles.

78. The process of claim 76, wherein the carbon microparticles have a d50 value, by volume, of from about 1 μm to about 20 μm.

79. The process of claim 59, wherein the average distance between adjacent alloy nanoparticles on a given substrate particle is from about 1 nm to about 10 nm.

80. The process of claim 59, wherein the liquid vehicle comprises water.

81. The process of claim 59, wherein steps (b) and (c) occur substantially simultaneously through spray pyrolysis.

82. The process of claim 59, wherein step (b) occurs at least partially before step (c).

83. The process of claim 59, wherein precursor medium comprises the substrate precursor in an amount from about 1 to about 10 weight percent, based on the total weight of the precursor medium.

84. The process of claim 59, wherein the alloy nanoparticles comprise a disordered alloy.

85. An electrocatalyst composition, comprising:
a plurality of alloy nanoparticles disposed on a surface of a substrate particle, wherein the plurality of alloy nanoparticles has a number average particle size of from about 1 to about 5 nm.

86. An electrocatalyst composition of claim 85, wherein the number average particle size is from about 1 to about 4 nm.

87. The electrocatalyst composition of claim 85, wherein the number average particle size is from about 1 to about 3 nm.

88. The electrocatalyst composition of claim 85, wherein the number average particle size is from about 1 nm to about 2.5 nm.

89. The electrocatalyst composition of claim 87, wherein the number average particle size is from about 3 nm to about 5 nm.

90. The electrocatalyst composition of claim 85, wherein the composition delivers similar or better performance when used as a first cathode electrocatalyst at loadings if 0.1 to 0.5 mg active phase/cm², the active phase comprising the alloy nanoparticles, as compared to a MEA comprising a second cathode electrocatalyst comprising elemental platinum nanoparticles, wherein the first cathode electrocatalyst comprises at least 10% less platinum than the second cathode electrocatalyst.

91. The electrocatalyst composition of claim 85, wherein the alloy nanoparticles comprise a solid solution of platinum and a second metal selected from the group consisting of nickel, cobalt, iron, copper, manganese, chromium, ruthenium, rhenium, molybdenum, tungsten, vanadium, zinc, titanium, zirconium, tantalum, iridium, palladium and gold.

92. The electrocatalyst composition of claim 85, wherein the alloy nanoparticles comprise a solid solution of platinum, a second metal and a third metal, the second and third metals being different from each other and being selected from the group consisting of nickel, cobalt, iron, copper, manganese, chromium, ruthenium, rhenium, molybdenum, tungsten, vanadium, zinc, titanium, zirconium, tantalum, iridium, palladium and gold.

93. The electrocatalyst composition of claim 85, wherein the substrate particle comprises a carbon microparticle.

94. The electrocatalyst composition of claim 93, wherein the carbon microparticle has a particle size of from about 0.1 to about 20 μm.

95. The electrocatalyst composition of claim 85, wherein the average distance between adjacent alloy nanoparticles on the substrate particle is from about 1 to about 10 nm.

96. The electrocatalyst composition of claim 85, wherein the alloy nanoparticles comprise a disordered alloy.

97. The electrocatalyst composition of claim 85, wherein the alloy nanoparticles comprise a solid solution of platinum, cobalt and copper.

98. The electrocatalyst composition of claim 85, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points A, B, C and D of the ternary diagram which is FIG. 8.

99. The electrocatalyst composition of claim 85, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points E, F, G and H of the ternary diagram which is FIG. 8.

100. The electrocatalyst composition of claim 85, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points I, J, K and L of the ternary diagram which is FIG. 8.

101. The electrocatalyst composition of claim 85, wherein the alloy nanoparticles comprise a solid solution of platinum, cobalt and copper in amounts represented by the formula PtₓCo_{y}Cu_{z}, wherein x, y and z represent the mole fractions of platinum, cobalt and copper, respectively, present in the alloy nanoparticles, the mole fractions being such that they are within the compositional area defined by points M, J, N and O of the ternary diagram which is FIG. 8.

102. The electrocatalyst composition of claim 85, wherein the alloy nanoparticles comprise a solid solution of platinum, cobalt and copper in amounts represented by one of the formulae: Pt_{˜0.50}Co_{˜0.50}, Pt_{˜0.25}Co_{˜0.75}, Pt_{˜0.39}Co_{˜0.54}Cu_{˜0.07}, Pt_{˜0.50}, C_{˜0.25}Cu_{˜0.25} Pt_{˜0.50}Cu_{˜0.50}, Pt_{˜0.25}Co_{˜0.10}Cu_{˜0.65}, Pt_{˜0.25}Co_{˜0.21}Cu_{˜0.54}, Pt_{˜0.39}, C_{˜0.07}Cu_{˜0.54}, Pt_{˜0.75}Cu_{˜0.25} or Pt_{˜0.61}Cu_{˜0.39}.

103. The electrocatalyst composition of claim 85, wherein the alloy nanoparticles comprise a solid solution of platinum, cobalt and iron.

104. The electrocatalyst composition of claim 85, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points A, B, C and D of the ternary diagram which is FIG. 9.

105. The electrocatalyst composition of claim 85, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points E, F, G and H of the ternary diagram which is FIG. 9.

106. The electrocatalyst composition of claim 85, wherein the alloy nanoparticles comprise a solid solution of platinum, cobalt and iron in amounts represented by the formula PtₓCo_{y}Fe_{z}, wherein x, y and z represent the mole fractions of platinum, cobalt and iron, respectively, present in the alloy nanoparticles, the mole fractions being such that they are within the compositional area defined by points I, J, K and L of the ternary diagram which is FIG. 9.

107. The electrocatalyst composition of claim 85, wherein the alloy nanoparticles comprise a solid solution of platinum, cobalt and iron in amounts represented by one of the formulae: Pt_{˜0.50}Co_{˜0.50}, Pt_{˜0.25}Co_{˜0.75}, Pt_{˜0.25}Co_{˜0.37}Fe_{˜0.38}, Pt_{˜0.50}F_{˜0.50} or Pt_{˜0.25}F_{˜0.75}.

108. The electrocatalyst composition of claim 85, wherein the alloy nanoparticles comprise a solid solution of platinum, iron and copper.

109. The electrocatalyst composition of claim 85, wherein the alloy nanoparticles comprise a solid solution of platinum, iron and copper in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points A, B, C, D, E and F of the ternary diagram which is FIG. 10.

110. The electrocatalyst composition of claim 85, wherein the alloy nanoparticles comprise a solid solution of platinum, cobalt and iron in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points G, H, I and J of the ternary diagram which is FIG. 10.

111. The electrocatalyst composition of claim 85, wherein the alloy nanoparticles comprise a solid solution of platinum, cobalt and iron in amounts represented by the formula PtₓFe_{y}Cu_{z}, wherein x, y and z represent the mole fractions of platinum, iron and copper, respectively, present in the alloy nanoparticles, the mole fractions being such that they are within the compositional area defined by points A, K, L and M of the ternary diagram which is FIG. 10.

112. The electrocatalyst composition of claim 85, wherein the alloy nanoparticles comprise a solid solution of platinum, iron and copper in amounts represented by one of the formulae: Pt_{˜0.50}Fe_{˜0.50}, Pt_{˜0.39}Fe_{˜0.54}Cu_{˜0.07}, Pt_{˜0.35}Fe_{˜0.60}Cu_{˜0.05} Pt_{˜0.25}Fe_{˜0.75}, Pt_{˜0.25}Fe_{˜0.54}Cu_{˜0.21}Pt_{˜0.25}Cu_{˜0.75} or Pt_{˜0.25}Fe_{˜0.21} Cu_{˜0.54}.

113. The electrocatalyst composition of claim 85, wherein the alloy nanoparticles comprise a solid solution of platinum, nickel and copper.

114. The electrocatalyst composition of claim 85, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points A, B, C, and D of the ternary diagram which is FIG. 11.

115. The electrocatalyst composition of claim 85, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points E, F, G and H of the ternary diagram which is FIG. 11.

116. The electrocatalyst composition of claim 85, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points I, J, K and L of the ternary diagram which is FIG. 11.

117. The electrocatalyst composition of claim 85, wherein the alloy nanoparticles comprise a solid solution of platinum, nickel and copper in amounts represented by the formula PtₓNi_{y}Cu_{z}, wherein x, y and z represent the mole fractions of platinum, nickel and copper, respectively, present in the alloy nanoparticles, the mole fractions being such that they are within the compositional area defined by points M, I, N and O of the ternary diagram which is FIG. 11.

118. The electrocatalyst composition of claim 85, wherein the alloy nanoparticles comprise a solid solution of platinum, nickel and copper in amounts represented by one of the formulae: Pt_{˜0.39}Ni_{˜0.54}Cu_{˜0.07}, Pt_{˜0.61}Ni_{˜0.39}, Pt_{˜0.45}Ni_{˜0.55}, Pt_{˜0.50}Ni_{˜0.50}, Pt_{˜0.25}Ni_{˜0.75}, Pt_{˜0.25}Ni_{˜0.54}Cu_{˜0.21}, Pt_{˜0.25}Ni_{˜0.38}Cu_{˜0.37}, Pt_{˜0.39}Ni_{˜0.07}Cu_{˜0.54} or Pt_{˜0.25}Ni_{˜0.21}Cu_{˜0.54}.

119. The electrocatalyst composition of claim 85, wherein the alloy nanoparticles comprise a solid solution of platinum, nickel and iron.

120. The electrocatalyst composition of claim 85, wherein the alloy nanoparticles comprise a solid solution of platinum, nickel and iron in amounts represented by the formula PtₓNi_{y}Fe_{z}, wherein x, y and z represent the mole fractions of platinum, nickel and iron, respectively, present in the alloy nanoparticles, the mole fractions being such that they are within the compositional area defined by points A, B, C, and D of the ternary diagram which is FIG. 12.

121. The electrocatalyst composition of claim 85, wherein the alloy nanoparticles comprise a solid solution of platinum, nickel and iron in amounts represented by one of the formulae: Pt_{˜0.25}Ni_{˜}_{˜0.75}, Pt_{˜0.50}Ni_{˜0.50}, or Pt_{˜0.39}Ni_{˜0.54}F_{˜0.07}.

122. The electrocatalyst composition of claim 85, wherein the alloy nanoparticles comprise a solid solution of platinum, palladium and copper.

123. The electrocatalyst composition of claim 85, wherein the alloy nanoparticles comprise a solid solution of platinum, palladium and copper in amounts represented by the formula PtₓPd_{y}Cu_{z}, wherein x, y and z represent the mole fractions of platinum, palladium and copper, respectively, present in the alloy nanoparticles, the mole fractions being such that they are within the compositional area defined by points A, B, C, D, E, and F of the ternary diagram which is FIG. 13.

124. The electrocatalyst composition of claim 85, wherein the alloy nanoparticles comprise a solid solution of platinum, palladium and copper in amounts represented by the formula PtₓPd_{y}Cu_{z}, wherein x, y and z represent the mole fractions of platinum, palladium and copper, respectively, present in the alloy nanoparticles, the mole fractions being such that they are within the compositional area defined by points G, B, H and I of the ternary diagram which is FIG. 13.

125. The electrocatalyst composition of claim 85, wherein the alloy nanoparticles comprise a solid solution of platinum, palladium and copper in amounts represented by one of the formulae: Pt_{˜0.39}Pd_{˜0.07}Cu_{˜0.54}, Pt_{˜0.50}Pd_{˜0.25}Cu_{˜0.25}, Pt_{˜0.25}Pd_{˜0.37}Cu_{˜0.38}, or Pt_{˜0.25}Pd_{˜0.21}Cu_{˜0.54}.

126. The electrocatalyst composition of claim 85, wherein the alloy nanoparticles comprise a solid solution of platinum, palladium and cobalt.

127. The electrocatalyst composition of claim 85, wherein the alloy nanoparticles comprise a solid solution of platinum, palladium and cobalt in amounts represented by the formula PtₓPd_{y}Co_{z}, wherein x, y and z represent the mole fractions of platinum, palladium and cobalt, respectively, present in the alloy nanoparticles, the mole fractions being such that they are within the compositional area defined by points A, B, C, and D of the ternary diagram which is FIG. 14.

128. The electrocatalyst composition of claim 85, wherein the alloy nanoparticles comprise a solid solution of platinum, palladium and cobalt in amounts represented by one of the formulae: Pt_{˜0.65}Pd_{˜0.05}Co_{˜0.30}, Pt_{˜070}Pd_{˜0.20}Co_{˜0.10}, Pt_{˜0.60}Pd_{˜0.20}Co_{˜0.20}, or Pt_{˜0.70}Pd_{˜0.10}C_{˜020}.

129. The electrocatalyst composition of claim 85, wherein the alloy nanoparticles comprise a solid solution of platinum, nickel and cobalt.

130. The electrocatalyst composition of claim 85, wherein the alloy nanoparticles comprise a solid solution of platinum, nickel and cobalt in amounts represented by the formula PtₓNi_{y}Co_{z}, wherein x, y and z represent the mole fractions of platinum, nickel and cobalt, respectively, present in the alloy nanoparticles, the mole fractions being such that they are within the compositional area defined by points A, B, C, and D of the ternary diagram which is FIG. 15.

131. The electrocatalyst composition of claim 85, wherein the alloy nanoparticles comprise a solid solution of platinum, nickel and cobalt in amounts represented by the formula PtₓNi_{y}Co_{z}, wherein x, y and z represent the mole fractions of platinum, nickel and cobalt, respectively, present in the alloy nanoparticles, the mole fractions being such that they are within the compositional area defined by points E, F, G and H of the ternary diagram which is FIG. 15.

132. The electrocatalyst composition of claim 85, wherein the alloy nanoparticles comprise a solid solution of platinum, nickel and cobalt in amounts represented by one of the formulae: Pt_{˜0.50}Ni_{˜0.25}Co_{˜0.25}, Pt_{˜0.30}Ni_{˜0.65}Cu_{˜0.5}, Pt_{˜0.30}Ni_{˜0.5}Cu_{˜0.65}, or Pt_{˜0.30}Ni_{˜0.35}Co_{˜0.35}.

133. The electrocatalyst composition of claim 85, wherein the alloy nanoparticles comprise a solid solution of platinum, palladium, nickel and cobalt.

134. The electrocatalyst composition of claim 85, wherein the alloy nanoparticles comprise a solid solution of platinum, palladium, nickel and cobalt in amounts represented by one of the formulae: Pt_{˜0.40}Pd_{˜0.05}Ni_{˜0.30}Cu_{˜0.25}, Pt_{˜0.40}Pd_{˜0.05}Ni_{˜0.25}Co_{˜0.30}, Pt_{˜0.40}Pd_{˜0.25}Ni_{˜0.30}Co_{˜0.05}, or Pt_{˜0.60}Pd_{˜0.05}Ni_{˜0.30}Co_{˜0.05}.

135. A membrane electrode assembly comprising an anode, an anode inlet, a cathode, a cathode inlet, and a membrane separating the anode and the cathode, wherein the cathode comprises an electrocatalyst layer, the electrocatalyst layer comprising alloy nanoparticles and having an alloy nanoparticle loading of not greater than about 0.5 mg of active species/cm², and wherein the membrane electrode assembly has a cell voltage of at least about 0.8 V at a constant current density of about 400 mA/cm² at 80° C. as measured with anode constant flow rate of 100% humidified 510 ml/min hydrogen and the cathode flow rate of fully humidified 2060 ml/min air, at 30 psig pressure at both anode and cathode inlets.

136. The membrane electrode assembly of claim 135, wherein the loading is not greater than about 0.35 mg of active species/cm².

137. The membrane electrode assembly of claim 135, wherein electrocatalyst layer has a Pt loading of not greater than 0.3 mgPt/cm².

138. The membrane electrode assembly of claim 135, wherein electrocatalyst layer has a Pt loading of not greater than 0.2 mgPt/cm².

139. The membrane electrode assembly of claim 135, wherein electrocatalyst layer has a Pt loading of not greater than 0.1 mgPt/cm².

140. A membrane electrode assembly comprising an anode, an anode inlet, a cathode, a cathode inlet, and a membrane separating the anode and the cathode, wherein the cathode comprises an electrocatalyst layer, the electrocatalyst layer comprising alloy nanoparticles and having an alloy nanoparticle loading of not greater than about 0.5 mg of active species/cm², and wherein the membrane electrode assembly has a cell voltage of at least about 0.75 V at a constant current density of about 600 mA/cm² at 80° C. as measured with anode constant flow rate of 100% humidified 510 ml/min hydrogen and the cathode flow rate of fully humidified 2060 ml/min air, at 30 psig pressure at both anode and cathode inlets.

141. The membrane electrode assembly of claim 140, wherein the loading is not greater than about 0.35 mg of active species/cm².

142. The membrane electrode assembly of claim 140, wherein electrocatalyst layer has a Pt loading of not greater than 0.3 mgPt/cm².

143. The membrane electrode assembly of claim 140, wherein electrocatalyst layer has a Pt loading of not greater than 0.2 mgPt/cm².

144. The membrane electrode assembly of claim 140, wherein electrocatalyst layer has a Pt loading of not greater than 0.1 mgPt/cm².

145. A membrane electrode assembly comprising an anode, an anode inlet, a cathode, a cathode inlet, and a membrane separating the anode and the cathode, wherein the cathode comprises an electrocatalyst layer, the electrocatalyst layer comprising alloy nanoparticles and having an alloy nanoparticle loading of not greater than about 0.5 mg of active species/cm², and wherein the membrane electrode assembly has a cell voltage of at least about 0.7 V at a constant current density of about 850 mA/cm² at 80° C. as measured with anode constant flow rate of 100% humidified 510 ml/min hydrogen and the cathode flow rate of fully humidified 2060 ml/min air, at 30 psig pressure at both anode and cathode inlets.

146. The membrane electrode assembly of claim 145, wherein the loading is not greater than about 0.35 mg of active species/cm².

147. The membrane electrode assembly of claim 145, wherein electrocatalyst layer has a Pt loading of not greater than 0.3 mgPt/cm².

148. The membrane electrode assembly of claim 145, wherein electrocatalyst layer has a Pt loading of not greater than 0.2 mgPt/cm².

149. The membrane electrode assembly of claim 145, wherein electrocatalyst layer has a Pt loading of not greater than 0.1 mgPt/cm².
